(19) United States
(12) Patent Application Publication
(10) Pub. No.: US 2014/0081875 A1
(43) Pub. Date: Mar. 20, 2014

(54) METHOD AND SYSTEM FOR PROVIDING CUSTOMER SUPPORT

(71) Applicant: New Gate Technologies, Inc., Bozeman, MT (US)

(72) Inventors: Eric Pierson, Bozeman, MT (US); Kellen Pierson, Bozeman, MT (US); Bruce Pierson, Bozeman, MT (US); Adriele Rosheger, Bozeman, MT (US)

(73) Assignee: New Gate Technologies, Inc., Bozeman, MT (US)

(21) Appl. No.: 14/026,251

(22) Filed: Sep. 13, 2013

Related U.S. Application Data
(60) Provisional application No. 61/701,025, filed on Sep. 14, 2012.

(51) Int. Cl. G06Q 30/00

(52) U.S. Cl. CPC G06Q 30/016
USPC 705/304

(57) ABSTRACT

A method executed at least in part in a computing device for providing cloud based customer support services includes providing a cloud based service enabling data interchange between participants of a cloud based support service, the participants including customers seeking support on products or services and support personnel from companies providing the products or services. The method further includes associating a subset of the participants with a selected product or service, enabling the customers to initiate a support case for the selected product or service, and enabling the subset of the participants associated with the product or service to communicate in order to resolve the support case.

### CROSS-REFERENCE TO RELATED APPLICATIONS

This application claims priority under 35 U.S.C. §119 to provisional application Ser. No. 61/701,025 filed Sep. 14, 2012, herein incorporated by reference in its entirety.

### FIELD OF THE INVENTION

The present invention relates to customer support. More particularly, but not exclusively, the present invention relates to methods, system and apparatus for providing customer support.

### BACKGROUND OF THE INVENTION

Providing immediate and effective service and support for customers is a difficult challenge faced by many companies. The question is how to best involve actual personnel in the process of solving critical support cases while arriving at effective case resolution rapidly. The staffing, training and time required to give the customer the kind of support that makes an actual difference when something goes wrong is cost prohibitive for many companies. Even if the expense of putting the personnel in place is not an object, the knowledge required to adequately support the customer may still be missing. The difficulty lies in the fact that the knowledge required to support a complex product, installation or project is often connected to a group of people whose first priority is not service and support. It may be the engineers, designers or scientists who developed the product that would be best-suited to solve the problem but it is very difficult to keep these people engaged or involved in a way that can be of any real help to the customer and the support team. Many times, the result is a frustrating experience for the customer and a perception that the company supporting them is not knowledgeable about their own products or service or does not place sufficient importance on customer support.

In particular situations any number of additional challenges may also be present. For example, even a small capital equipment manufacturer may have equipment installed throughout the world. Moreover, some types of equipment may be vital to a customer's operations and thus a deeper relationship between customers and equipment manufacturers may be needed. For example, equipment which is installed in-line becomes a critical part of a manufacturing line and thus it is critically important that the manufacturing line remain operable.

Although knowledge of a product or service is essential to good customer support, knowledge is not enough to provide customer support. There are also problems with providing constant and consistent communication and accurate case management. It can be very difficult to keep track of multiple service and support cases related to a project or product in the field. Multiple cases, if not sorted and managed properly, can be confusing and may cause miscommunication and lost productivity. This process can become especially difficult when multiple service organizations or “resolvers” working on the issue are located in different companies around the globe.

In addition, there may be significant variation in complexity of customer service cases. Typical cases can range in complexity from simple questions about how to change a setting on a system to very complex maintenance issues. Adding to the difficulty is the variety of equipment in place and the different operational parameters of each individual system.

Another problem with customer support relates to response time. Response time may be critical when dealing with products that run in manufacturing environments or with a project on a tight timeline. This response time can be the difference between whether or not a customer is able to hit their production numbers. A slow response or a delay in getting the right answer to a problem can be very costly to the customer. Moreover some delays may be caused by failure to immediately involve the most appropriate people early on in the process. There are related problems in escalating problems in a manner which gets the right answer from the right person. Consider, for example, the problem of a control module may be generating an error that causes a system to shut down. That error may be caused by something that very few people are able to identify. The challenge would be how to quickly engage the person with the right answer. Failure to do so can result in involving numerous people who may not be able to provide the right answer.

Another problem is that sometimes the person with the right answer has a primary function which is unrelated to product support. Engineers and developers, whose primary function is unrelated to product support, often make poor support personnel. Concern for the customer is usually not the issue, it is simply that they are already involved in other initiatives and the continual interruption of managing support calls can be a significant disruption.

Customer's desire for immediate support is further complicated when one considers that in the global economy support is not generally isolated to one small region. Suppliers are challenged with supporting their products in widely distributed markets that span the entire globe. However, the expectation for effective customer service from the customer is the same whether they are across the street or in another country. They want immediate response to their critical problems and resolutions that keep their program up and running This generally involves a 24/7 type of support approach due to time zone differences as well as the “around-the-clock” operation of many companies. Suppliers, no matter how small, have to be available to these clients and ready to respond properly.

Where small companies have customers from around the world, being able to provide 24/7 service support for all customers can be expensive.

Another problem relates to third parties. Involving a third party in a support case can be difficult. It is a labor-intensive process to bring others up to speed on all the particulars of a case. There is detail and communication that is often lost each time a new person is brought in. A third-party supplier, another customer contact or a new service group may need to be included in the case, but this process can be time-consuming and often results in miscommunication and lost information.

Another problem relates to the integration of components from others. When a manufacturer includes components of others they may be assuming responsibility of supporting those components once installed in their customer base. Thus, the supplier's product may be the problem yet the manufacturer providing support is still tasked with diagnosing the problem and chasing down the supplier to assist with the solution.

Additional problems relate to billing for service and support and managing the complexities of spare parts and other revenue-based activities. Many times the customer is confused about what is billable and what is not, as well as what to expect for charges on a service call. When tracking billable service a company should be able to produce documentation showing that the case was resolved and a record of the time spent on the case. This is another confusing component of the support process that can cause questions in the customer's mind.

Therefore, what is needed are improved methods, systems, and apparatus which assist in facilitating customer service and customer support.

### SUMMARY

Therefore, it is a primary object, feature, or advantage of the present invention to improve over the state of the art.

It is a further object, feature, or advantage of the present invention to assist in facilitating customer service and customer support.

Another object, feature, or advantage of the present invention is to share the load of supporting customer, to increase exposure to the knowledgeable people on all sides of the support case in a manner which allows costs to be reduced or revenue opportunities to be generated.

It is a further object, feature, or advantage of the present invention to spread out a support load amongst a plurality of different teams within an organization, such as a knowledgeable development team and knowledgeable manufacturing team.

It is a still further object, feature, or advantage of the present invention to distribute the support load in a manner which avoids costly interruptions to team members.

A still further object, feature, or advantage of the present invention is to reduce and shorten the amount of time it takes to resolve a case by easily involving other resolvers and customer personnel in the case.

Another object, feature, or advantage of the present invention is to simplify management of suppliers, customers and equipment to one primary support manager.

Yet another object, feature, or advantage of the present invention is to provide the customer with an immediate and ongoing visibility into product support cases and product performance so they are always in the loop.

A further object, feature, or advantage of the present invention is to simplify the report generating for customers, products and cases.

A still further object, feature, or advantage of the present invention is to link support incidents directly to specific products so there is never a question about which product and customer is being serviced.

Another object, feature, or advantage of the present invention is to manage and store the documents, data, communication and complexities of service issues with 100 percent access and visibility to the involved parties.

Yet another object, feature, or advantage of the present invention is to allow for tracking of billable time, spare parts requirements and other revenue generating activities associated with products and support cases.

A further object, feature, or advantage of the present invention is to give supporting team members visibility to all support cases without exception, regardless of their global location.

A still further object, feature, or advantage of the present invention is to reduce costs associated with service and support by keeping the size of the support team small while, at the same time, increasing the number of people available to assist the customer.

Another object, feature, or advantage of the present invention is to increase the customer's access to support help without creating additional work for the customer in accessing that help

Yet another object, feature, or advantage of the present invention is to provide customers with 24/7 response to their support requests without overloading the supporting team members.

A further object, feature, or advantage of the present invention is to provide a method, apparatus, and system which is seamlessly adaptable and simple for the customer to understand and utilize.

Another object, feature, or advantage of the present invention is to provide a low-cost and easily implemented solution to product support which gives clients the advantage in support case resolution.

Yet another object, feature, or advantage of the present invention is the ability to link specific people to specific products and to sort these products and related support cases, resulting in a seamless communication link that maximizes the customers' up-time and support experience.

A further object, feature, or advantage of the present invention is to provide support case escalation and management.

A still further object, feature, or advantage of the present invention is to provide labor savings through shared responsibilities.

Another object, feature, or advantage of the present invention is to provide a repository for images, documents, specific to any supported product

Yet another object, feature, or advantage of the present invention is to provide case information tracking and storage.

A further object, feature, or advantage of the present invention is to provide targeted advertising capability.

A still further object, feature, or advantage of the present invention is to assist in maximizing customer up-time. Another object, feature, or advantage of the present invention is to provide improved customer perception and relationship building.

Yet another object, feature, or advantage of the present invention is to provide for automatically building a customer list and contact database.

A further object, feature, or advantage of the present invention is to provide a support link in the form of a product-person link which allows for attaching and/or linking a user to a specific product for support on that product. Thereby allowing people to be linked only to the products they care about, whether they are supporting a product or receiving support on a product.

A still further object, feature, or advantage of the present invention is to provide for multi-product linking thereby allowing users to be linked to multiple products thereby allowing users to be linked to all of the products they care most about receiving or giving support on and it sets the stage for Multi-Product Support.

Another object, feature, or advantage of the present invention is to provide bi-modal multi-product support thereby allowing a user to support and be supported on multiple products from the same account. Thus, a user can receive support on all products pertinent to him—in one place. It also gives him the ability to support every product within his company that he is responsible for, again—in one place. These two features work together enabling a user to support multiple products and receive support on multiple products—all in one place.

Yet another object, feature, or advantage of the present invention is to provide for multi-company linking thus allowing users to be linked to multiple supporting companies. In the event that a user is employed by both Company A and Company B and is supporting products for both companies, he has the ability to be linked to both Company A and B. He can toggle between the two companies and see real-time changes in his total Support Case numbers and products he supports in his Dashboard.

A further object, feature, or advantage of the present invention is to provide a user to user invite onto a product with administrator permission. Thus, a user may be invited to ‘follow’ a product by a user who is already linked to that product. The request is then pending approval from a company Administrator. Once accepted by the company Admin, the invite request is pending acceptance from the invited user. The invited user can choose to ‘follow’ the product or deny the invitation. In the case that the invited user denies the invitation, he is ‘unfollowing’ the product. He cannot remove himself completely from a product, as that is up to the company Admin, he can only ‘unfollow’ the product. This feature helps ensure that the right people are linked to the right products.

A further object, feature, or advantage of the present invention is to allow a user to follow a product.

A still further object, feature, or advantage of the present invention is the ability to set up different Support Case types or tracks.

Another object, feature, or advantage of the present invention is to allow for photos, videos and documents to be uploaded to a specific Support Case or track.

Yet another object, feature, or advantage of the present invention is to allow a user to be invited to join a Support Case or track by a user already linked to the product and involved in the Support Case.

A further object, feature, or advantage of the present invention it to allow a user who is linked to a product to receive activity stream notifications on the product.

Another object, feature, or advantage of the present invention is to provide for managing notifications.

A still further object, feature, or advantage of the present invention is to provide visibility by allowing a user to see and communicate with everyone linked to the same product.

Another object, feature, or advantage of the present invention is to allow a user to view all new, open, and closed Support Cases or tracks that have been created on all of his products on one page.

Yet another object, feature, or advantage of the present invention is to provide companies using the system to purchase ad space targeted to their customers.

A still further object, feature, or advantage of the present invention is to provide for product-centric communication between participants.

The present invention contemplates these and/or other objects, features, or advantages. No single embodiment need meet or provide every object, feature, or advantage. Different embodiments may have different objects, features, or advantages. The present invention is not to be limited to these objects, features, or advantages.

According to one aspect of the present invention, a method executed at least in part in a computing device for providing cloud based customer support services is provided. The method includes providing a cloud based service enabling data interchange between participants of a cloud based support service, the participants including customers seeking support on products or services and support personnel from companies providing the products or services. The method further includes associating a subset of the participants with a selected product or service, enabling the customers to initiate a support case for the selected product or service, and enabling the subset of the participants associated with the product or service to communicate in order to resolve the support case.

According to another aspect of the present invention, a system for providing cloud based customer support services is provided. The system includes a cloud based server providing a cloud based service enabling data interchange between participants of a cloud based support service, the participants including customers seeking support on products or services and support personnel from companies providing the products or services. Preferably, the cloud based server is programmed to perform the steps of associating a subset of the participants with a selected product or service, enabling the customers to initiate a support case for the selected product or service, and enabling the subset of the participants associated with the product or service to communicate in order to resolve the support case.

According to another aspect of the present invention, a method executed at least in part in a computing device for providing cloud based customer support services is provided. The method includes providing a cloud based service enabling data interchange between participants of a cloud based support service, the participants including customers seeking support on products or services and support personnel from companies providing the products or services, the cloud based service providing access to a database stored on a non-transitory computer readable storage medium and providing a user interface, associating a subset of the participants with a selected product or service through the user interface associated with the cloud based service, enabling the customers to initiate a support case for the selected product or service through the user interface associated with the cloud based service, and enabling the subset of the participants associated with the product or service to communicate in order to resolve the support case through the user interface of the cloud based service.

According to yet another aspect of the present invention, a method for providing customer support includes providing a cloud based service enabling data interchange between participants of a cloud based support service, the participants including customers seeking support on products or services and support personnel from companies providing the products or services, the cloud based service providing access to a database stored on a non-transitory computer readable storage medium and providing a user interface. The method further includes providing access to a plurality of companies providing support to their customers using the cloud-based service on the host device.

### BRIEF DESCRIPTION OF THE DRAWINGS

FIG. 1 is a block diagram of one embodiment of the present invention.

FIG. 2 illustrates a screen display of a page allowing a user to set up an account and join the cloud-based support service, log into an existing account, or find out more information about the service. There is also a link to assist individuals in registering their company to provide support for customers.

FIG. 3 illustrates a screen display of a page which may be display after a user logs into their account. This page houses all of the products the user is following. If there is a new or open support case on any product a user is following, it will appear next to the product in the form of a red or blue notification box. This page may also be personalized giving a user the ability to rearrange the order in which the user views the products. The user may view them in a ‘list’ view, organize products into folders, or unfollow a product.

FIG. 4 illustrates a screen display of a page which may be displayed after a user selects a product from their Dashboard. The product overview page shows all of that product's information and gives the user an activity feed for that specific product.

FIG. 5 illustrates a screen display of a page containing a tab which lists all of the Support Cases that are associated with this specific product.

FIG. 6 illustrates a screen display of a page containing a tab which shows the various image folders that store images of this specific product. Clicking on an image folder displays all of the photos and videos inside that folder.

FIG. 7 illustrates a screen display of a page containing a tab which lists all of the documents that have been uploaded to this specific product.

FIG. 8 illustrates a screen display of a page containing a tab which shows all of the people that are linked to this specific product. These are the only people that will receive notifications on Support Cases or any other activity specific to this product.

FIG. 9 illustrates a screen display of a page which may be viewed after selecting a Support Case. The overview tab shows all of the Support Case information. The creator of the case has the ability to change the status from open to closed or change the type, severity, name or description of the case.

FIG. 10 illustrates a screen display of a method of communication between people within a Support Case. Through Support Chat users may have real-time conversations with the people that can best support a customer for the product they need assistance with. A user can also invite other users to a Support Case regardless if they are following that product or not. Images and documents may be uploaded directly to a Support Case within the Support Chat as well.

FIG. 11 illustrates a screen display of a page containing a tab which shows images that have been uploaded to the specific Support Case.

FIG. 12 illustrates a screen display of the Image Viewer displays after a user selects any image. This will display when the image was uploaded and the user who uploaded it. Image information such as an image name or image description may also be displayed here.

FIG. 13 illustrates a screen display of a page containing a tab which is not viewable to a client. It is only viewable by a member of the supporting company. It is used to track the time spent on each Support Case. This is used to create a report that an Admin of the company site can then use to bill the client.

FIG. 14 illustrates a screen display of the page which may be used in creating a new Support Case. A user may be able to name the case, write a case description, specify the case type, and choose the severity of the case.

FIG. 15 illustrates a screen display of the page which is all about a user and includes information such as name, position in a company, email(s), and phone number(s). A user can choose what information is viewable to the public. A user can also upload a profile picture on this page that will be used as a thumbnail throughout the cloud-based service wherever their name appears.

FIG. 16 illustrates a screen display of a dashboard allowing a user to select a product or a folder or group of products.

FIG. 17 illustrates a screen display showing products within a folder or group of products.

FIG. 18 illustrates a screen display showing companies supporting a user.

FIG. 19 illustrates a screen display showing a product of a company.

FIG. 20 illustrates a screen display providing an overview of a product.

FIG. 21 illustrates a screen display showing support cases for a product.

FIG. 22 illustrates images available for a product.

FIG. 23 illustrates system images available for a product.

FIG. 24 illustrates a system image for a product and associated image information.

FIG. 25 illustrates folders containing documents available for a product including product documents and case folders.

FIG. 26 illustrates a document available for a product.

FIG. 27 illustrates a screen display shown people associated with a company which supports a product and people receiving support.

FIG. 28 illustrates an overview for a support case.

FIG. 29 illustrates a chat feature for a support case.

FIG. 30 illustrates activity information.

FIG. 31 illustrates chat information.

FIG. 32 illustrates echoed cases that a user is being supported on.

FIG. 33 illustrates a screen display for creating a new advertisement.

FIG. 34 illustrates a screen display for managing advertisements.

FIG. 35 illustrates another screen display for managing an advertisement.

FIG. 36 illustrates a screen display for an administrator log in.

FIG. 37 illustrates a screen display or selecting a company.

FIG. 38 illustrates a screen display for editing company information including the name of the company and a logo of the company.

FIG. 39 illustrates editing a company name.

FIG. 40 illustrates a screen display for managing support groups.

FIG. 41 illustrates another screen display for managing support groups.

FIG. 42 illustrates creating a new support group.

FIG. 43 illustrates editing an existing support group.

FIG. 44 illustrates adding a supporter to a support group.

FIG. 45 illustrates a screen display for arranging support groups.

FIG. 46 is a screen display illustrating products for a company.

FIG. 47 is a screen display illustrating support personnel for a company.

FIG. 48 is a screen display illustrating adding a supporter to a company.

FIG. 49 is a screen display further illustrating adding a supporter to a company.

FIG. 50 is a screen display for editing a supporter.

FIG. 51 illustrates a screen display with multiple dashboard.

FIG. 52 illustrates a screen display showing profiles for different products.

FIG. 53 illustrates a screen display showing tracks.

FIG. 54 illustrates a screen display showing a profile for a particular product.

FIG. 55 illustrates a screen display where the tracks tab is selected for a product.

FIG. 56 illustrates a screen display where the photos tab is selected.

FIG. 57 illustrates a screen display where the documents tab is shown.

FIG. 58 illustrates a screen display where the people tab is selected.

FIG. 59 illustrates a screen display showing the editing of a profile for a product.

FIG. 60 illustrates a screen display for creating a new case or track.

FIG. 61 illustrates a screen display associated with a track.

FIG. 62 illustrates a screen display associated with a track where the overview tab is selected.

FIG. 63 illustrates a screen display associated with a track where the people tab is selected.

FIG. 64 illustrates a screen display after the button for adding other people is selected.

FIG. 65 illustrates a screen display with a window which may be used to disconnect a person from a particular track.

FIG. 66 illustrates a screen display with the photos tab selected.

FIG. 67 illustrates a screen display with the documents tab selected.

FIG. 68 illustrates a screen display with profiles that a user is following as well as notifications.

FIG. 69 illustrates a screen display for editing a profile or account of a user.

FIG. 70 illustrates a screen display for an administrator to use to add or edit information about a company.

FIG. 71 illustrates a screen display for an administrator to use to maintain company personnel.

FIG. 72 illustrates a screen display for an administrator to delete profiles.

FIG. 73 illustrates a screen display where the second dashboard is selected.

FIG. 74 illustrates a screen display showing profile connections sorted by company.

FIG. 75 illustrates a screen display showing profiles associated with a selected company.

### DETAILED DESCRIPTION OF THE PREFERRED EMBODIMENTS

The present invention provides for methods, apparatus, and systems for providing customer support. Although specific embodiments are shown and described herein, the present invention is not to be limited to the specific embodiments described.

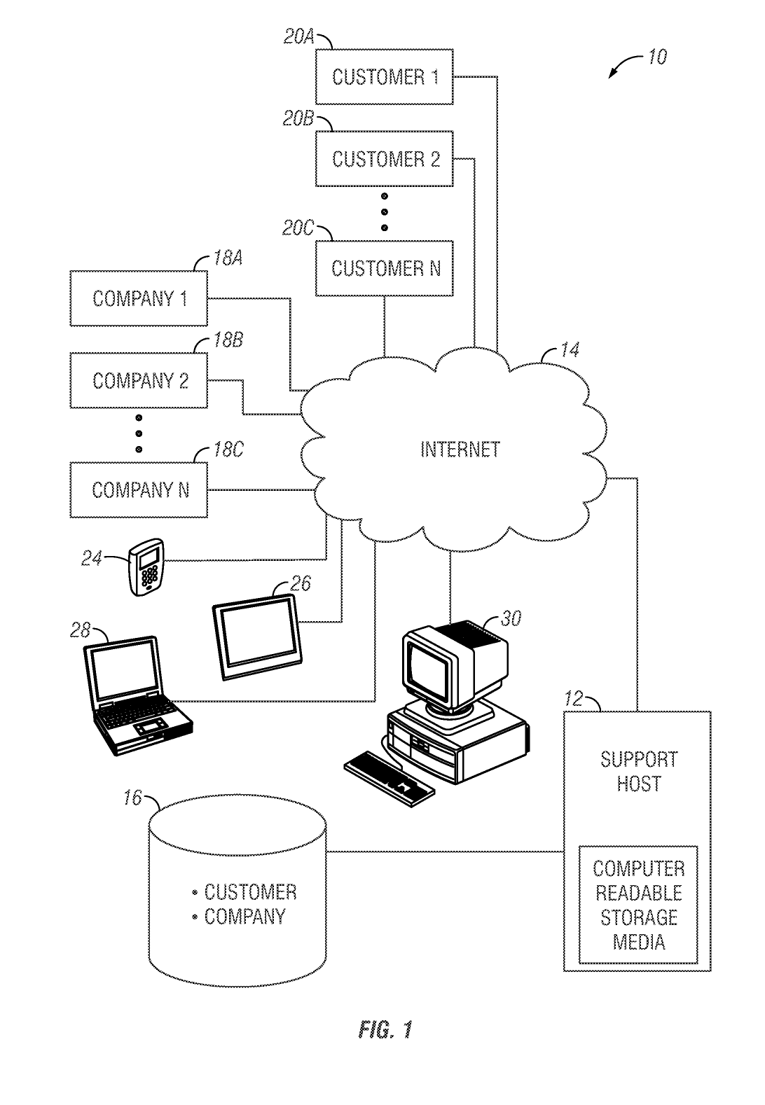

As shown in FIG. 1, a system 10 is provided. The system 10 includes a host 12 which is a computing device which may be configured to act as a web server or other cloud based server. There is a computer readable storage medium associated with the host 12 which is non-transitory. A database 16 may be accessible to the host 12. The database 16 may include data associated with customers, companies, and their accounts. Collectively those who access the cloud-based service may be referred to as participants. Any number of companies 18A, 18B, 18C and their support personnel may access the host 12 through a network such as the internet 14. Similarly, any number of customers 20A, 20B, 20C may access the host 12. Any number of types of computing devices may be used to access the host 12, include mobile devices such as phones 24, tablet devices 26, notebook computers 28, or desktop computers 30.

The host 12 provides a hosted application that does not require packaged distribution. Companies may be provided with administrative rights and the ability to host and support their customer and product base and may be required to pay a license fee. Customers may sign up in a manner that is preferably simple and preferably without fee. Once registered, a customer may be supported by any company that uses the system. Thus, it is contemplated that a customer who is a customer of multiple companies which are a part of the system can receive support from all of the companies through the system. Thus, customers may receive additional benefits where multiple companies they have relationships with provide support through the same system.

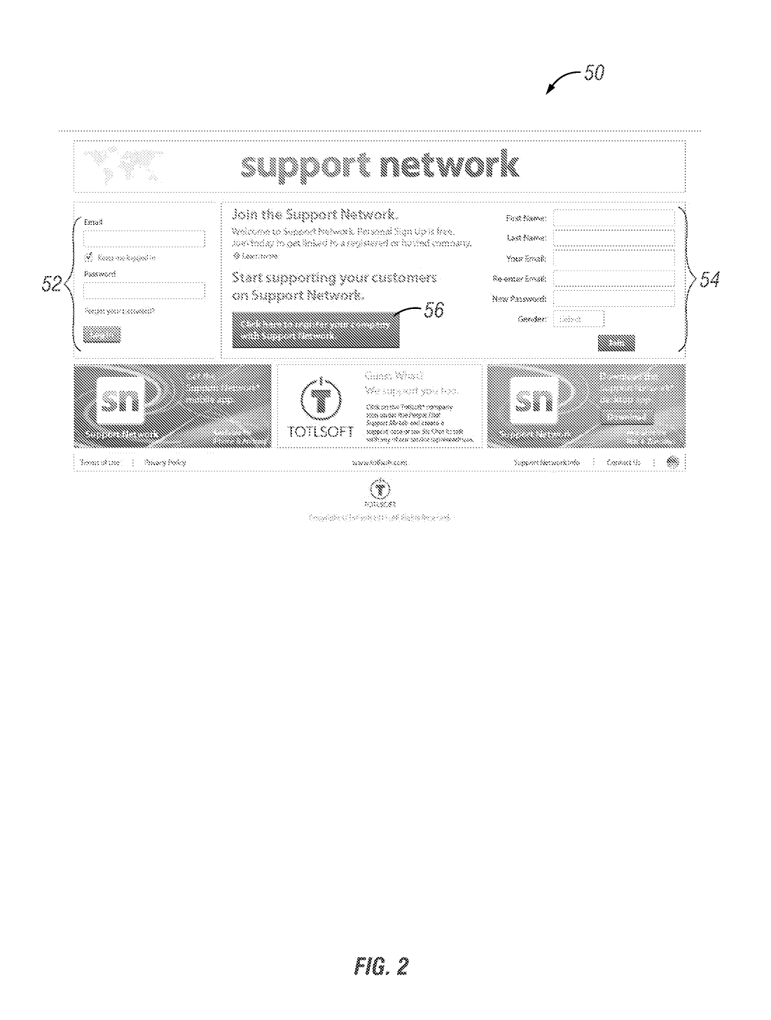

FIG. 2 illustrates a screen display 50. A login area 52 allows a user to log-into an existing account. There is also a registration area 54 for new customers. There is also a link 56 which may be followed to register a company so that the company can start supporting customers right away. Other information may be presented on the screen display including additional information about the services or links to additional information about the services, download links to applications for different platforms, or other information.

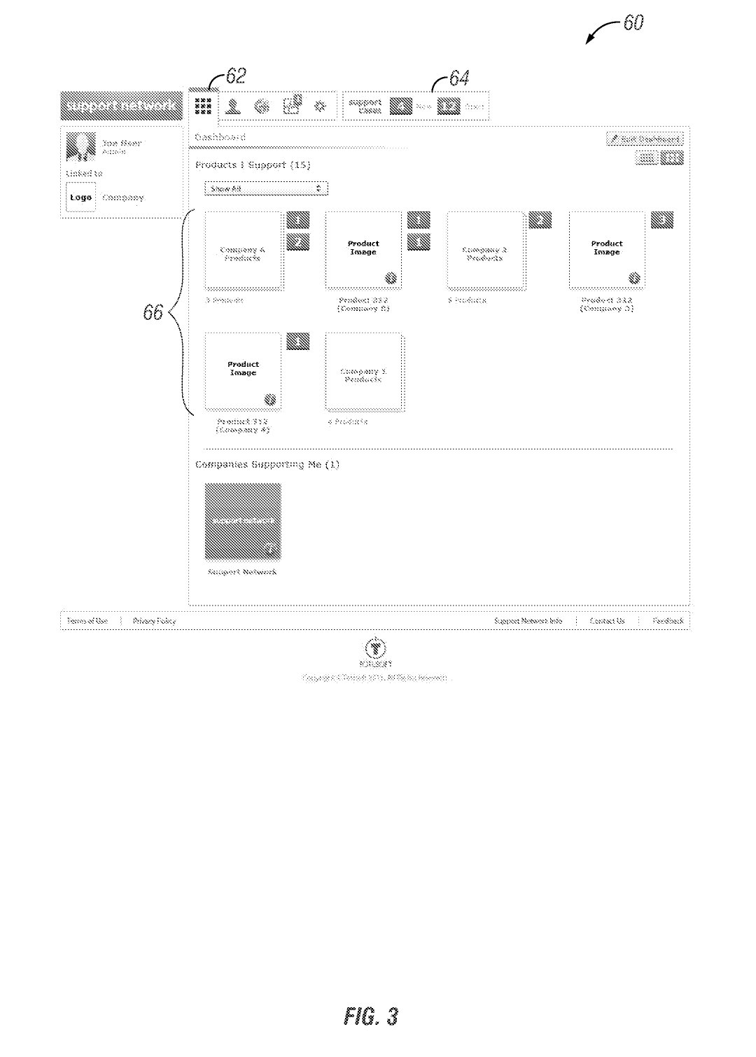

FIG. 3 is a screen display 60 which may be presented to a user after logging into their account. The screen display includes a dashboard 62 as well as relevant information 64 such as the number of support cases which are new and/or open. In the area 66 all of the products which the user is following are shown along with an indication of the number of support cases (new and/or open) for that product. Different colors may be used for these notifications. Preferably, the display of information may be personalized for a user such as by allowing a user the rearrange the order in which products are viewed. For example, a user may be able to list the products in a list view, organize the products into folders or unfollow a product if you choose. Thus, the present invention contemplates that a user may be linked to multiple products and thus allows for multi-product support.

It is also noted that the present invention allows for bi-modal multi-product support and allows users to support and be supported on multiple products through the same account. Bi-Modal Multi-Product Support enables a user to receive support on all products pertinent to the user—in one place. It also gives the user the ability to support every product within their company that the user is responsible for, again—in one place.

When a user is ‘following’ a product it means he wants to receive notifications about all activity connected to that product and be able to view the new, closed, and open Support Cases on that product in his main Support Case menu. The main Support Case menu keeps a running total of all new and open Support Cases on all products the user is following. Once invited onto a product by another user already associated with that product, the invited user may choose to accept the invite and follow that product or decline the invite, in which case the user would not be following the product. Any ‘unfollowed’ products can be viewed in the Dashboard by selecting “Unfollowed Products” from the drop down filter. The user then has the option to ‘follow’ the product, in which case the user would receive notifications on all activity on that product. If the user wanted to ‘unfollow’ a currently ‘followed’ product, the user would do so by editing their dashboard and choosing the ‘unfollow’ option next to the product icon. ‘Follow’ allows a user to fully customize what products the user receives information on so that there is only receiving notifications regarding the products the user cares about.

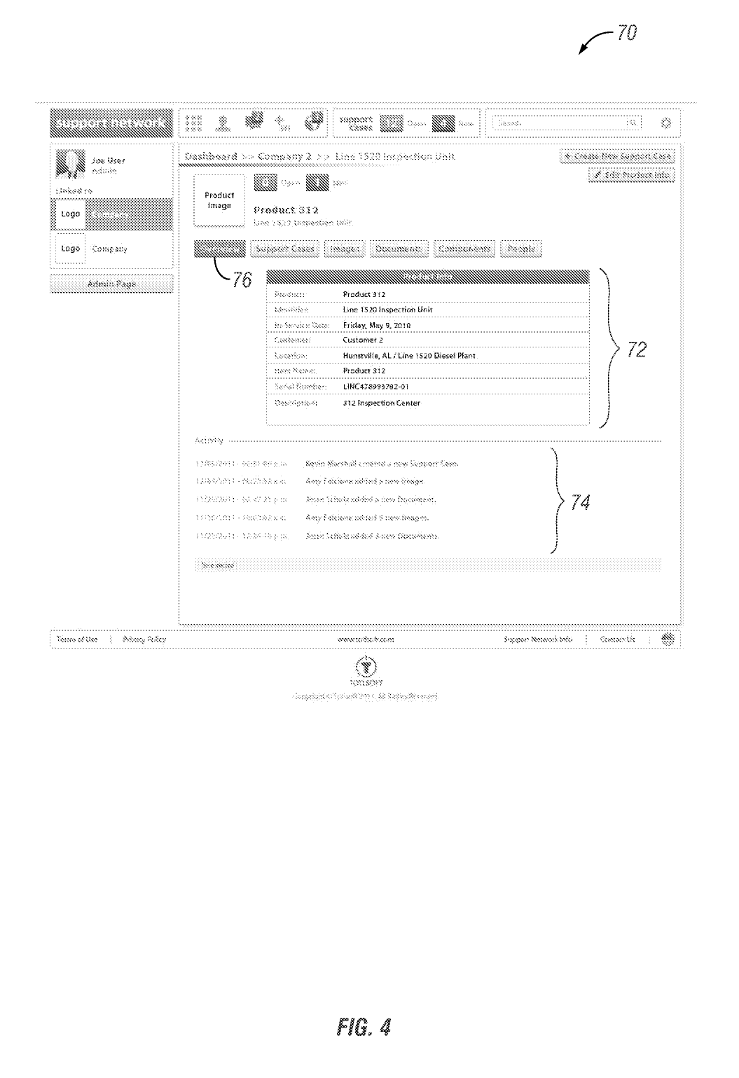

FIG. 4 is a screen display 70 which may be presented to a user after they select a product from the dashboard shown in FIG. 3. The screen display 70 shows an overview 76 of a product which includes such information as product information 72 and activity feedback 74. Examples of product information include a product name, a product identifier, an in-service data, a customer name, a customer location, an item name, a serial number, and a description. Examples of activity information may include date and time information as well type of activity and user performing the activity. Examples of such activities may include when a new support case is created, content such as documents or images are added or other activities. Thus, a user may be attached or linked to a specific product for support on that product. This allows people to be linked only to the products they care about, whether they are supporting a product or receiving support on a product.

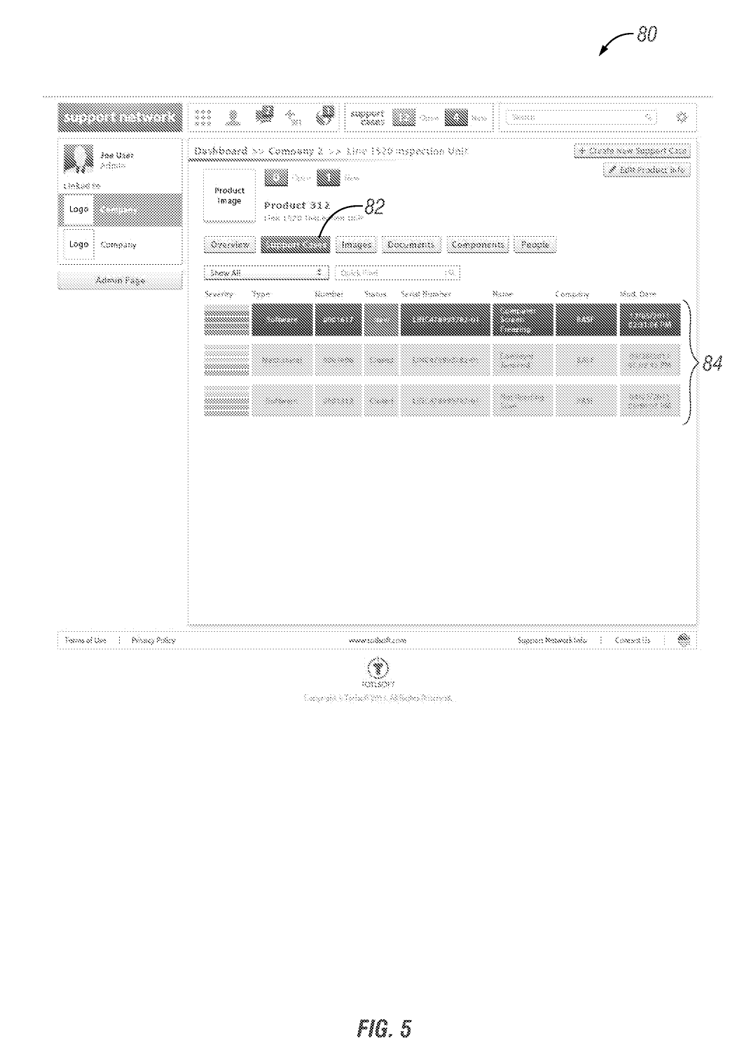

FIG. 5 illustrates a screen display 80 with a support cases tab 82 which provides a listing 84 of all of the support cases that are associated with the selected product. Information about the support cases can be shown in various ways. For example, different colors may be used to specify different severity or different priority. The information can also include the type of case such as software, mechanical, electrical, or other type. The information can further indicate a number or other identifier of the support ticket or case, the status of the case (such as new, open, or closed), the serial number for the product, a name or description for the support case, the company or customer experiencing the issue, and date and time information.

A company administrator or Admin can set up different Support Case types. The case type setup may pertain to all of the company's products being supported and is not limited to just one product. When a user creates a new Support Case and selects a case type, that case is then categorized as such. Different case types specify the category of a Support Case. A user can choose to only be notified about certain types of Support Cases.

Support Case types help categorize the Support Cases for the customer service people working to solve them. Categorizing cases in this way narrows down the possible reasons for needed support and helps ensure the right people are notified immediately so the problem can be solved as quickly as possible.

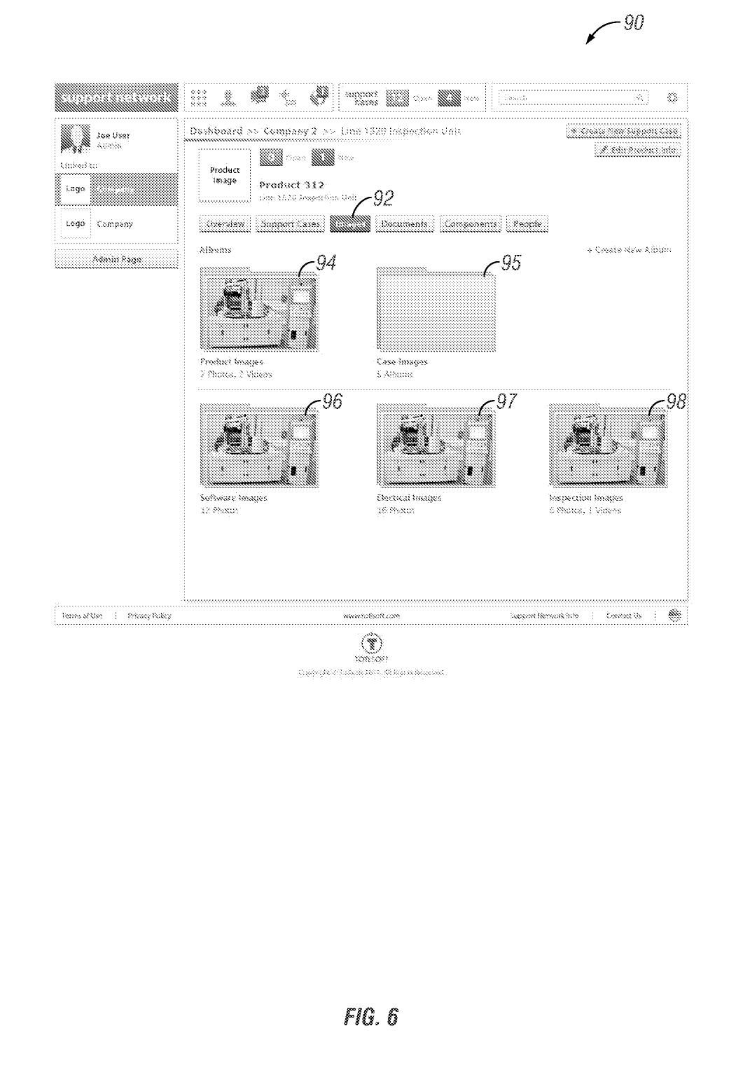

FIG. 6 illustrates a screen display 90 containing a tab 92 which shows the various image folders that store images of this specific product. Clicking on an image folder displays all of the photos and videos inside that folder. The image folders may include a product images folder 94, a case images folder 95, a software images folder 96, an electrical images folder 97, and an inspection images folder 98. Images or videos can serve a number of different purposes including to show what a product is and to document a problem with the product or its operations. Note that the folder name may be anything that a supporting company decided it should be for a particular product, thus the names shown are merely representative names.

Photos, videos and documents can be uploaded to a specific Support Case. These files are associated with a Support Case even after the case has been closed. Images and documents may be uploaded through the Support Case chat feature or on the “Images” or “Documents” tab within the Support Case. These images and documents may also be viewed by navigating to the “Images” or “Documents” tab within the product (not the case) and selecting the “Case Images” or “Case Documents” folder and then navigating to the case folder.

Rather than uploading images and documents onto the product itself and having other users have to dig through the mass of product images and documents to try and find the ones that relate to a specific Support Case, a user can simply upload these items directly to a Support Case and everything pertaining to that Support Case remains together in one place.

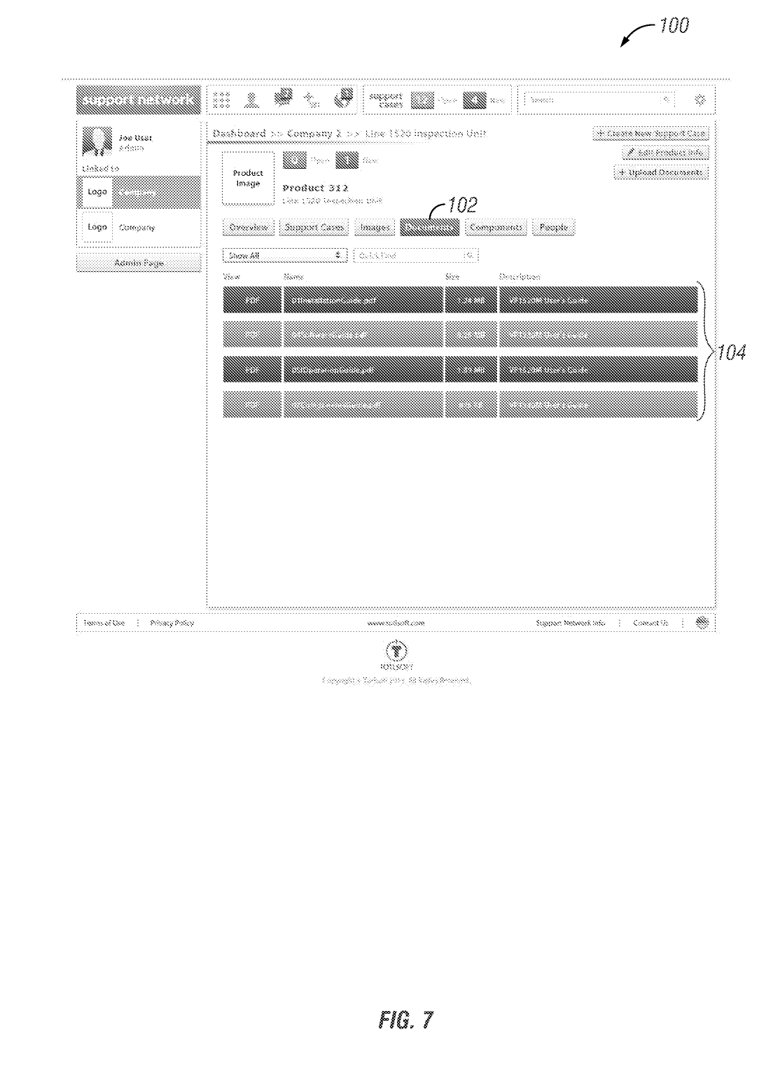

FIG. 7 illustrates a screen display 100 containing a tab 102 which provides a listing 104 of all of the documents that have been uploaded for a specific product. This may include such information as installation guides, user's guides, or other documentation relevant to the installation, operation, or maintenance of the product.

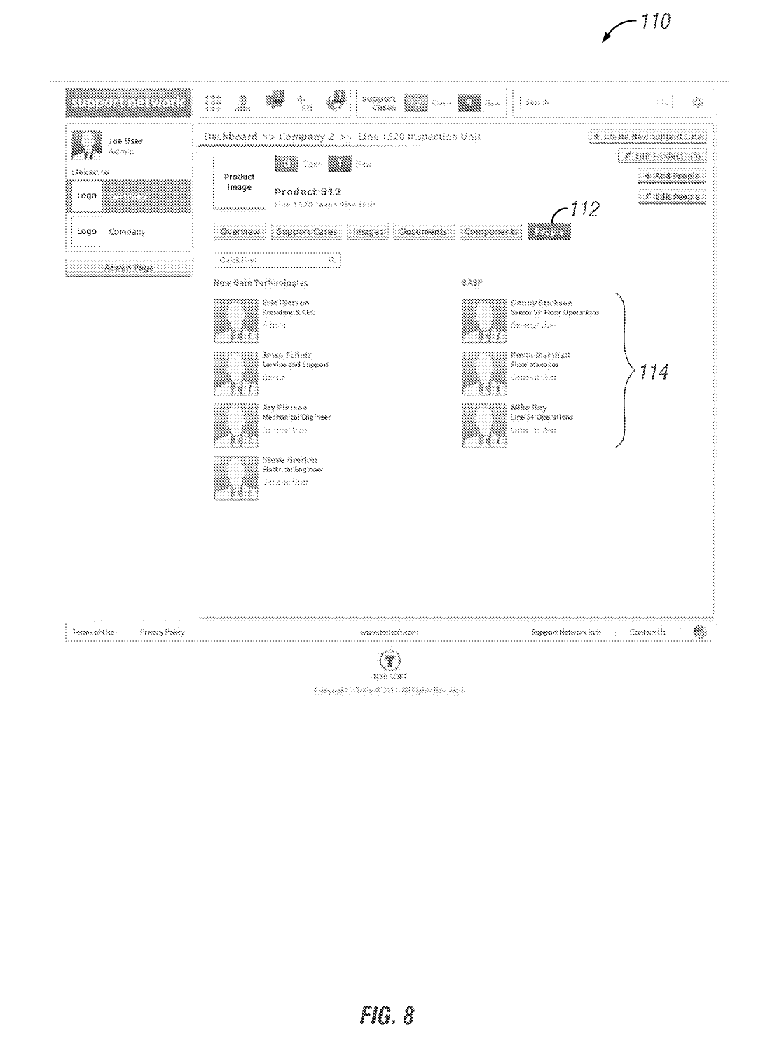

FIG. 8 illustrates a screen display 110 containing a tab 112 which shows a listing 114 of all of the people that are linked to this specific product. Such individuals may receive notifications on Support Cases or any other activity specific to this product.

Additional people may be “added” or invited onto the product with administrator permission. A user may be invited to ‘follow’ a product by a user who is already linked to that product. The request is then pending approval from a company Administrator. Once accepted by the company Admin, the invite request is pending acceptance from the invited user. The invited user can choose to ‘follow’ the product or deny the invitation. In the case that the invited user denies the invitation, the user is ‘unfollowing’ the product. A user cannot remove themselves completely from a product, as that is up to the company Admin, a user can only ‘unfollow’ the product. Although Admins have to approve what users are linked to a product, they may not always know exactly who to invite. That is where Plus 1 comes in, which is the ability for any user linked to a product to invite any other user onto that product. This feature helps ensure that the right people are linked to the right products.

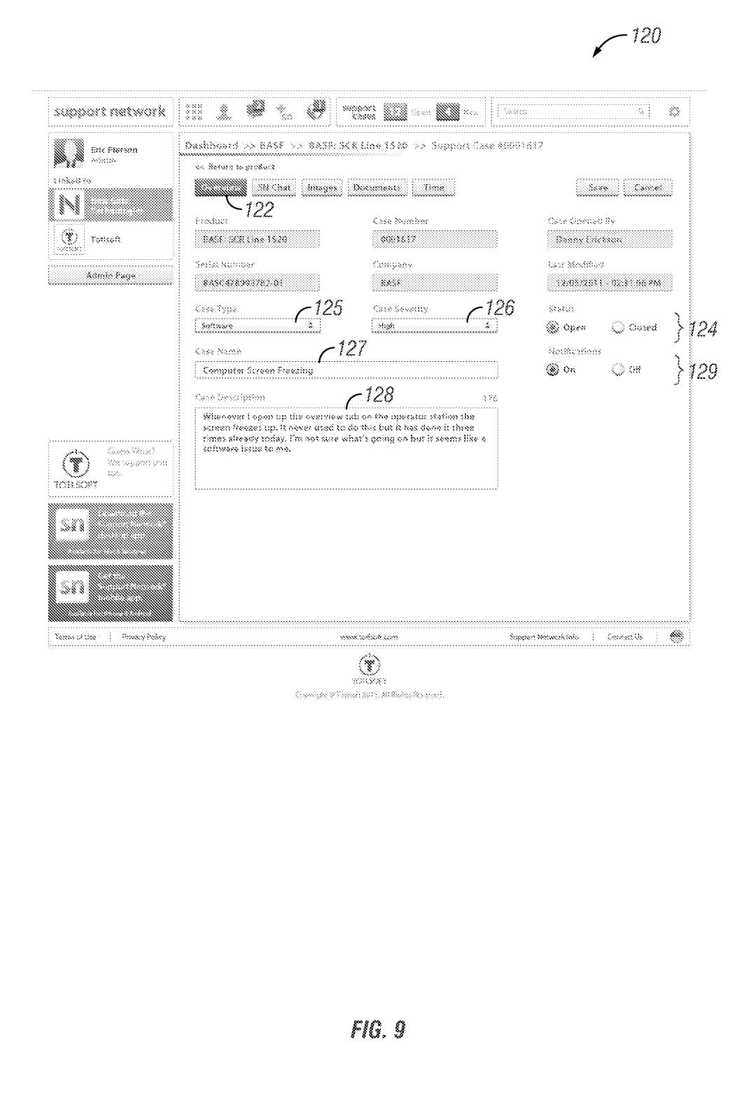

FIG. 9 illustrates a screen display 120 containing a tab 122 which provides an overview after a support case has been selected. The overview tab 122 shows all of the support case information. The creator of the case has the ability to change the status 125 from open to closed or change the type 125, severity 126, name 127 or description 128 of the case.

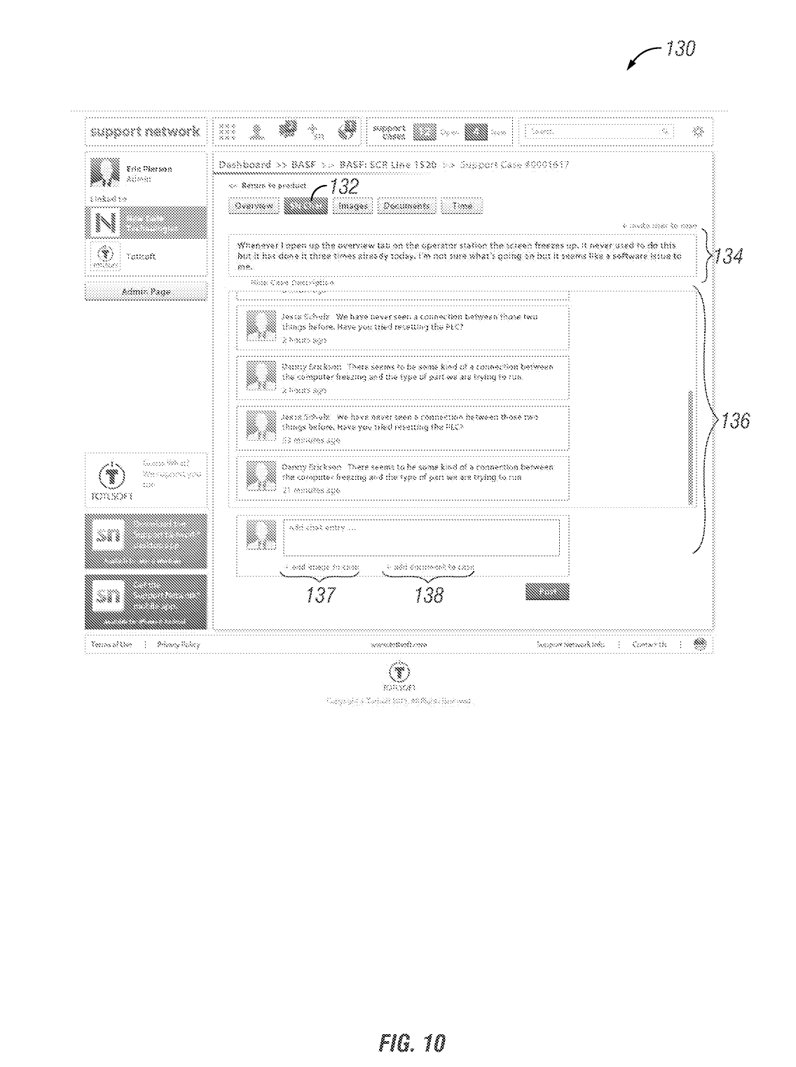

FIG. 10 illustrates a screen display 130 of a method of communication between people within a Support Case. A description 134 for the Support Case is shown. Through Support Chat a customer may have real-time conversations 136 with the people that can best support the user and the product. A user can also invite any user to a Support Case regardless if they are following that product or not. Images and documents may be uploaded directly to a Support Case within the Support Chat as well such as selecting to “add image to case” 137 or “add document to case” 138.

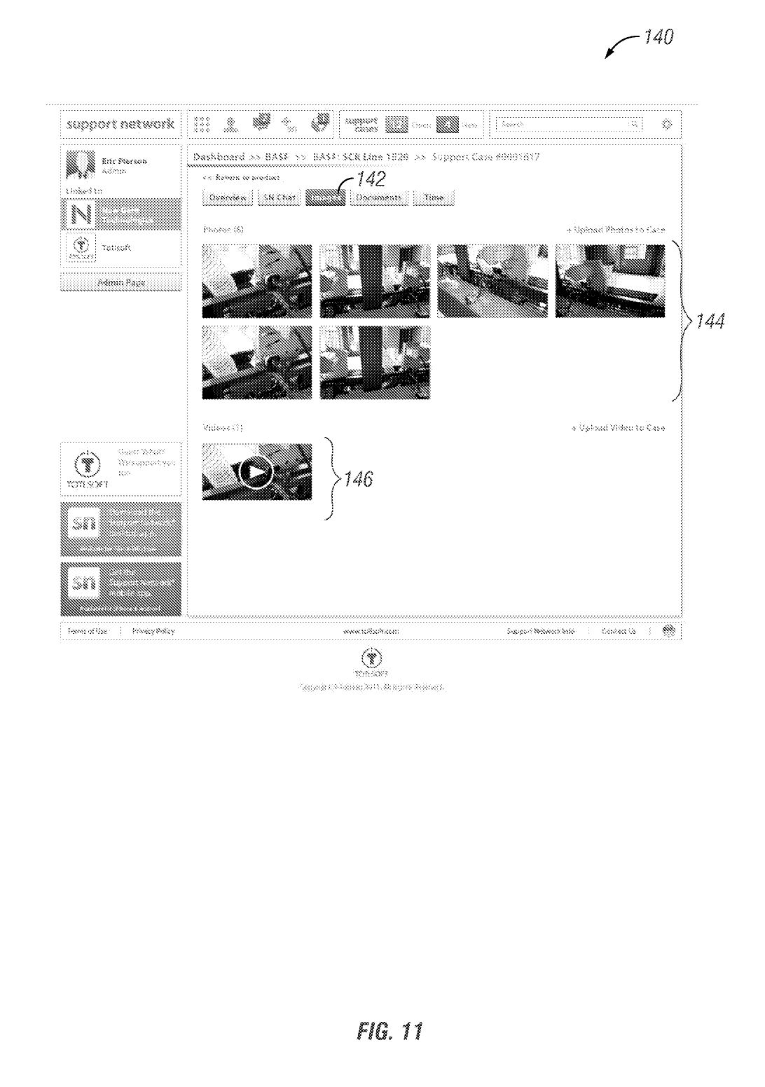

FIG. 11 illustrates a screen display 140 containing a tab 142 shows images that have been uploaded to the specific Support Case. This may include photos 144 as well as videos 146.

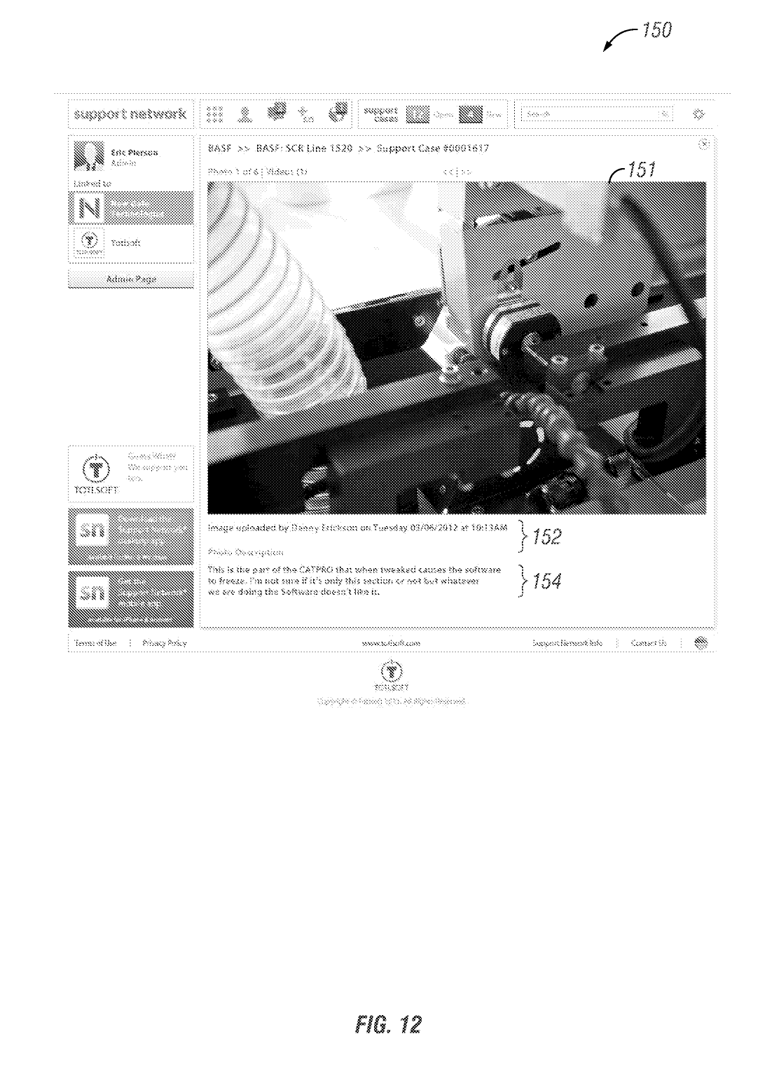

FIG. 12 illustrates a screen display 150 which includes an image viewer for viewing an image 151. The image viewer may be used whenever an image is selected. Once the image viewer is selected the image 151 will be displayed as well as other image information 152 will be displayed such as the user who uploaded the image, when the image was uploaded, and a description 154 of the image.

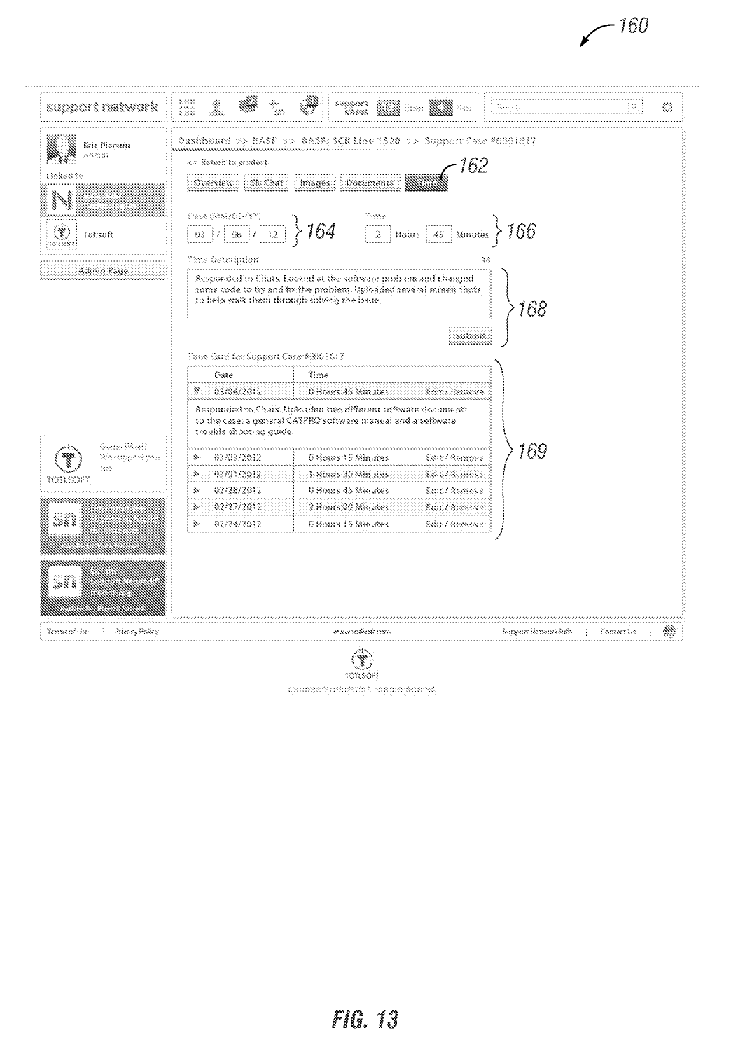

FIG. 13 illustrates a screen display 160 containing a time tab 162. The time tab 162 is not viewable to a client but is viewable by a member of the supporting company. The time tab 162 may be used to track the time spent on each Support Case. Recorded information may include a date 164, a time duration 166, and/or a description 168. A time card 169 for the Support Case may be provided. This information may be used to create a report than an Admin of the company can used to bill the client. Thus, the present invention allows for capturing the time spent on support tasks.

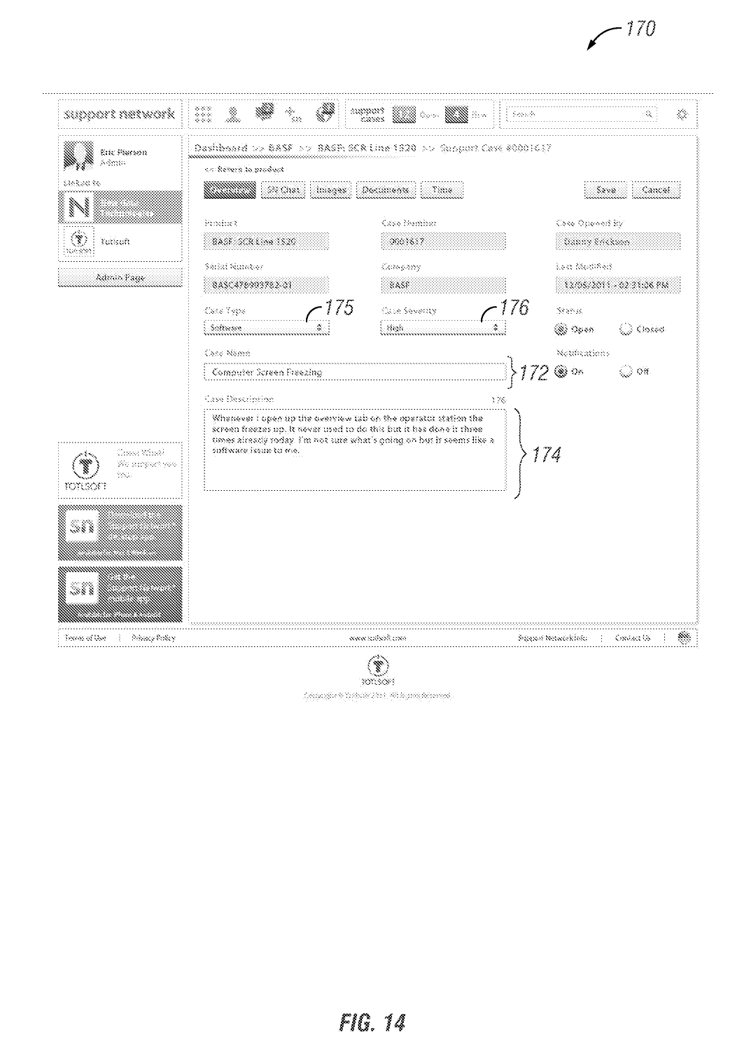

FIG. 14 illustrates a screen display 170 which may be viewed when creating a new Support Case. A user creating a new Support Case may provide a case name 12, a case description 174, a type of case 175, case severity 176, and other information.

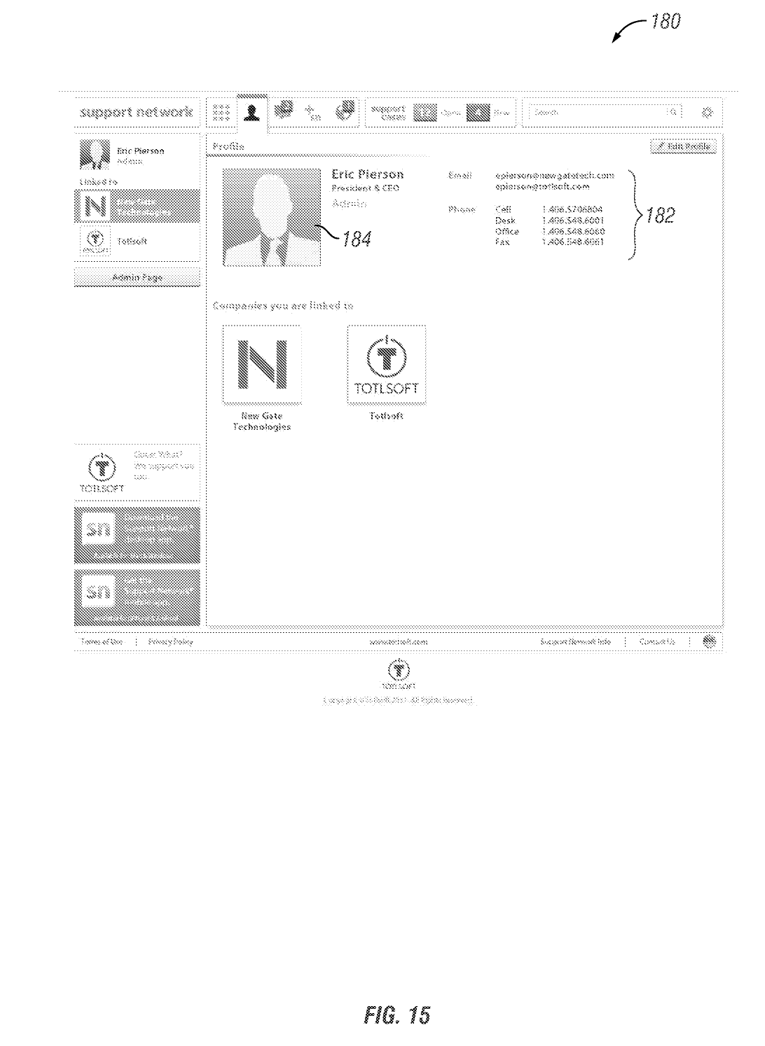

FIG. 15 illustrates a screen display 180 providing information about a user. Such information may include name, position within a company, email address(es), and phone number(s), and/or other contact information 182. A user can select which information is viewable to the public. A user can also upload a profile picture 184 on this page that will be used as a thumbnail whenever the user's name appears.

Note that as shown in FIG. 15 multi-company linking is permitted. Thus, users can be linked to multiple supporting companies. In the event that a user is employed by both Company A and Company B and is supporting products for both companies, the user has the ability to be linked to both Company A and B. The user can toggle between the two companies and see real-time changes in their total Support Case numbers and products he supports in their Dashboard. This is very useful for anyone trying to support multiple products over a range of several companies. A prime example of this would be a service contractor. Through Multi-Company Linking the service contractor can support several different companies' products and keep track of which products belong to which company. FIG. 15 illustrates a screen display of the page which is all about a user and includes information such as name, position in a company, email(s), and phone number(s). A user can choose what information is viewable to the public. A user can also upload a profile picture on this page that will be used as a thumbnail throughout the cloud-based service wherever their name appears.

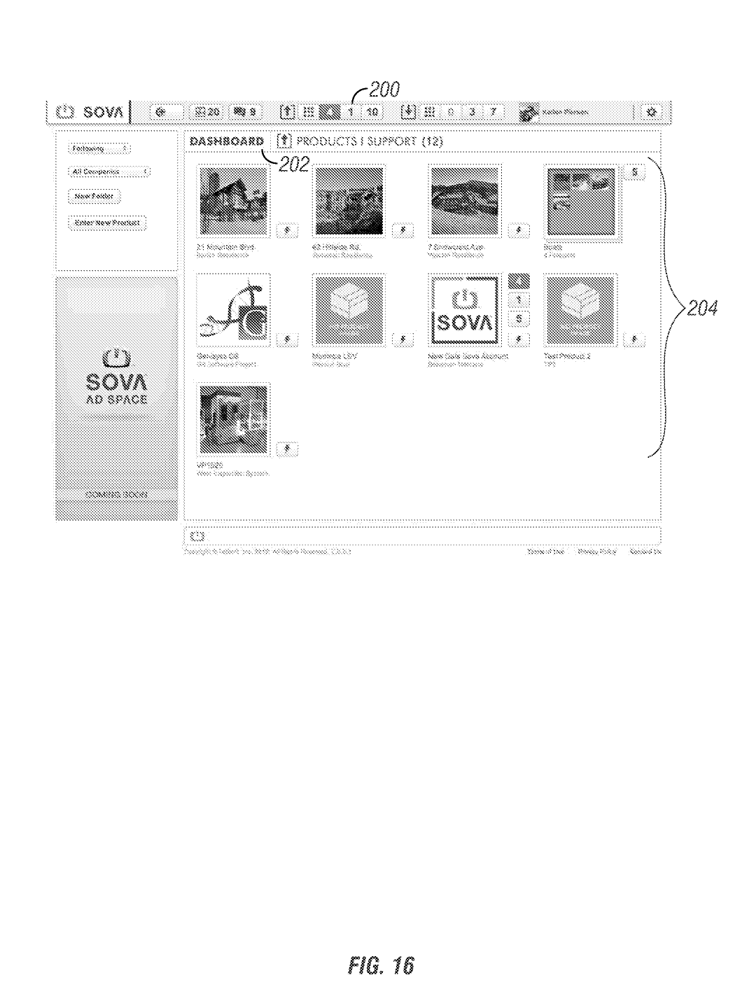

FIG. 16 illustrates a screen display of a dashboard allowing a user to select a product or a folder or group of products. As shown in FIG. 16, a screen display 200 is provided with a dashboard 202. A list of products 204 is also provided.

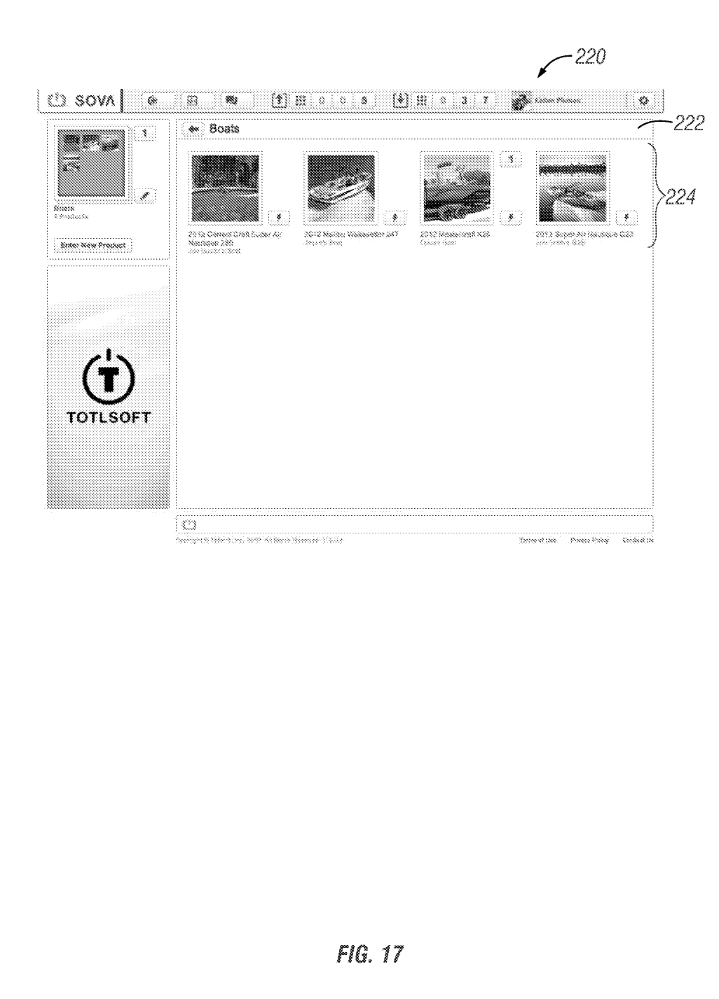

FIG. 17 illustrates a screen display showing products within a folder or group of products. As shown in FIG. 17, a screen display 220 is provided for a grouping of products 222. Within the product grouping is a list 224 of products.

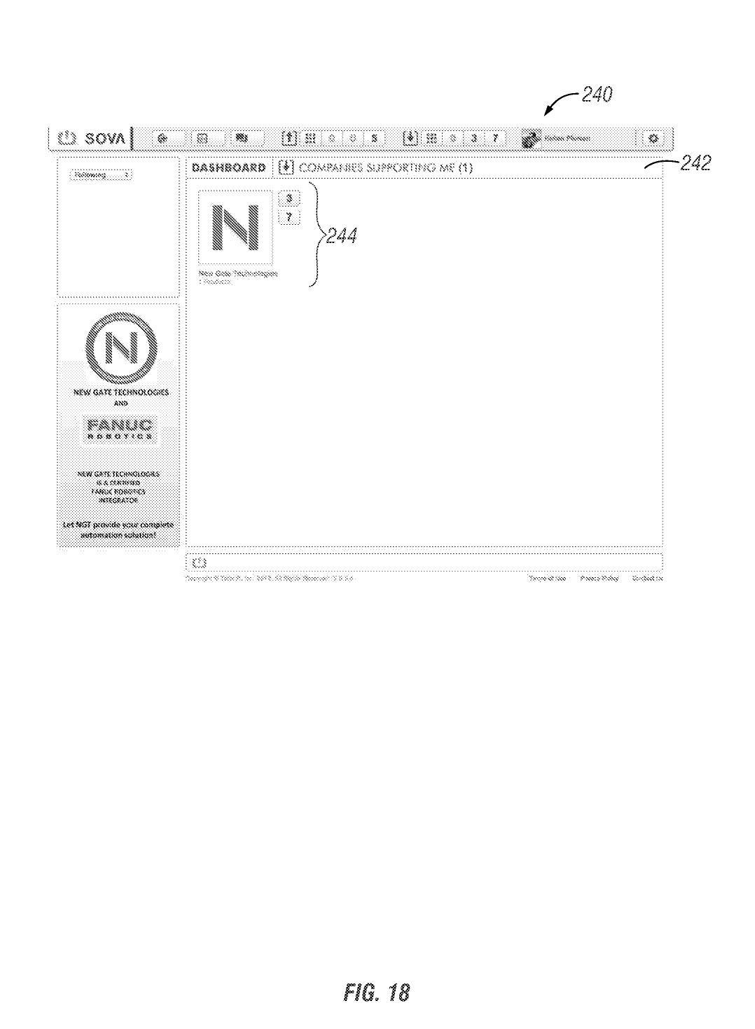

FIG. 18 illustrates a screen display showing companies supporting a user. As shown in FIG. 18, a screen display 240 identifies companies supporting a user 242 and provides a listing 244 of those companies.

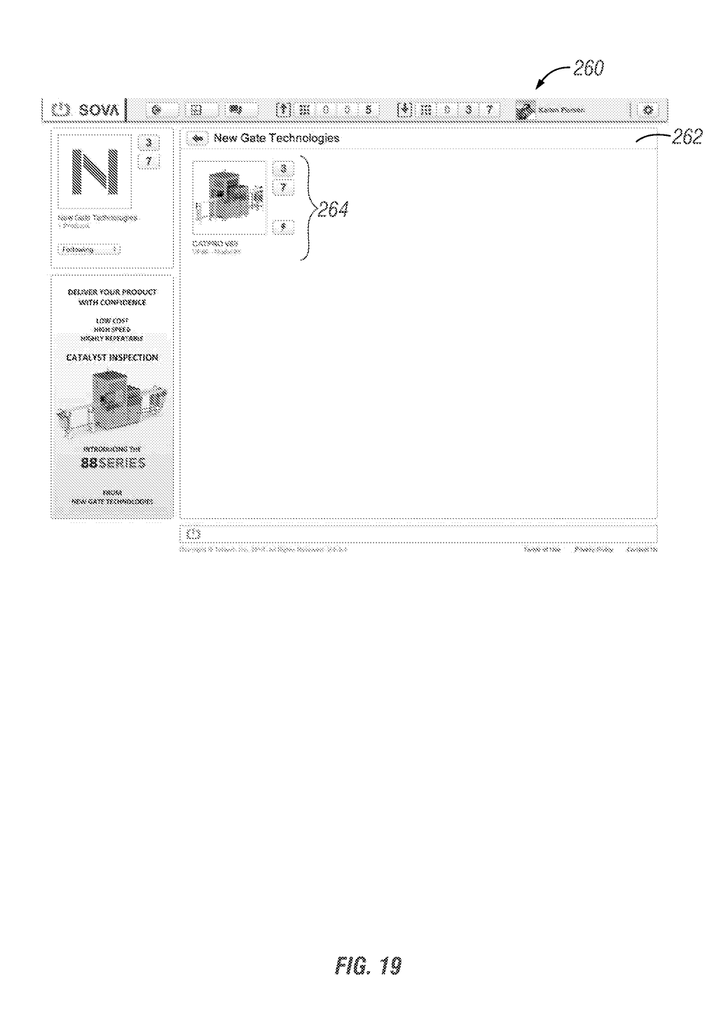

FIG. 19 illustrates a screen display showing a product of a company. As shown in FIG. 19, a screen display 260 includes a company name 262 and a listing 264 of products from that company.

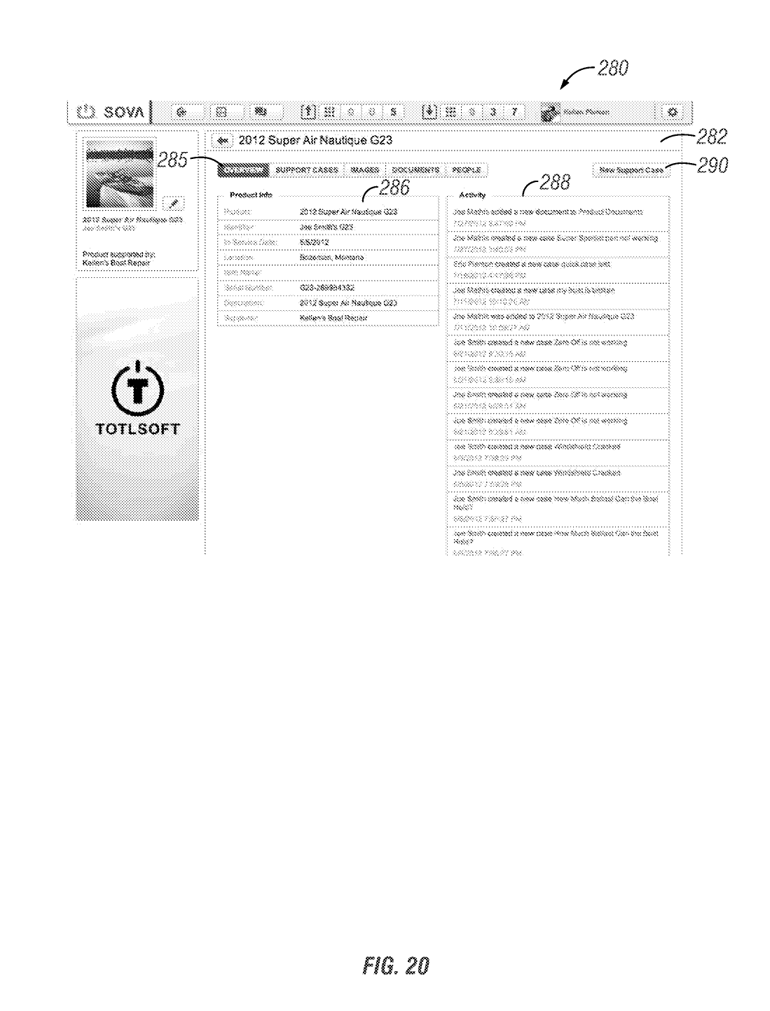

FIG. 20 illustrates a screen display providing an overview of a product. As shown in FIG. 20, a screen display 280 includes a product 282 and tabs 284 about the product including an overview tab 285. Information contained within the product overview may include product information 286 and activity information 288. Product information may include information such as product name, a product identifier, an in-service date, a location, an item name, a serial number, a description, or a supporter for the product. Activity information 288 may include information of various activities such as creating a new case, added documents, or other user activity. A new support case button 290 is also shown which may be used to create a new case.

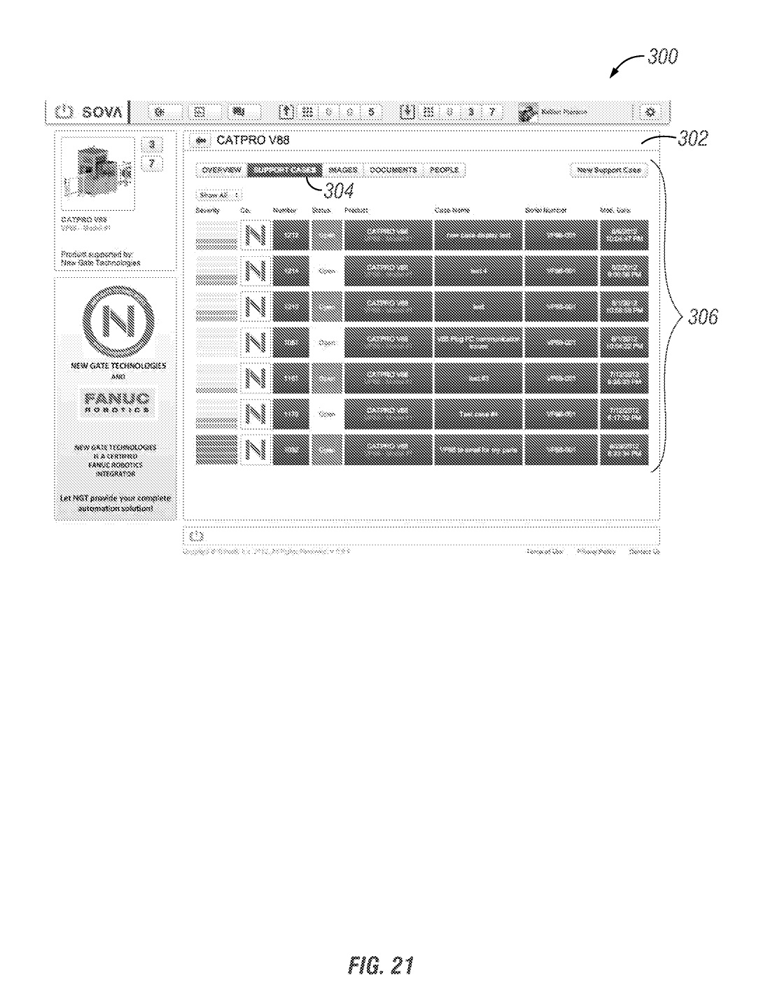

FIG. 21 illustrates a screen display showing support cases for a product. As shown in FIG. 21, a screen display 300 includes a product 302 and related tabs including a support cases tab 304. With the support cases tab 304 selected, a listing 306 of support cases is provided. The listing 306 may include severity of the case, the company, the case number assigned, the status of the case, the product, the case name, the serial number for the product, and the date of last modification to the support case.

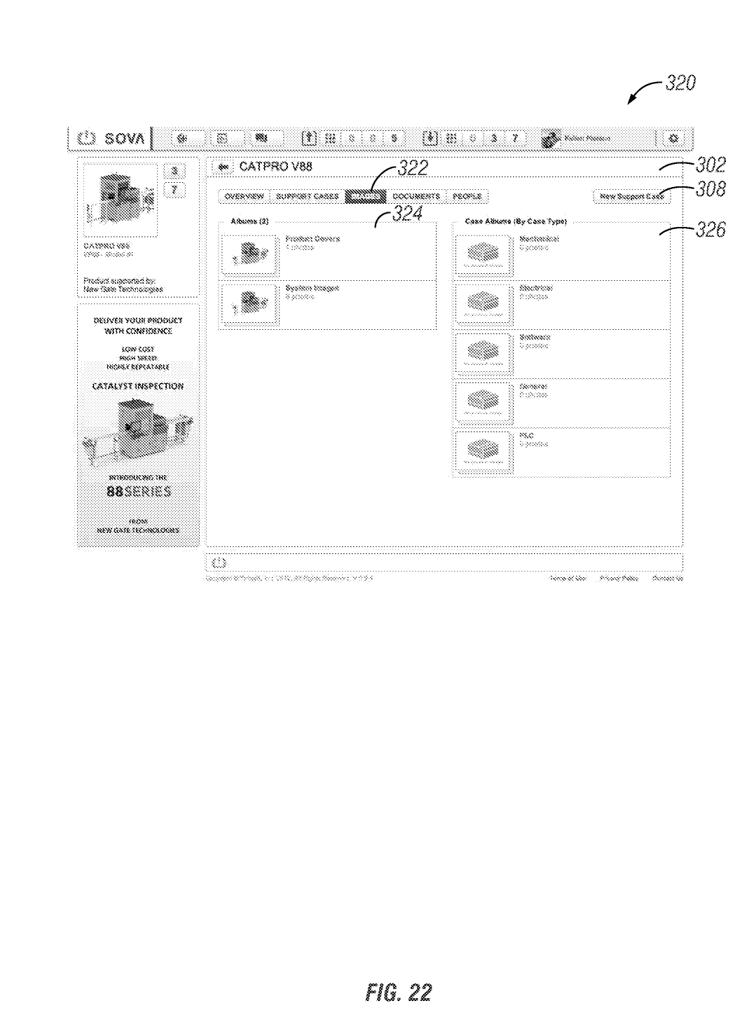

FIG. 22 illustrates images available for a product. As shown in FIG. 22, a screen display 320 provides information for a product 302 and tabs about the product including an images tab 322. The images may be organized into albums 324 for the product. In addition, case albums 326 are provided. Thus all images associated with a product can be accessed whether they are associated with a product or a support case involving the product. In addition, a button 328 is provided for generating a new support case.

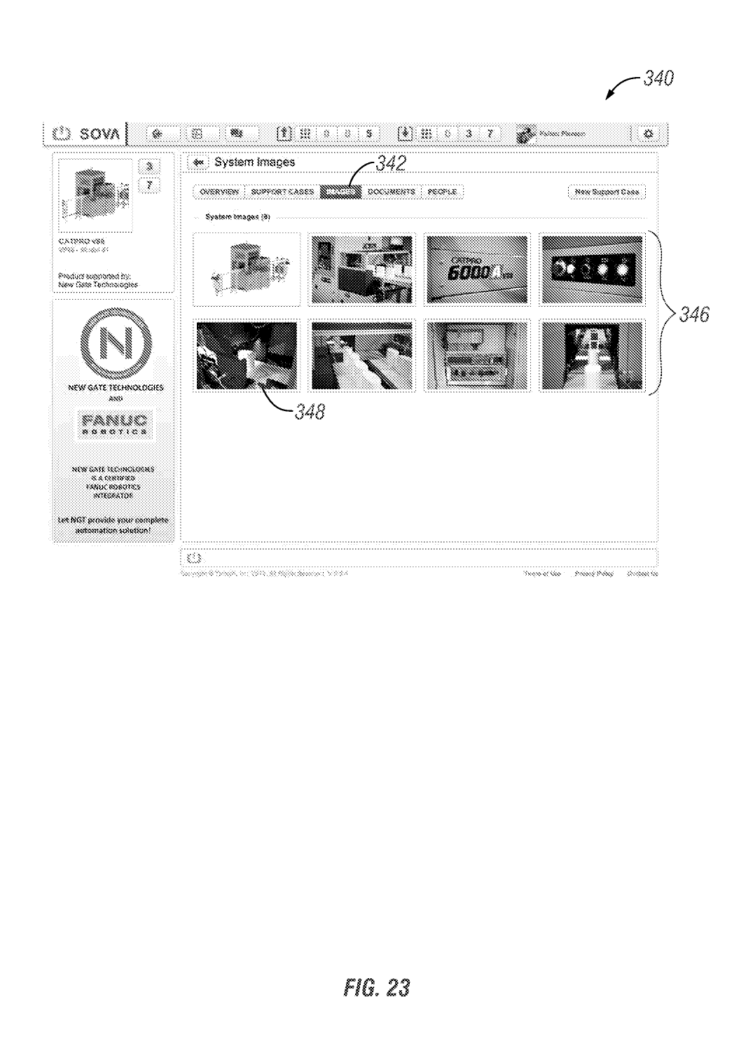

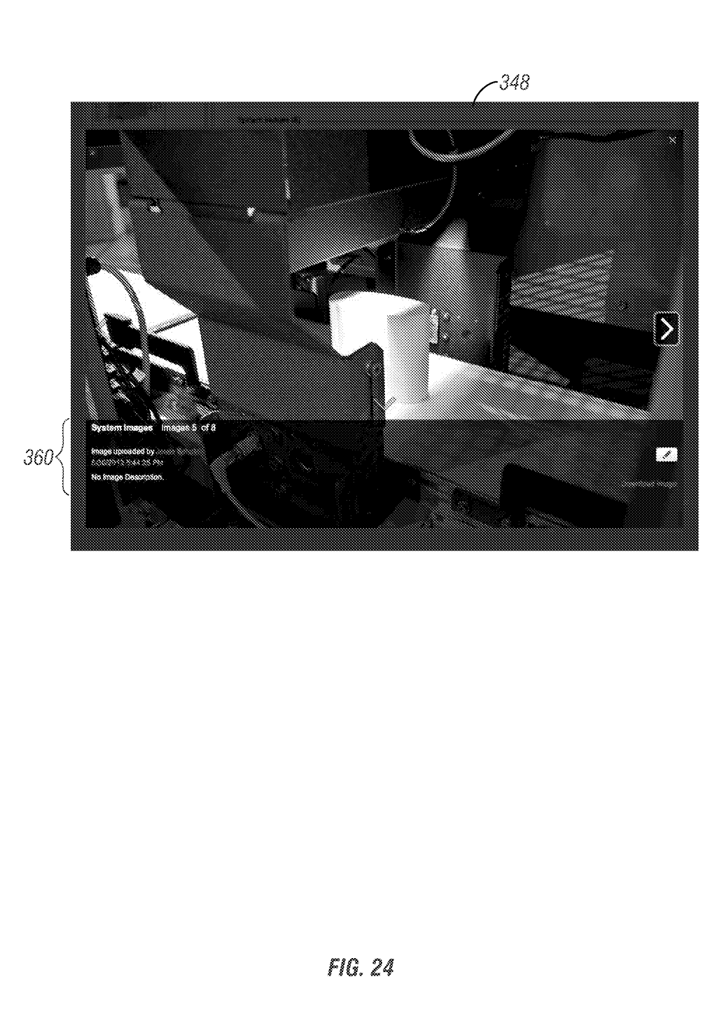

FIG. 23 illustrates system images available for a product. As shown in FIG. 23, a screen display 340 includes an images tab 342 and a collection of images 346. One of the system images 348 within the collection may be selected. FIG. 24 illustrates the system image 348 and associated image information which may include a user who uploaded the image, when the image was uploaded including date and type, and an image description.

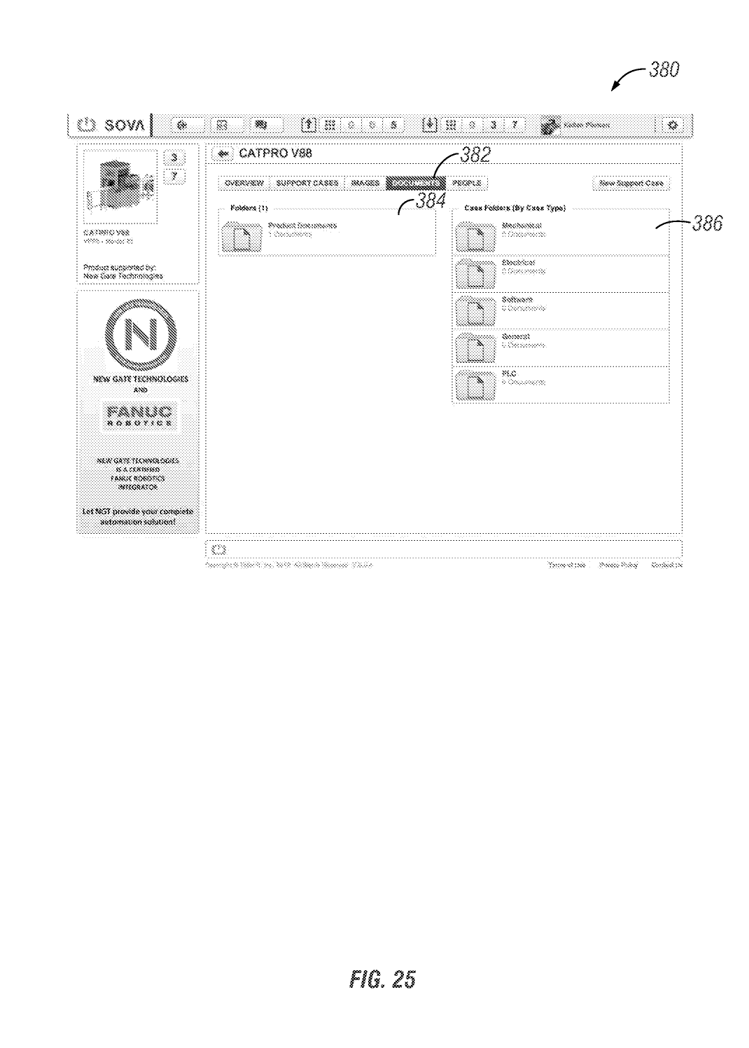

FIG. 25 illustrates folders containing documents available for a product including product documents and case folders. As shown in FIG. 24, there is a screen display 380 for a product which includes a documents tab 382. The documents may be organized into folders 384. In addition, documents associated with specific cases may be organized into case folders 386. Thus all images associated with a product can be accessed whether they are associated with a product or a support case involving the product.

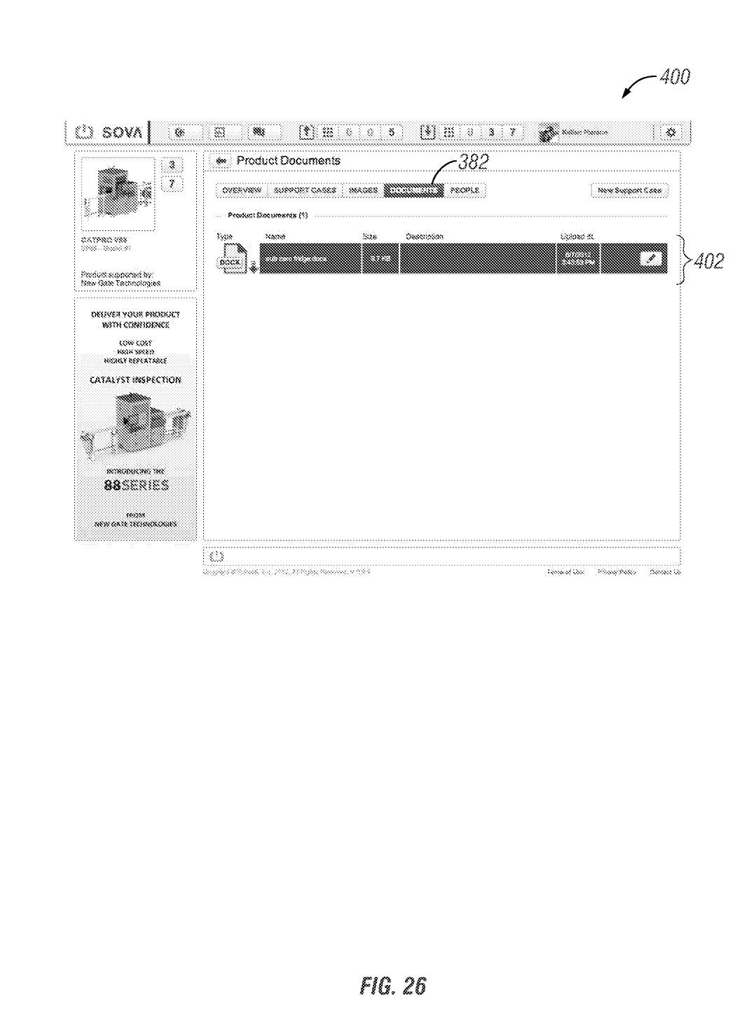

FIG. 26 illustrates a document available for a product. As shown in FIG. 26, there is a screen display 400 for product documents. There is a documents tab 382 and a listing 402 of product documents is shown.

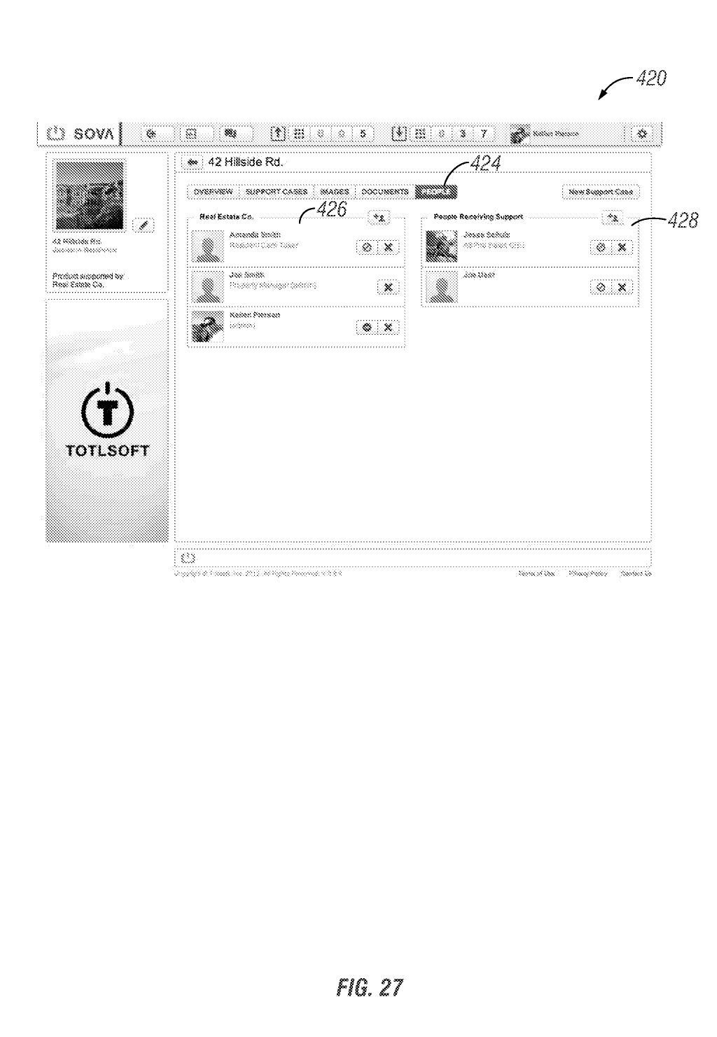

FIG. 27 illustrates a screen display shown people associated with a company which supports a product and people receiving support. As shown in FIG. 27, there is a screen display 420. There is a people tab 424. People for the organization providing support are shown in listing 426. People receiving support are shown in listing 428.

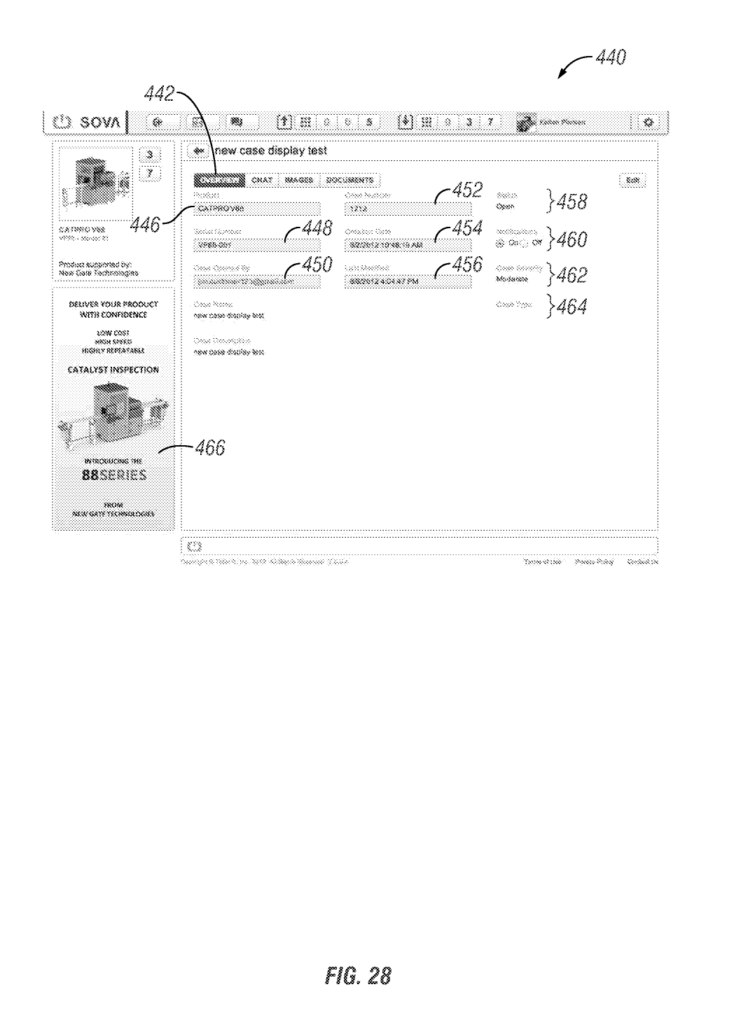

FIG. 28 illustrates an overview for a support case. As shown in FIG. 28, there is a screen display 440 for a new support case. There is an overview tab 442 provided. Various data fields are provided for collecting or displaying information associated with the support case. This can include the product name 446, the serial number 448 for the product, the individual opening the support case 450, the case number 452, the creation date and or time 454, the date of last modification 456, the status 458 of the case, the notification setting 460, the case severity 462, the case type, 464 as well as other information such as a case name and case description.

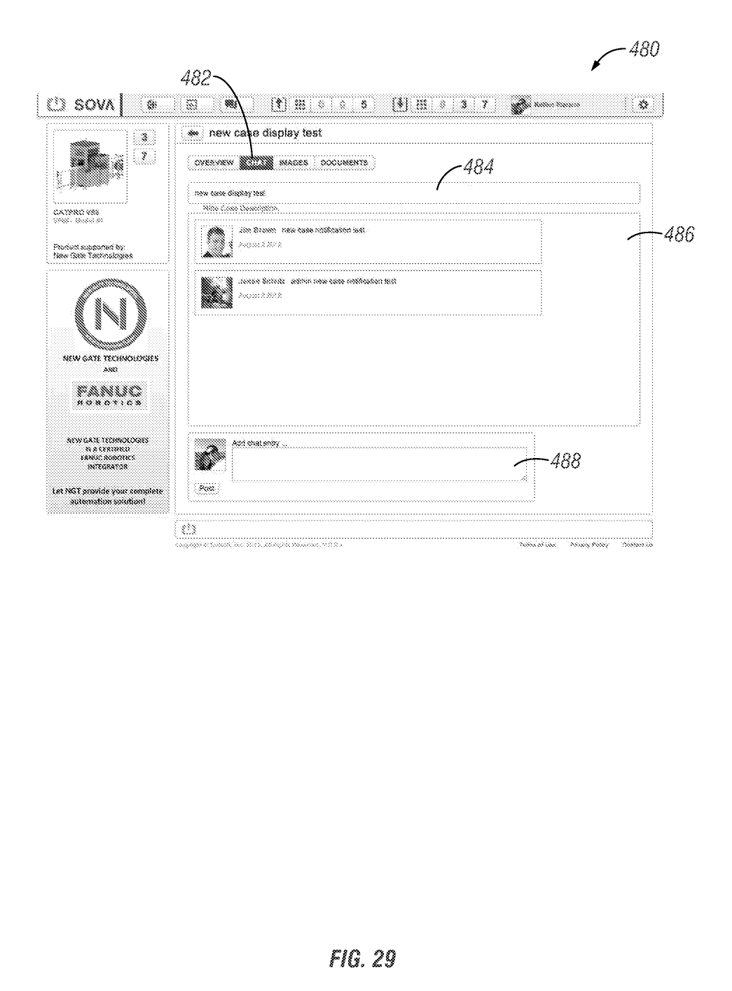

FIG. 29 illustrates a chat feature for a support case. As shown in FIG. 29, a screen display 480 includes a chat tab 482 for a support case. The description 484 for the support case may be shown as well as chat dialog 486. A new chat message 488 may be posted by the user.

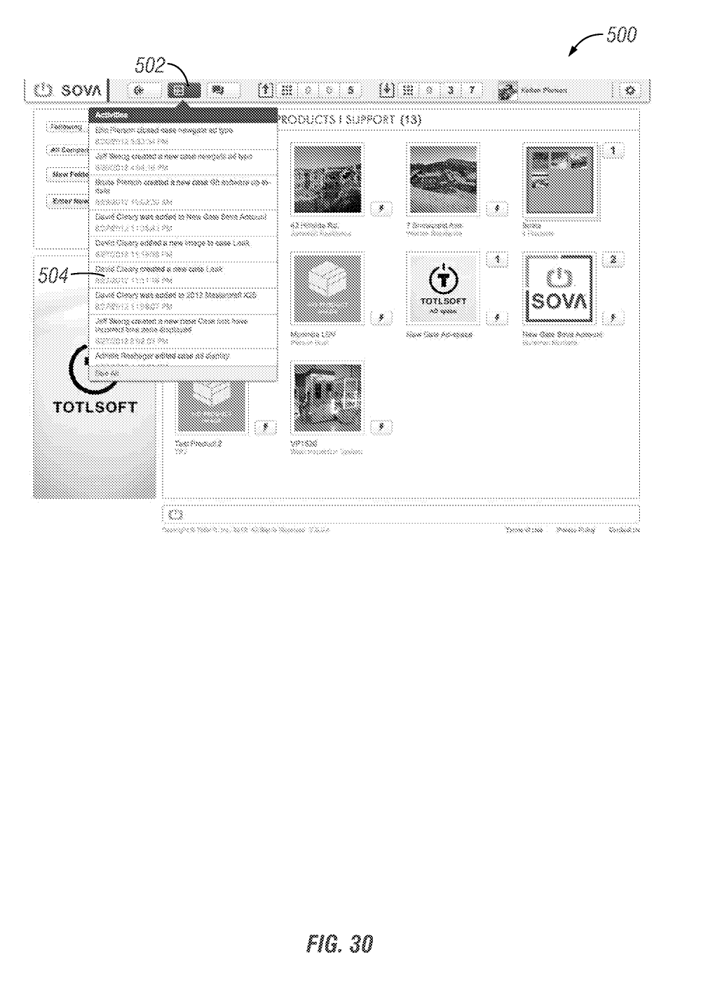

FIG. 30 illustrates activity information. As shown in FIG. 30, a screen display 500 is provided. A button 502 is provided at the top which may be selected to see activities or activities 504 may be seen by a mouse over the button 502.

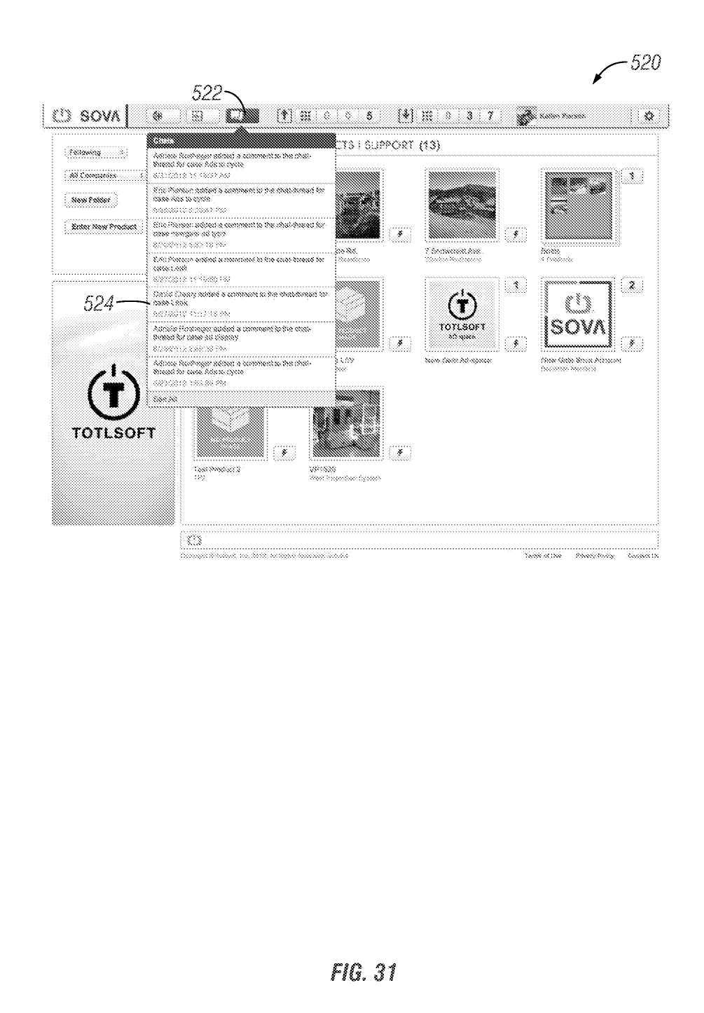

FIG. 31 illustrates chat information. As shown in FIG. 31, a screen display 520 is provided. A button 522 is provided at the top which may be selected to see chat entries or chat entries 525 may be seen by a mouse over the button 522.

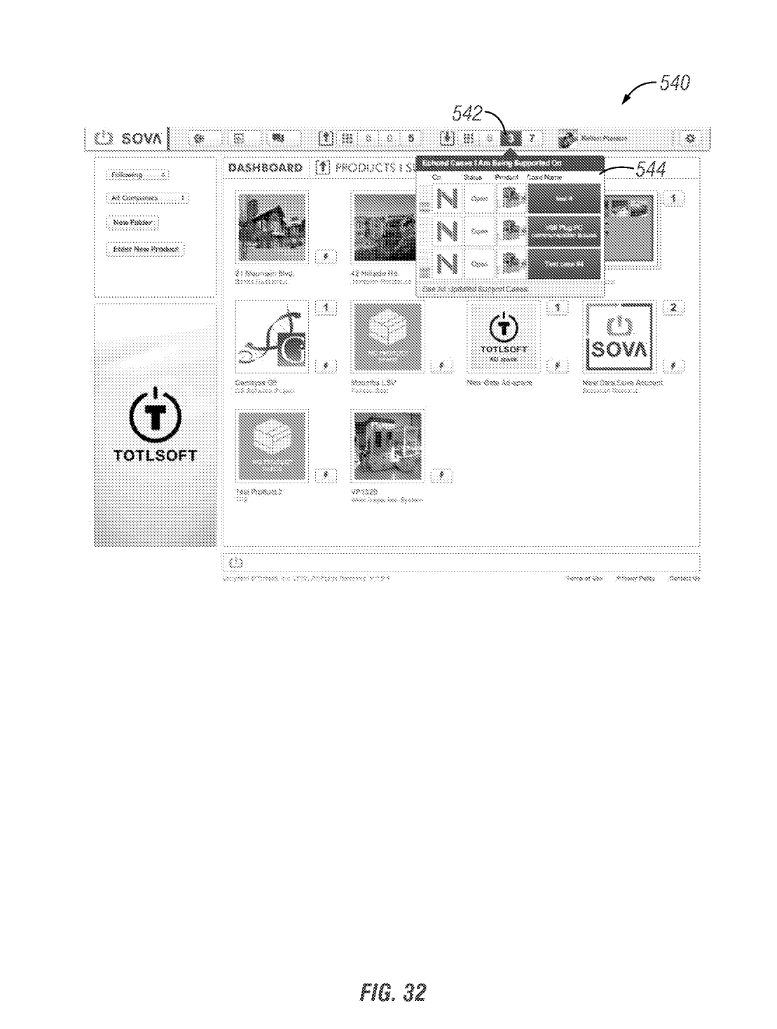

FIG. 32 illustrates echoed cases that a user is being supported on. As shown in FIG. 32, a screen display 540 is provided. A button 542 indicates the number of cases which a user is being supported on. The button 542 may be selected to see the cases or the cases 544 may be seen by a mouse over the button 542.

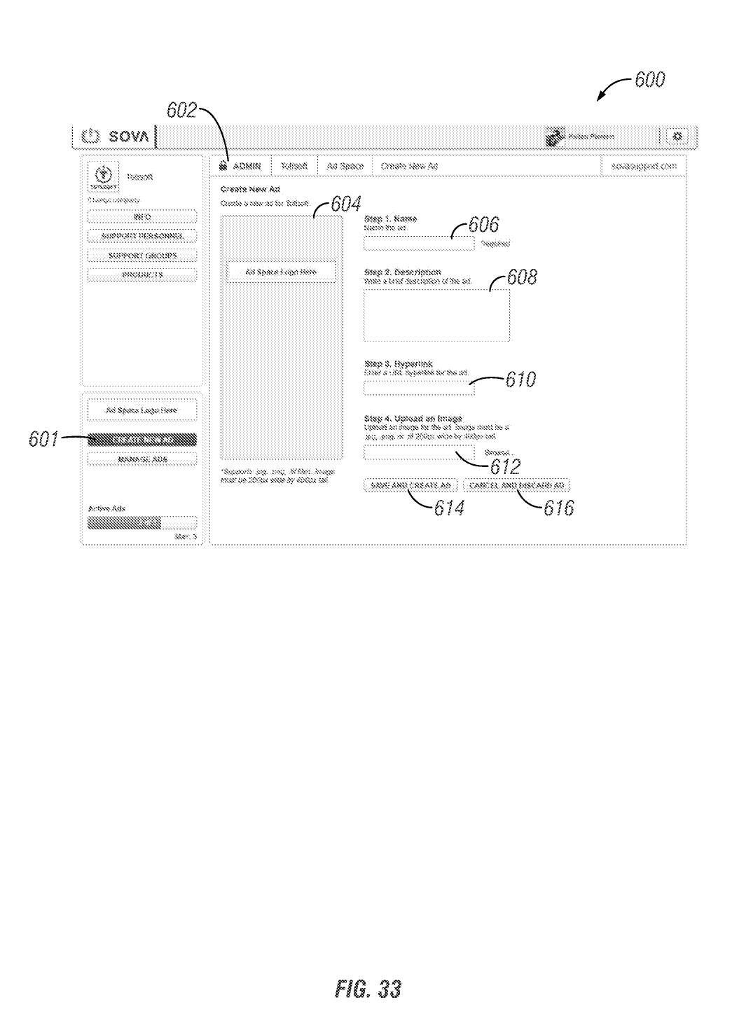

FIG. 33 illustrates a screen display for creating a new advertisement. As shown in FIG. 33, a screen display 600 is provided which is associated with administrator account as indicated by the administrator tab 602. This is associated with the create new ad button 601 on the left of the screen display. A logo may be placed in the space 604. Additional information for the advertisement may be specified by using corresponding fields. This may include a name 606, a description 608, a hyperlink, 610, and an image 612. A button 614 is shown for saving and creating the advertisement is provided as well as a button 616 for canceling and discarding the advertisement.

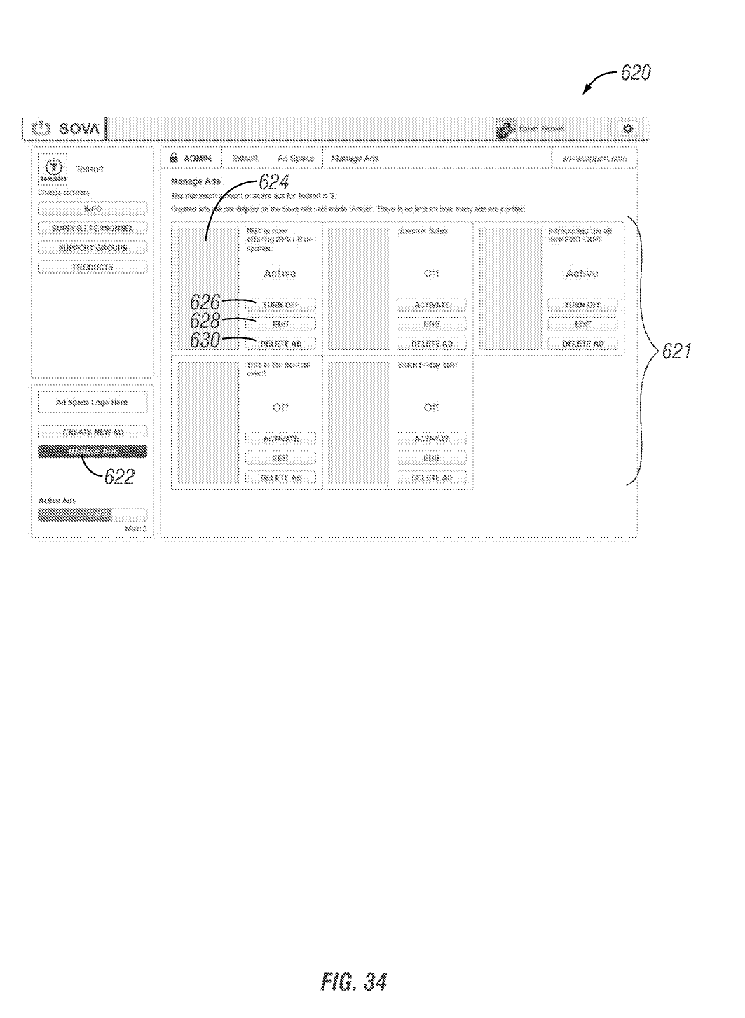

FIG. 34 illustrates a screen display for managing advertisements. A screen display 620 associated with selection of the manage ads button 622 is shown. A set of advertisements 621 is provided. For advertisement 624, the name and status of the advertisement is shown. Buttons include a turn off button 626 which may be used, an edit button 628 is shown, and a delete ad 630 button is shown. For ads which are already off, an activate button may replace the turn off button 626.

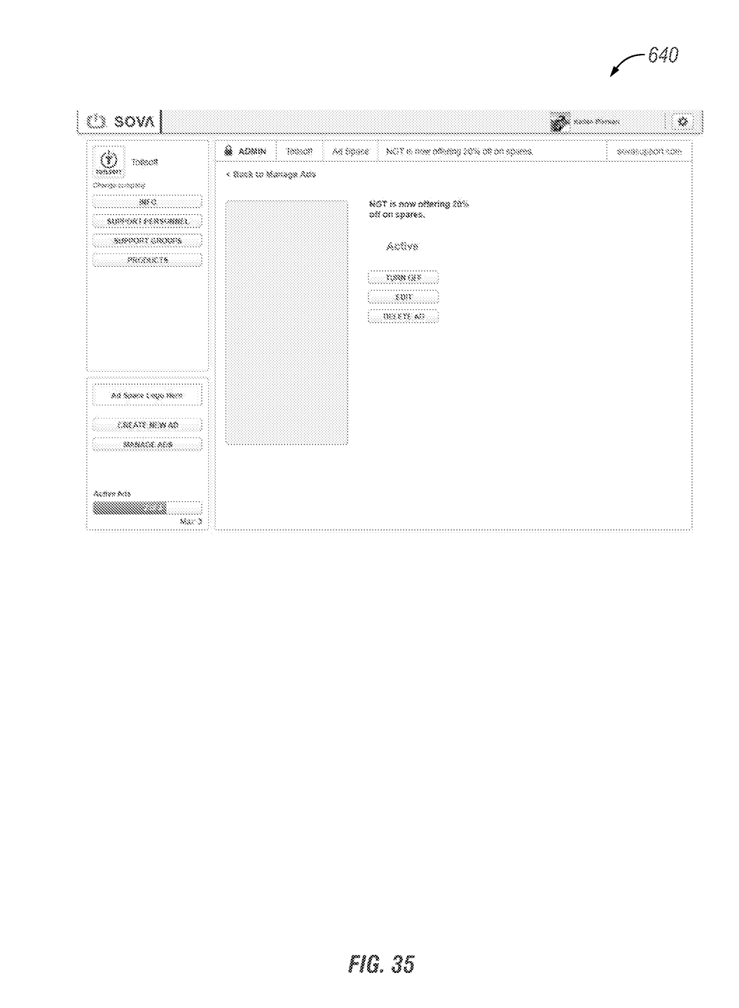

FIG. 35 illustrates a screen display 640 for managing advertisements.

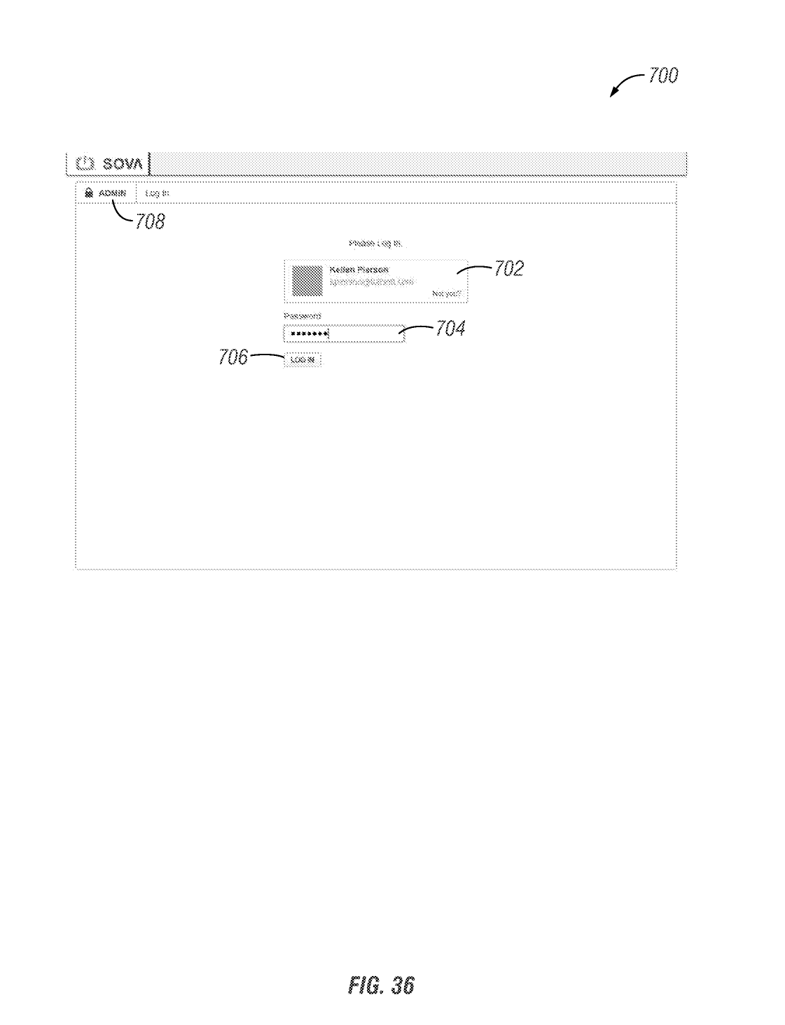

FIG. 36 illustrates a screen display 700 for an administrator to log in. The admin 708 near the top left indicates that the user has administrator privileges for a company. A user name 702, password 704, and log in button 706 are provided.

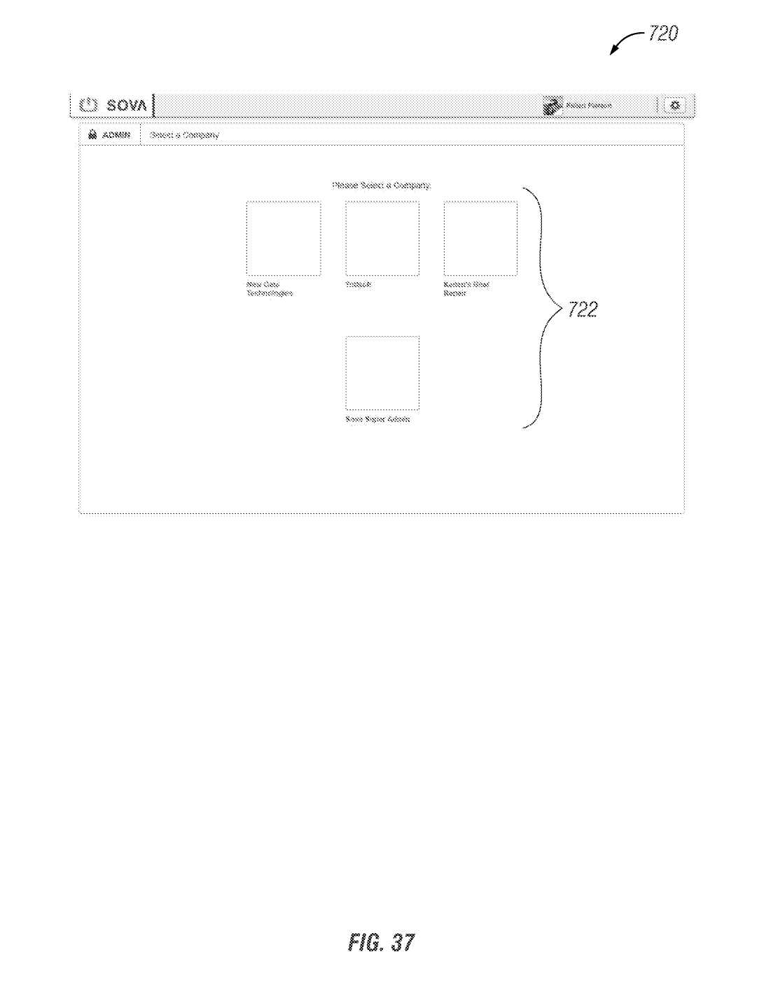

FIG. 37 illustrates a screen display or selecting a company. The screen display 720 includes a listing 722 of available companies to select from.

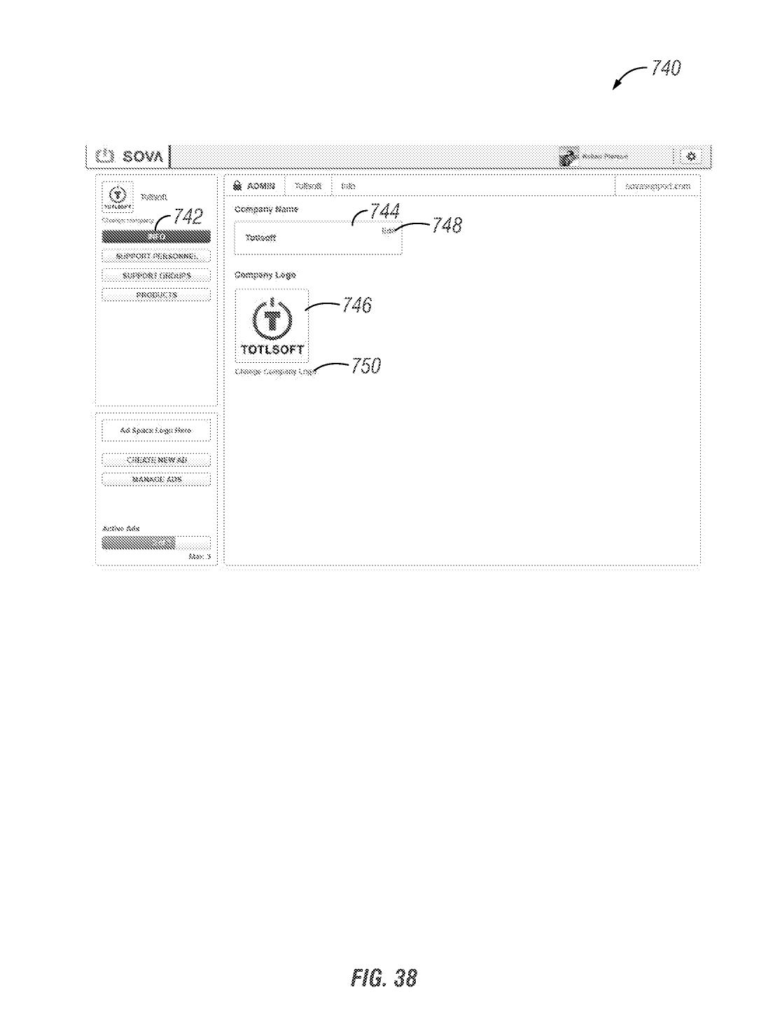

FIG. 38 illustrates a screen display 740 for editing company information including the name of the company and a logo of the company. Note that the info button 742 is highlighted. A company name 744 is shown which may be edited by selecting the edit function 748. A company logo 746 may be shown which may be edited by selecting the change company logo function 750.

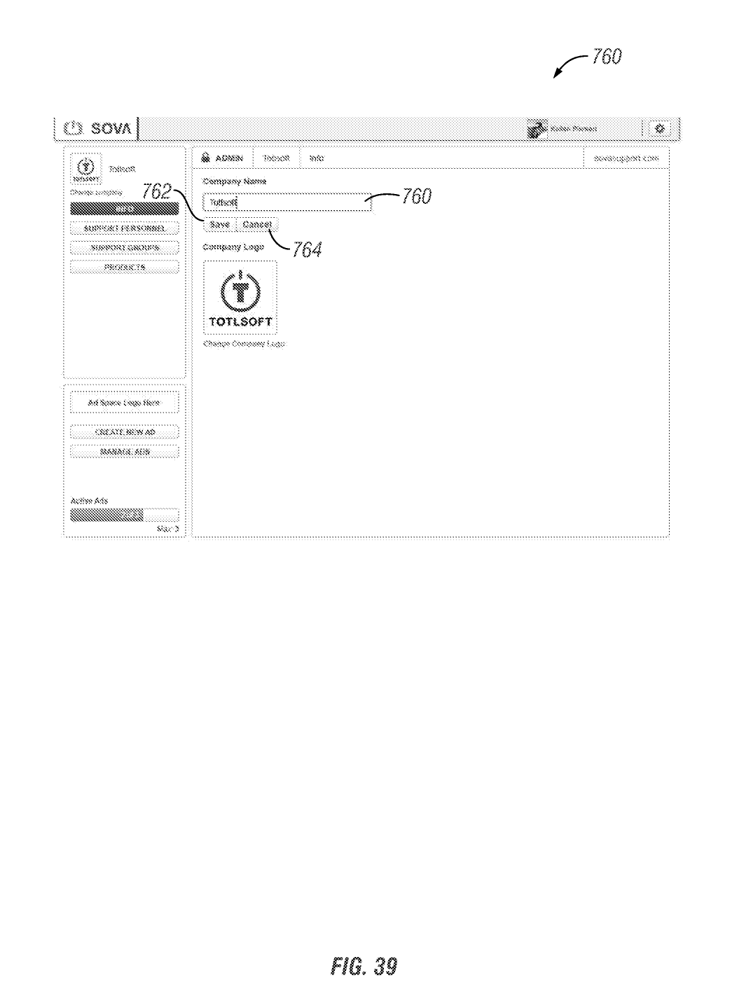

FIG. 39 illustrates editing a company name. The screen display 760 includes a field 761 for a company name, a save button 762, and a cancel button 764.

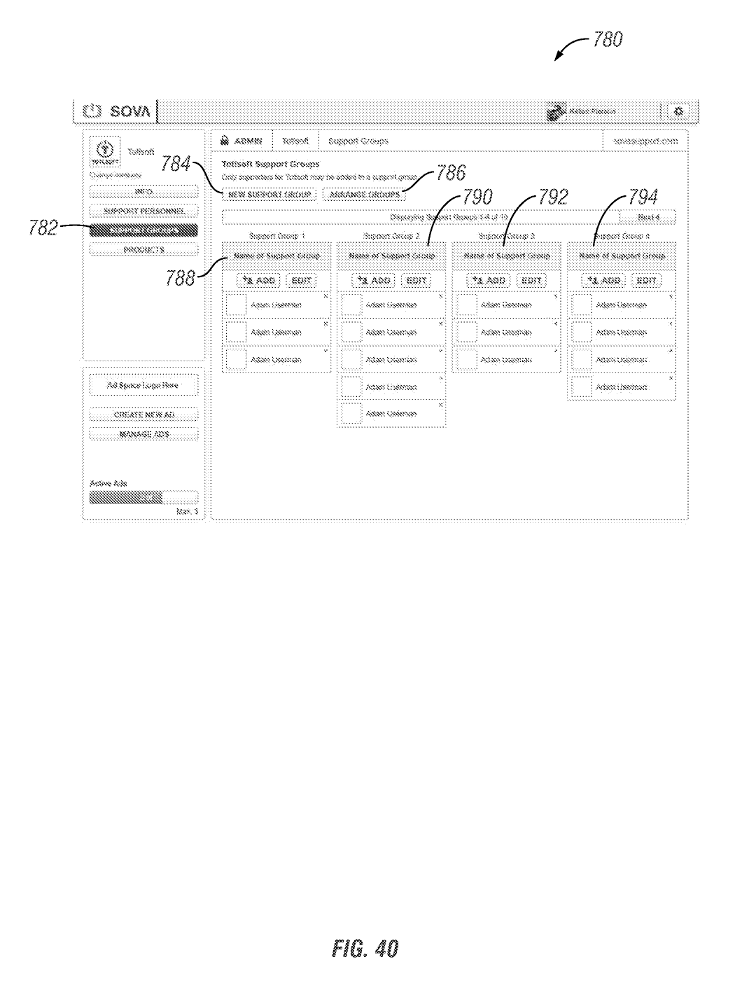

FIG. 40 illustrates a screen display 780 for managing support groups. Note that the support groups button 782 is highlighted on the left of the screen display 780. A button 784 is provided for adding a new support group and a button 786 is provided for arranging the support groups. Various support groups 788, 790, 792, and 794 are shown which allow users to be added or which may be otherwise edited.

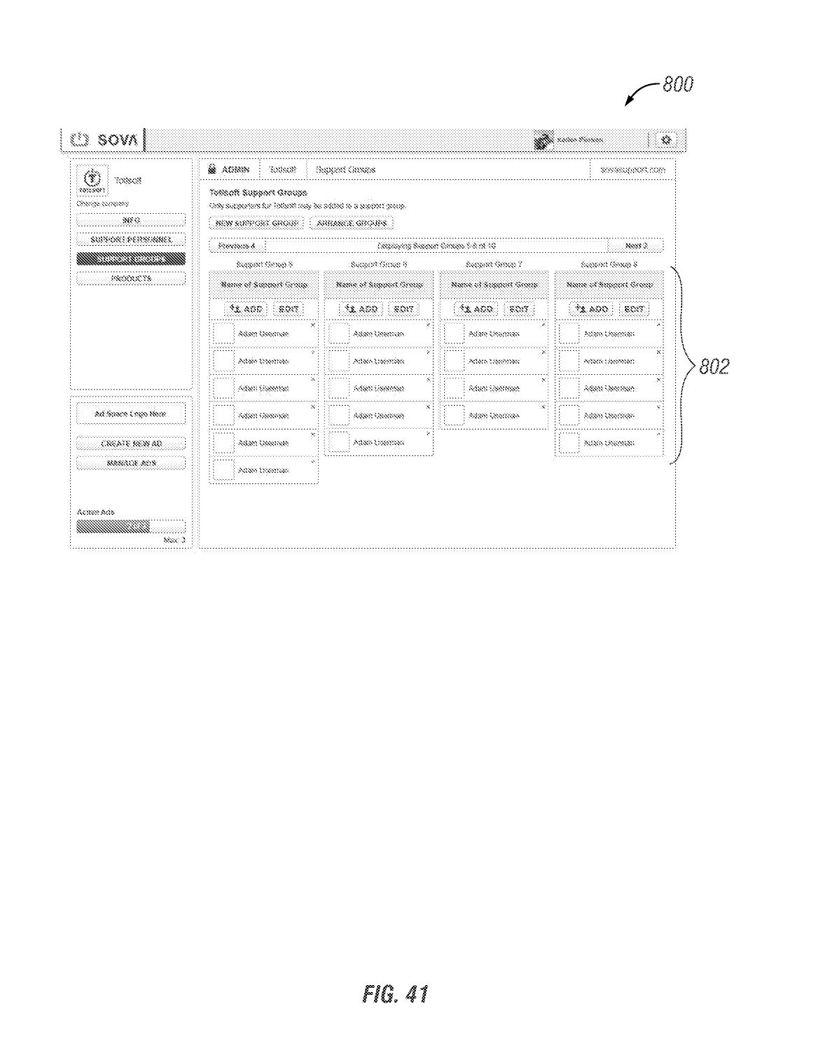

FIG. 41 illustrates another screen display 800 for managing support groups. A further listing 802 of support groups are provided.

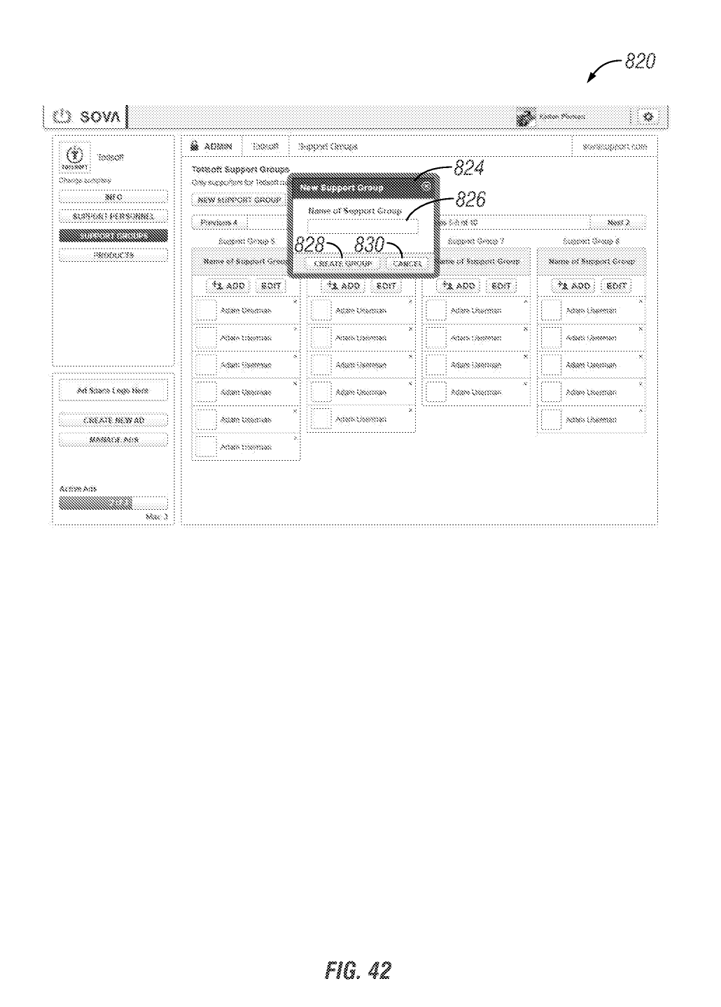

FIG. 42 illustrates creating a new support group. As shown in FIG. 42, the screen display 820 includes a pop-up window 824 while allows a name of support group 826 to be entered. A create group button 828 may be selected to then create the group or the operation may be cancelled by selecting the cancel button 830.

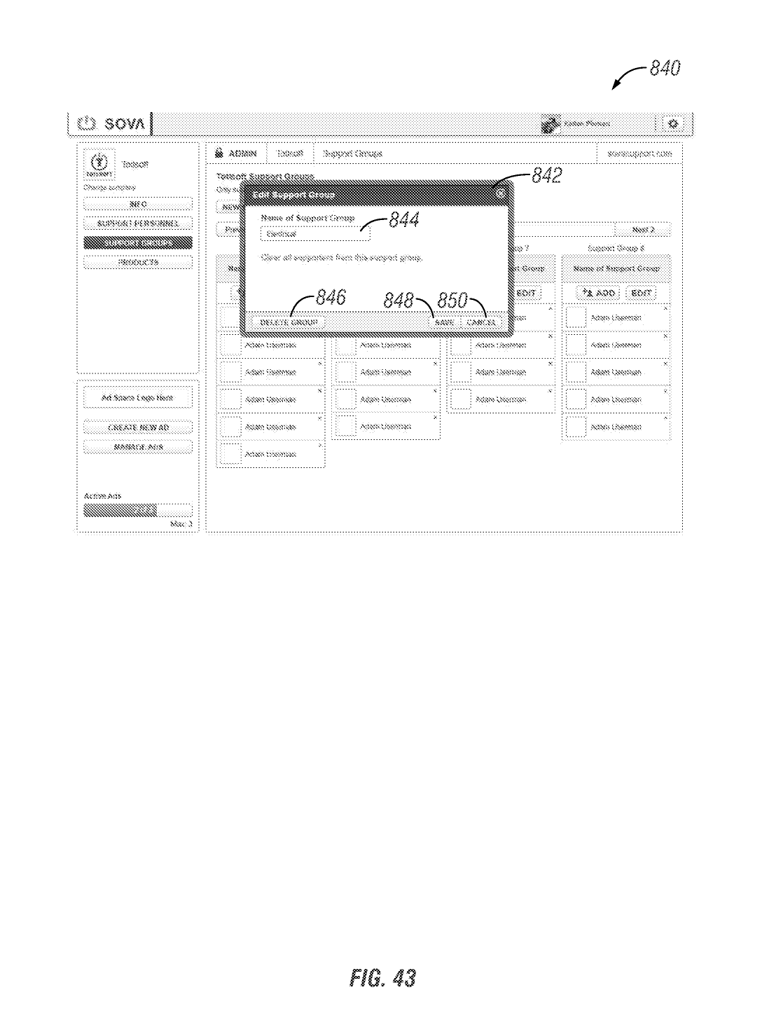

FIG. 43 illustrates editing an existing support group. As shown in FIG. 43, a screen display 840 is provided. A window 842 is provided for editing a support group such as by changing a name 844 of the support group. The group may also be deleted by using the delete group button 846. Once a group has been edited, a user may select the save button 848 or the cancel button 850.

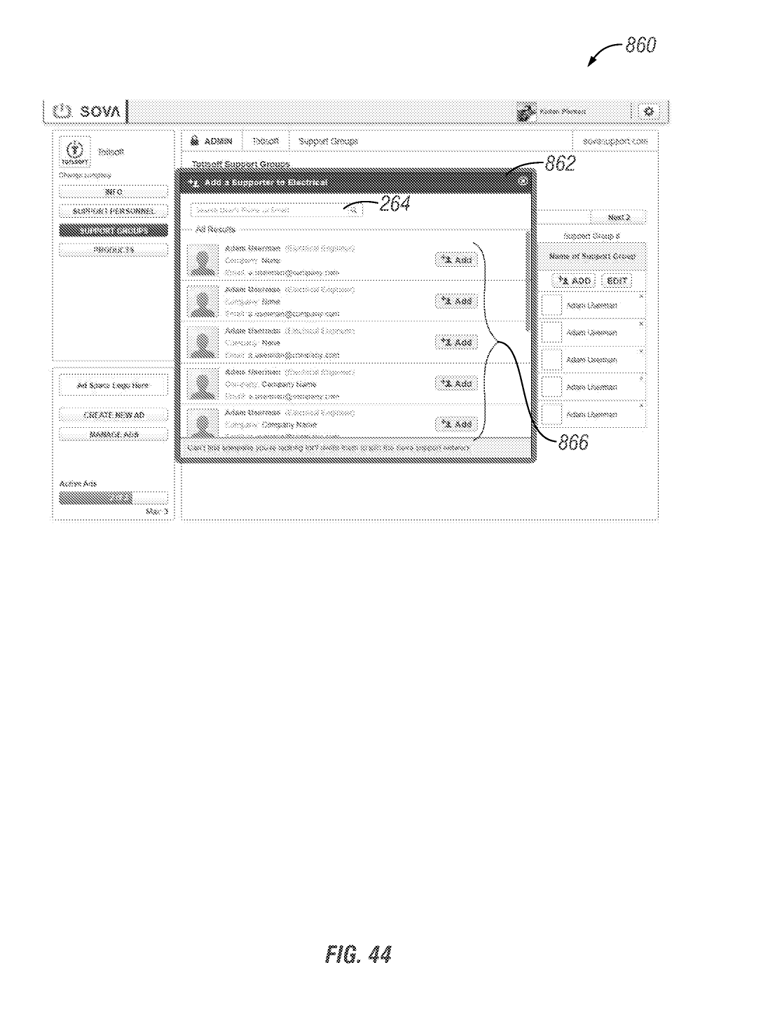

FIG. 44 illustrates adding a supporter to a support group. A shown in FIG. 44, a screen display 860 for adding a supporter to a support network is provided. A window 862 us provided which includes a search tool 864 which may be used to find a user by name or email address. A listing 866 of users is provided.

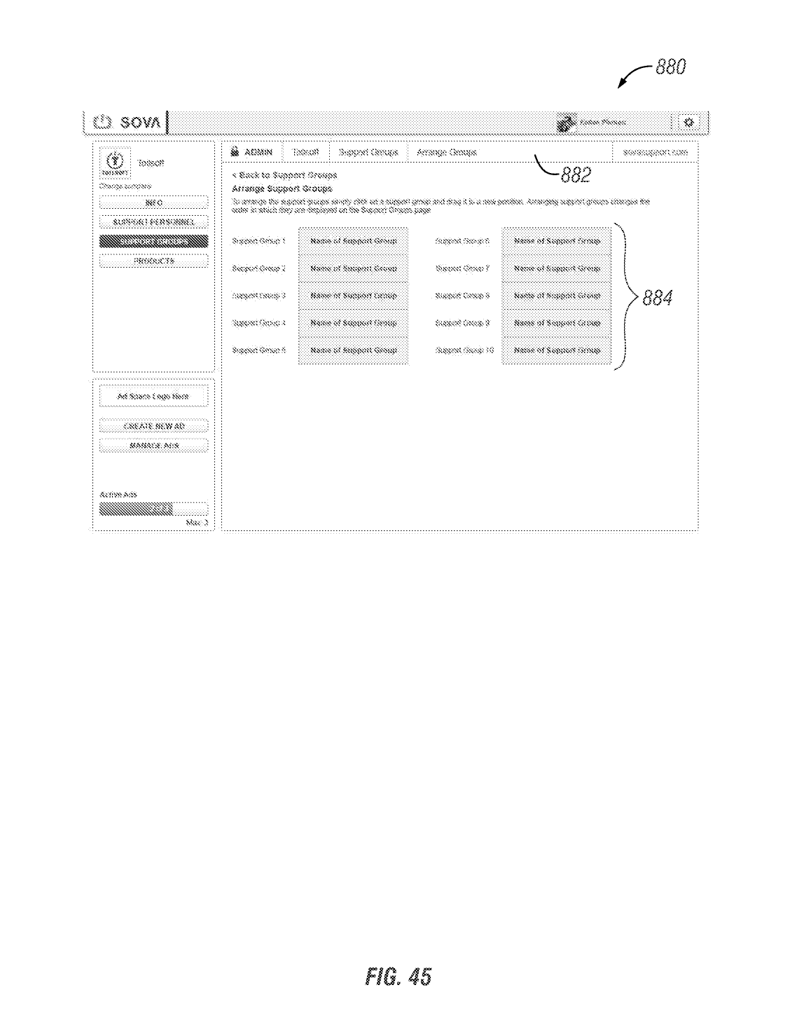

FIG. 45 illustrates a screen display for arranging support groups. As shown in FIG. 45, a screen display 880 is present. As indicated near the top of the screen display is used to arrange groups 882. A listing 884 of support groups is provided. Arranging support groups changes the order in which they are displayed on the support groups page.

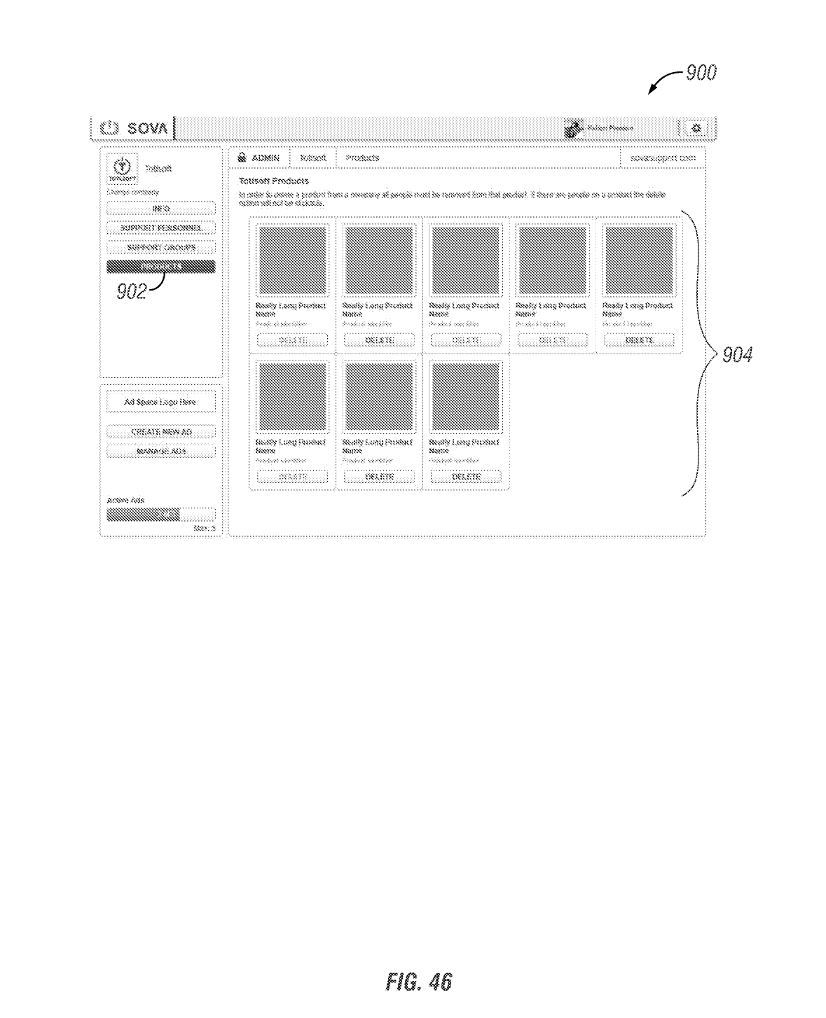

FIG. 46 is a screen display illustrating products for a company. As shown in FIG. 46, a screen display 900 is present which provides information about products. To the left, a products button 902 is selected. A listing 904 of products for a company is shown. These products may be deleted if no people are associated with the product.

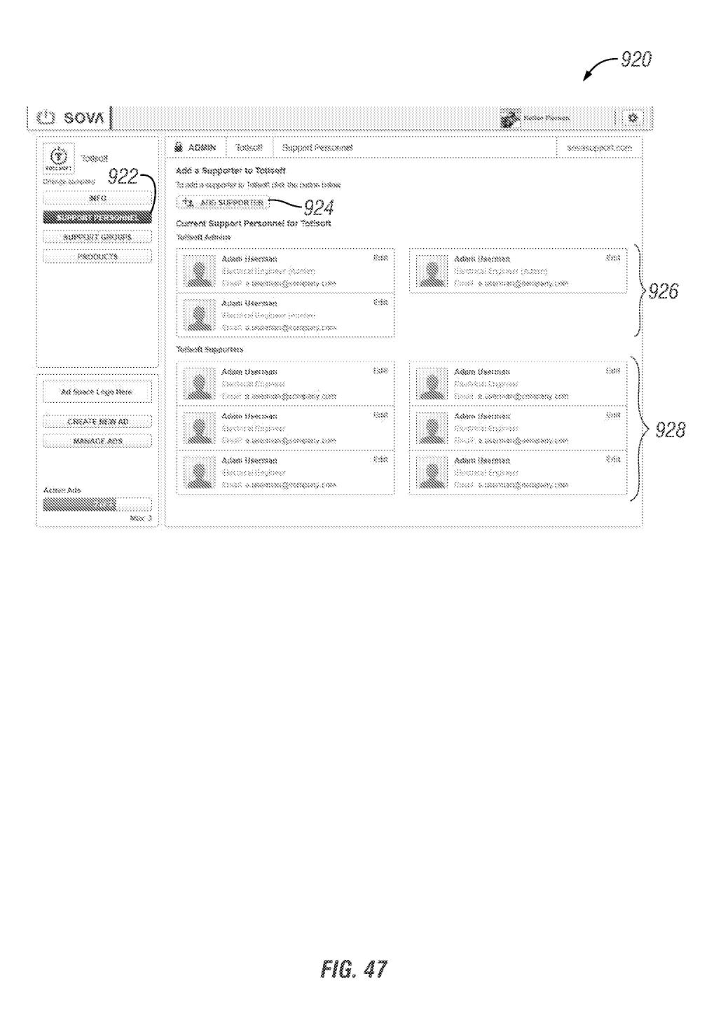

FIG. 47 is a screen display illustrating support personnel for a company. As shown in FIG. 47, a screen display 920 is present which provides information about support personnel. To the left, a support personnel button 922 is shown. An administrator may add a supporter to a company by selecting the add supporter button 924. A listing 926 of current administrators for the company is shown as well as a listing 928 for supporters for the company.

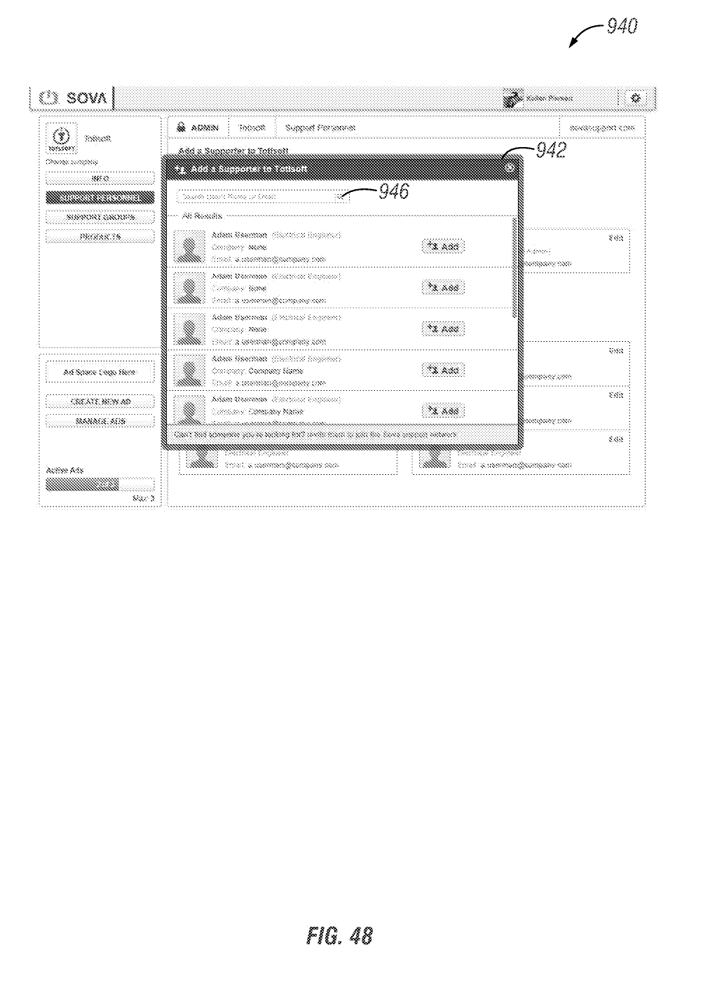

FIG. 48 is a screen display illustrating adding a supporter to a company. As shown in FIG. 48, a screen display 940 is present and a dialog box or window 942 may be used to add a supporter to a company. A search box 946 may be provided to allow a user to be searched for based on their name or email address.

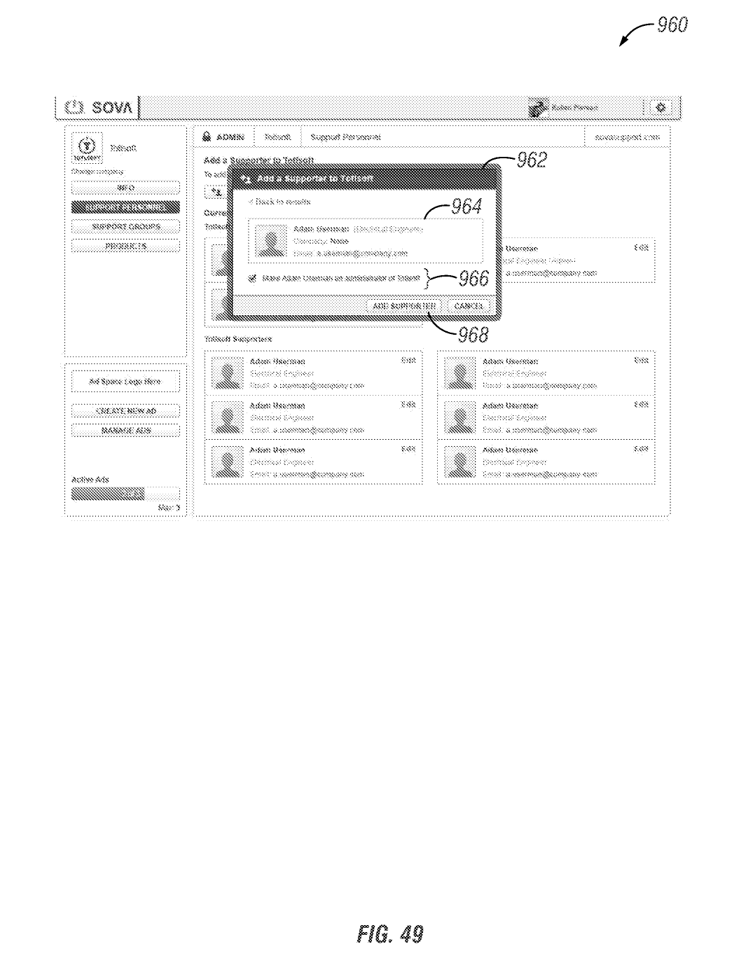

FIG. 49 is a screen display further illustrating adding a supporter to a company. As shown in FIG. 49, a screen display 960 is present and a dialog box or window 962 is present for adding a supporter to a company. Information about the supporter 974 may be collected. Such information may include their name, company, email address or other information. There is also a checkbox 988 which may be selected to make the supporter an administrator for the company. Once complete, the add supporter button 968 may be selected to add the supporter.

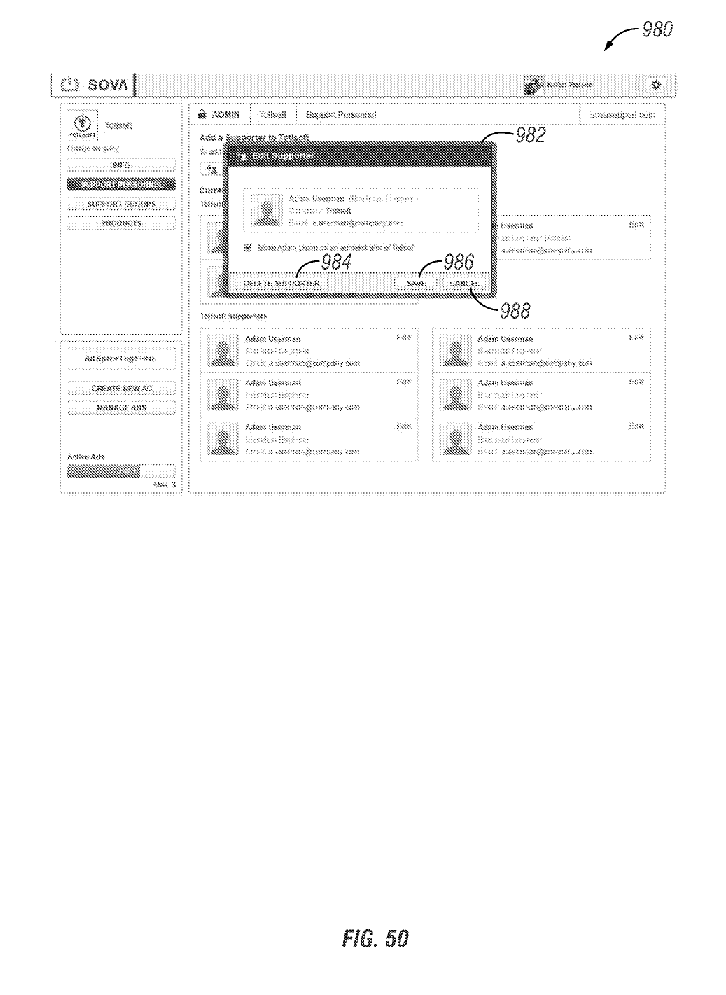

FIG. 50 is a screen display for editing a supporter. As shown in FIG. 50, a screen display 980 is present and a dialog box or window 982 is present for editing a support. The dialog box 982 provides information about a supporter such as their name, position, company, and email address and whether they are an administrator or not. A user may select a corresponding button to delete the supporter 984, save the supporter information 986, or cancel the operation 988.

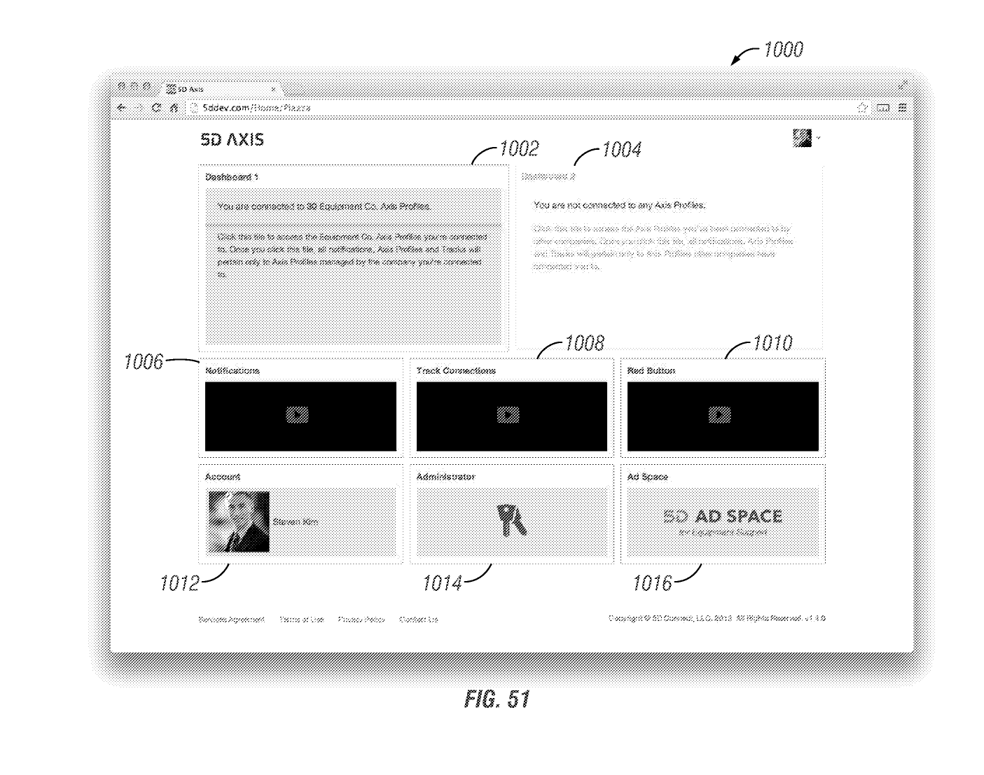

FIG. 51 through FIG. 75 illustrate additional embodiments of the invention.

FIG. 51 illustrates a screen display 1000 with a first dashboard 1002 and a second dashboard 1004. As shown, the first dashboard 1002 is used to access profiles associated with a particular company and the second dashboard 1004 is used to access profiles associated with other companies. Also on the screen display 1000 are screen areas associated with different functionalities of the user interface. These include notifications 1006, track connections 1008, red button 1010, account 1012, administrator 1014, and ad space 1016.

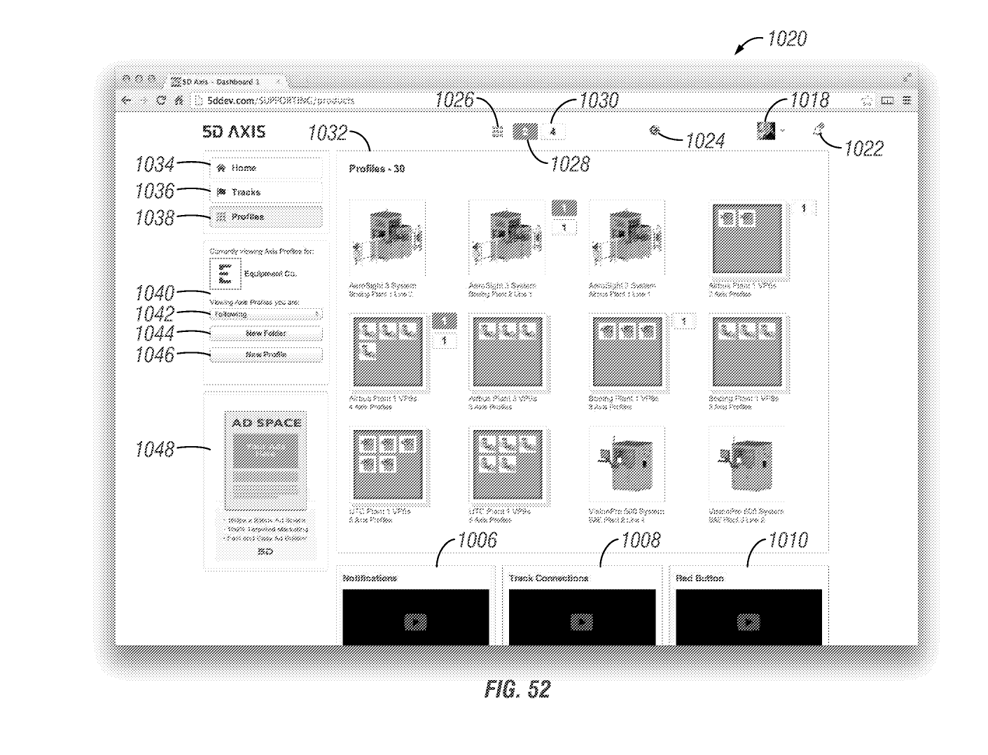

FIG. 52 illustrates a screen display 1020. A user 1018 is shown. A notification icon 1022 is shown which may be in the form of a bell. A red dot may be used with the bell in order to alert a user that there are new notifications. A plus icon 1024 is shown to add to the profiles. The profiles icon 1026 is shown along with an indicator of new tracks 1028 and open tracks 1030. The new tracks 1028 can also indicate that tracks are unattended.

Along the left column, a home button 1034 is shown, along with a tracks button 1036, a profiles button 1038, a company 1030 associated with the current profiles, a list box 1043 indicating that the profiles being viewed are those which the user is following, a new folder button 1044, a new profile button 1046, and an ad space area 1048. Note that the screen display 1020 is the home.

The screen display 1020 further includes the profiles 1032 for different products. For each product if there are new or open tracks associated with the product, this may be conveyed through the user interface such as by including boxes of different colors to the right of the product.

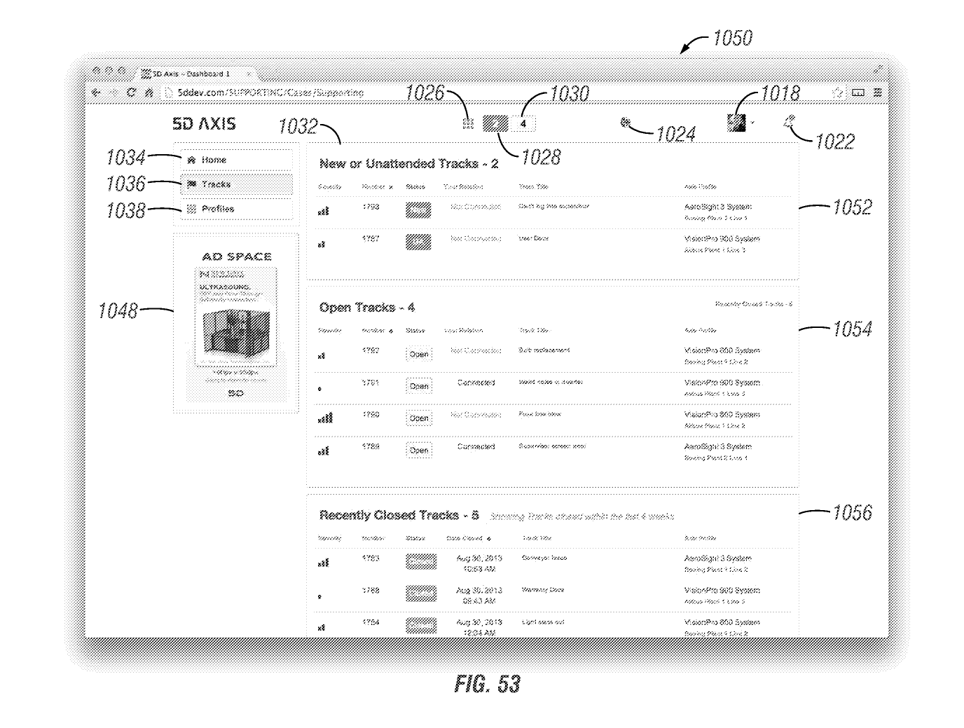

FIG. 53 illustrates a screen display 1050 showing tracks. Track information 1032 is displayed. This can include new or unattended tracks 1052, open tracks, 1054, and recently closed tracks 1056. Information about tracks can include the severity of the track, an identification number associated with the track, the status of the track (e.g. New, Unattended, Open, Closed, etc.), the relationship between the user and the track (e.g. Connected or Unconnected), the track title, and the profile associated with the track., and the date and time the track was closed.

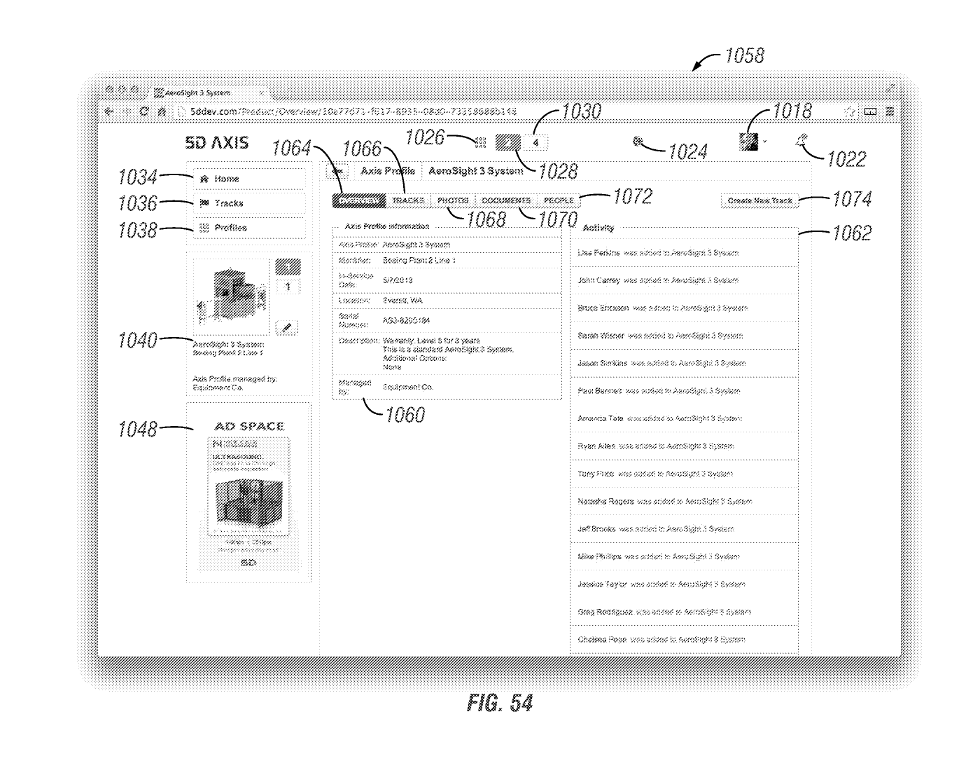

FIG. 54 illustrates a screen display 1058 which illustrates a profile for a particular product. An overview 1064 for the product is shown. Other tabs are present which may be selected to view tracks 1066, photos 1068, documents 1070, or people 1072 associated with this product. A user can also select the create new track button 1074 to create a new track. Profile information 1060 is shown which can include the name of the profile, an identifier, an in-service date, a location, a serial number, a description, and who is managing. Activity 1062 for the product is also shown.

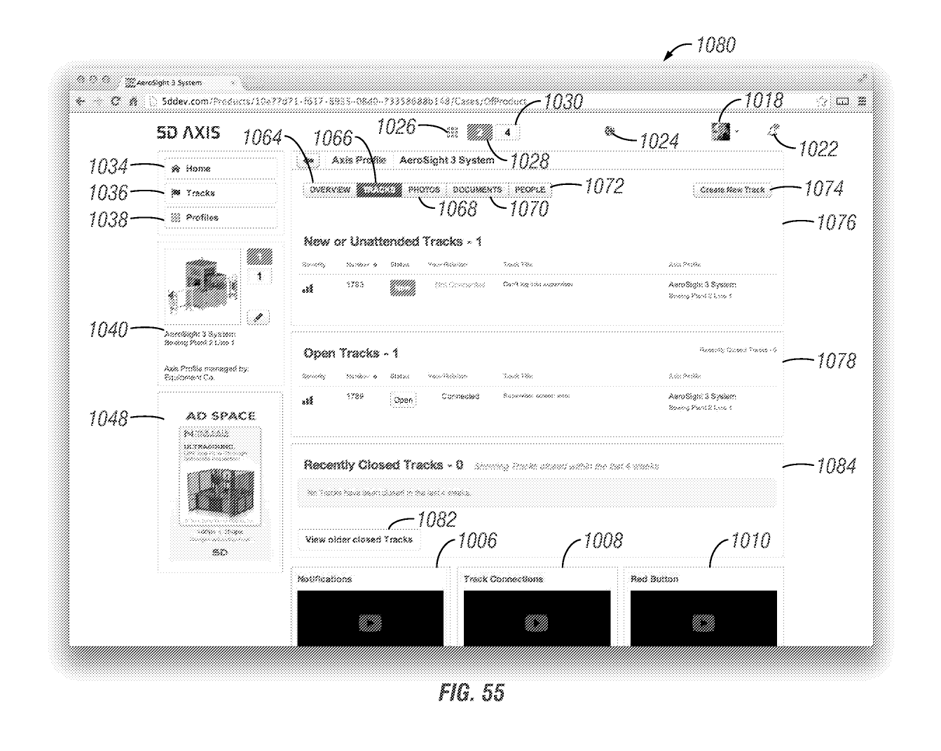

FIG. 55 illustrates a screen display 1080 where the tracks tab 1066 is selected for a product. A new track can be created by selecting the create new track button 1074. Information regarding new or unattended tracks 1076 is shown, information open tracks 1078 is shown, and information on recently closed tracks 1084 is shown. Button 1082 may be selected to view older closed tracks.

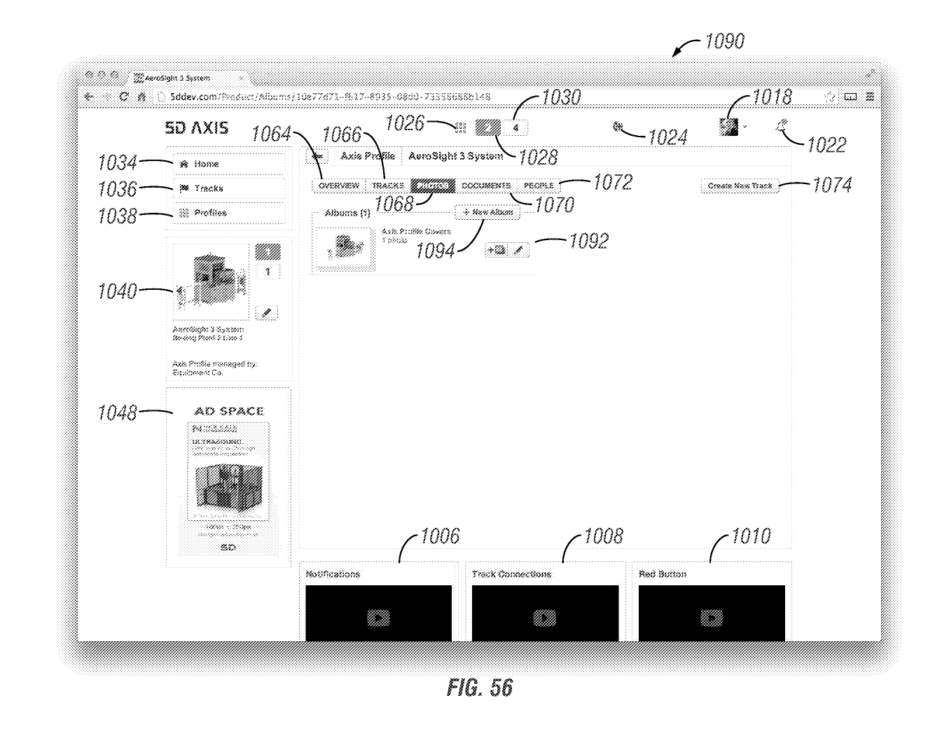

FIG. 56 illustrates a screen display 1090 where the photos tab 1068 is selected. Available albums 1092 are shown. A user can select the New Album button 1094 to create a new album.

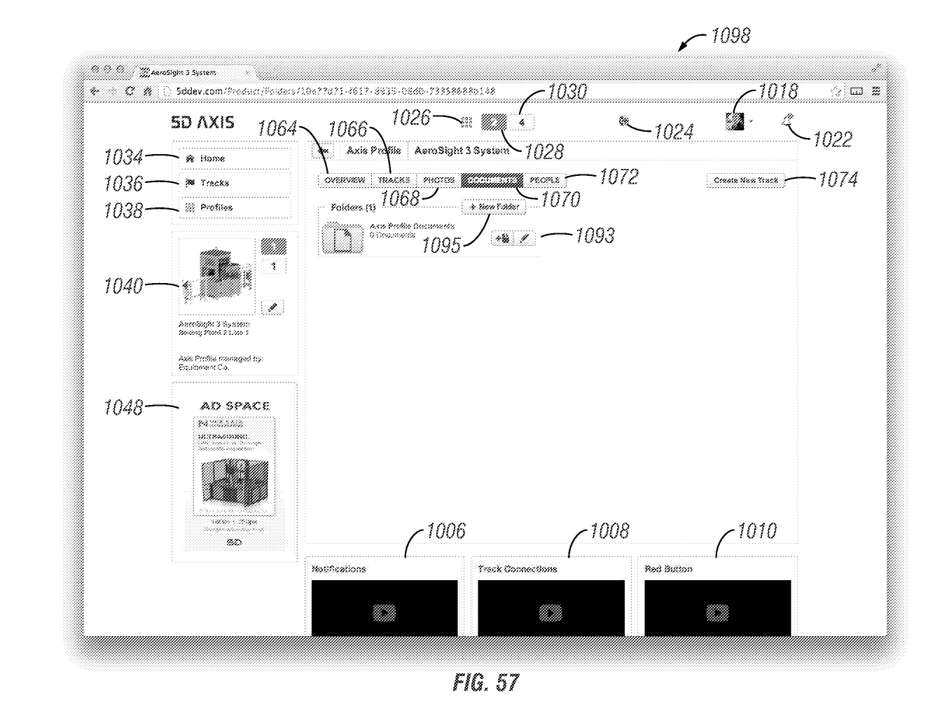

FIG. 57 illustrates a screen display 1098 where the documents tab 1070 is shown. Available folders 1093 are shown. A user can select the new folder button 1095 to create a new folder.

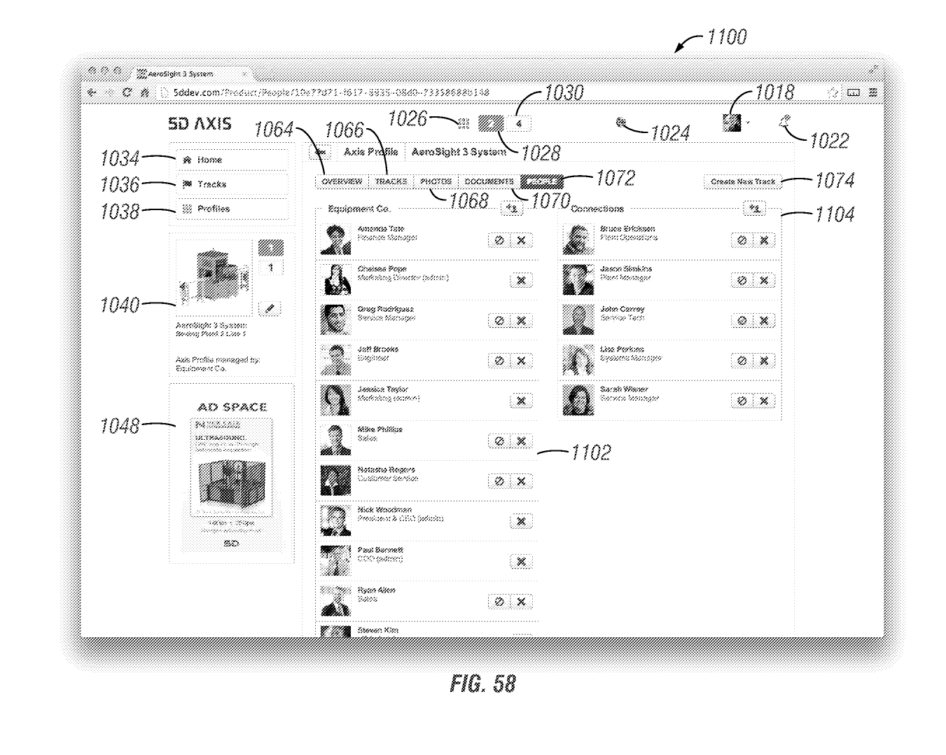

FIG. 58 illustrates a screen display 1100 where the people tab 1072 is selected. People associated with the company 1102 are shown and connections 1104 are also shown.

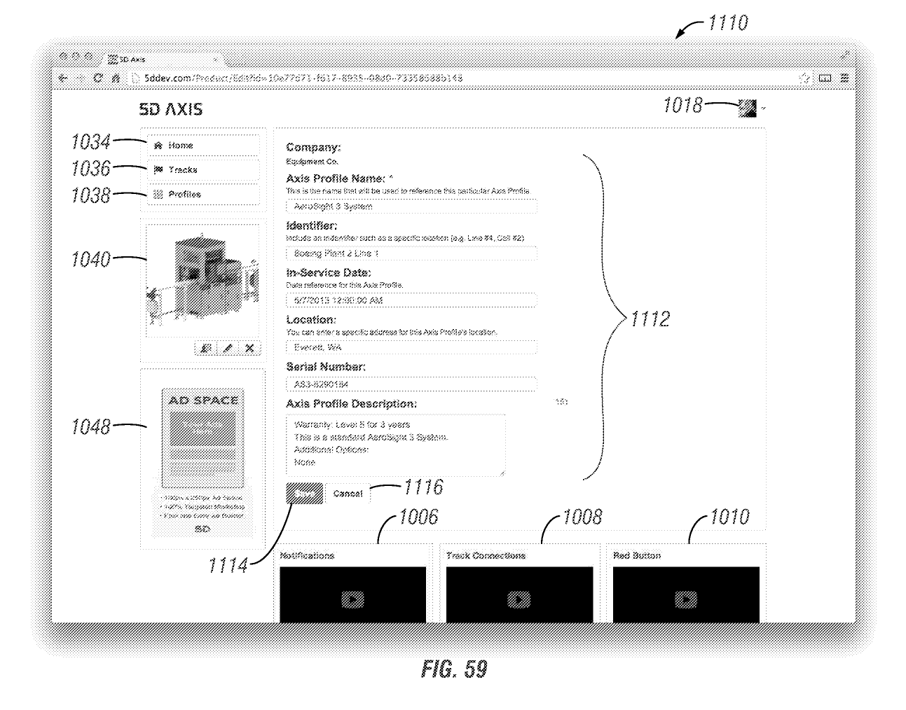

FIG. 59 illustrates a screen display 1110 illustrating the editing of a profile for a product. Product information 1112 is displayed and may be edited. This can include a profile name for the product, an identifier such as the specific location of the product, an in-service date for the product, a location or address, and a description. A save button 1114 is provided for saving the information and a cancel button 1116 is also provided.

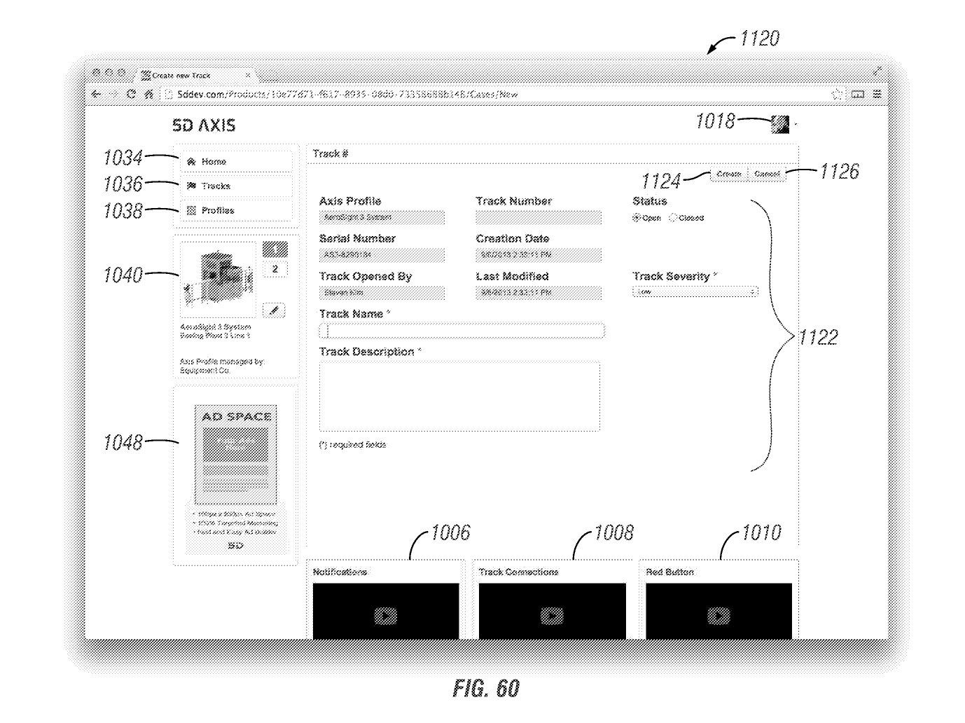

FIG. 60 illustrates a screen display 1120 for creating a new case or track. Track information 1122 associated with a product can be input. This can include a track name, a track description, a status (e.g. open or closed), a track severity (e.g. low, moderate, high). A create button 1124 is shown as well as a cancel button 1126 Once created, a track number can be assigned.

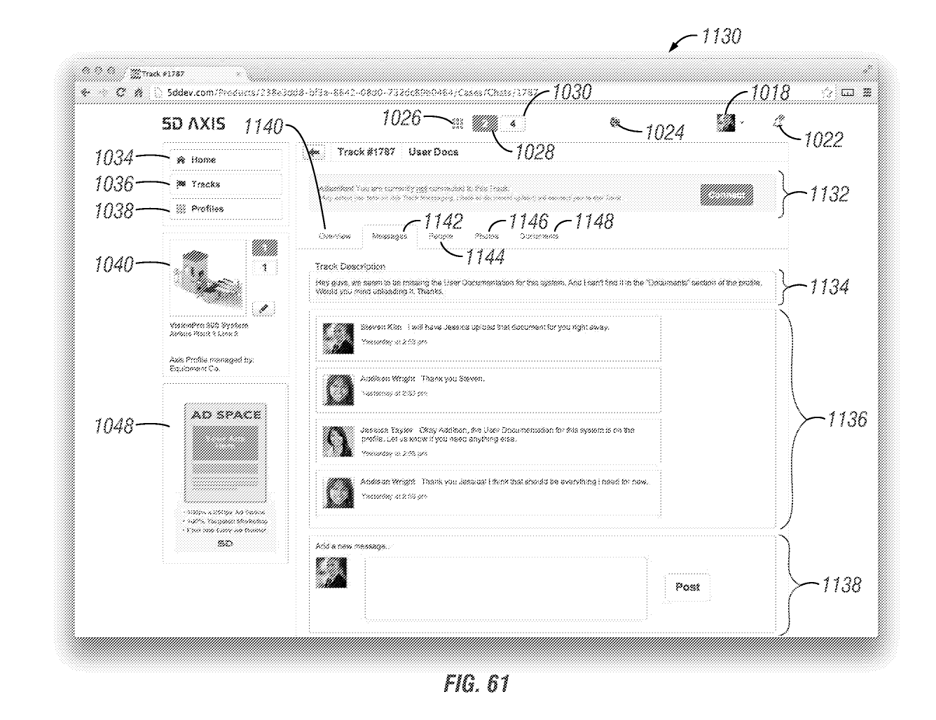

FIG. 61 illustrates a screen display 1130 associated with a track. The user can select the connect button 1132 to connect with this track. Tabs are shown for this track including an overview tab 1140, a messages tab 1142, a people tab 1144, a photos tab 1146, and a documents tab 1148. The messages tab 1142 is selected. A track description 1134 is shown, as well as messages 1136. In addition there is a section 1138 for adding a new message.

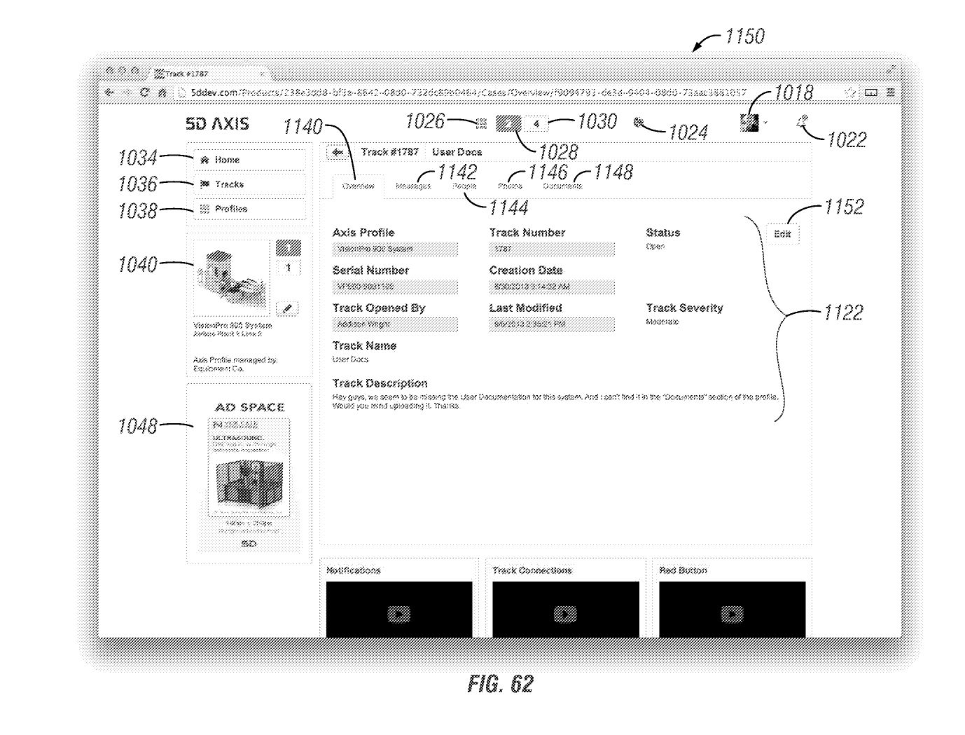

FIG. 62 illustrates a screen display 1150 associated with a track where the overview tab 1140 is selected. Track information 1122 is shown which may include a profile, a serial number, a track number, a creation date, a user who opened the track, when the track was last modified, a status of the track, a track severity, a track name, and a track description. To edit the track a user may select the edit button 1152.

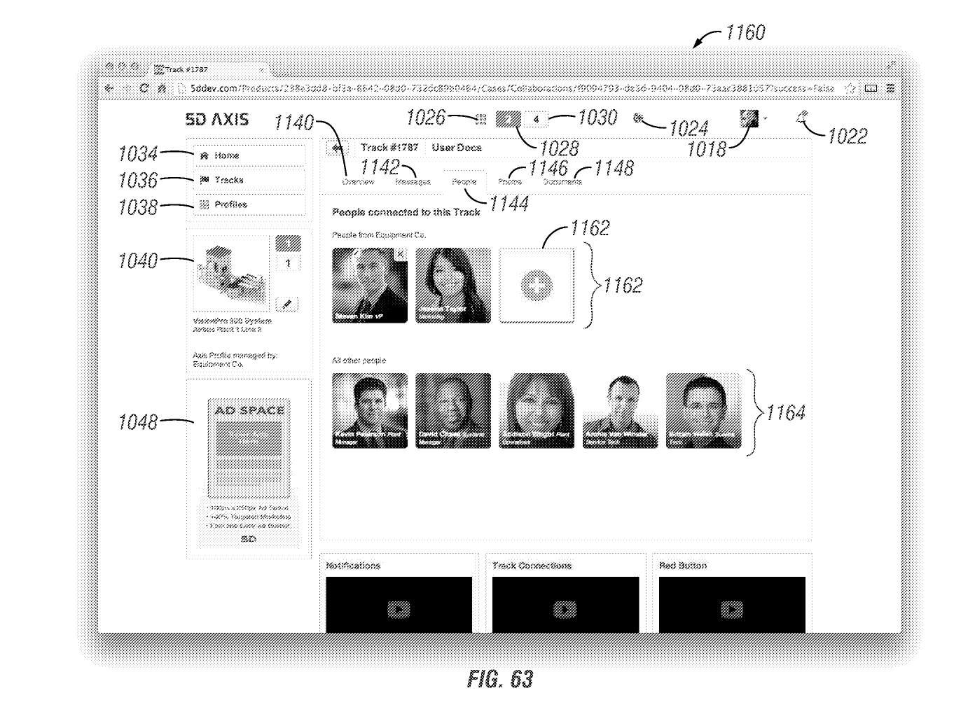

FIG. 63 illustrates a screen display 1160 associated with a track where the people tab 1144 is selected. People 1162 connected to the track are shown and a button 1162 for adding other people is shown. Other people 1164 from the company are also shown.

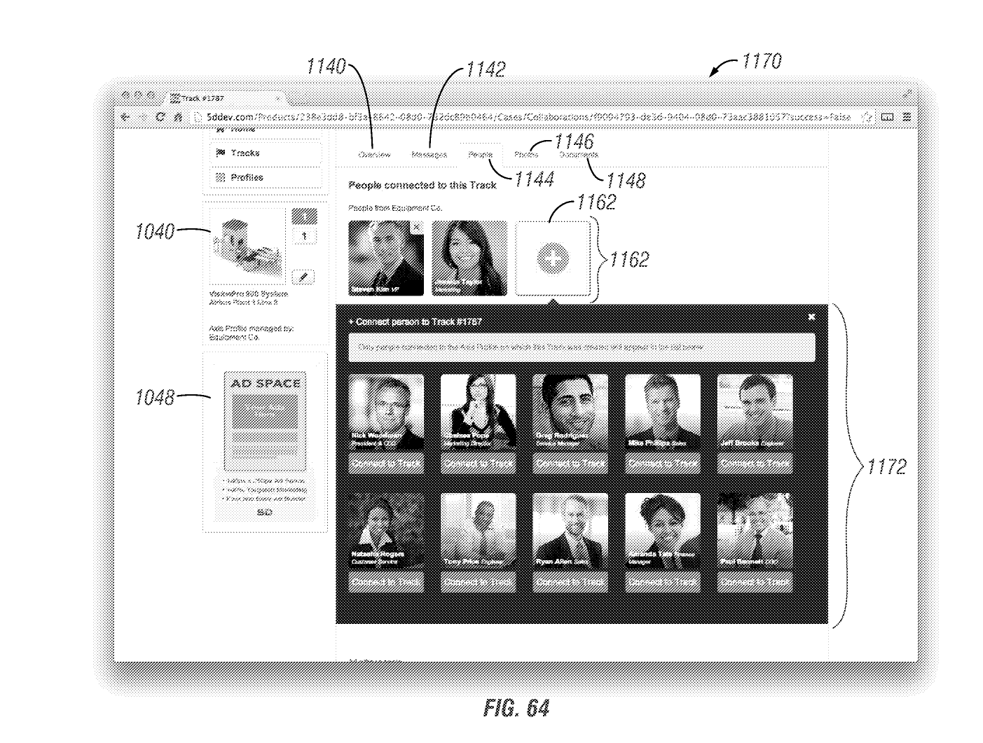

FIG. 64 illustrates a screen display 1170 after the button 1162 for adding other people is selected. A window 1172 is shown with people connected to a profile on which the track was created. One or more of these people may then be connected to the track.

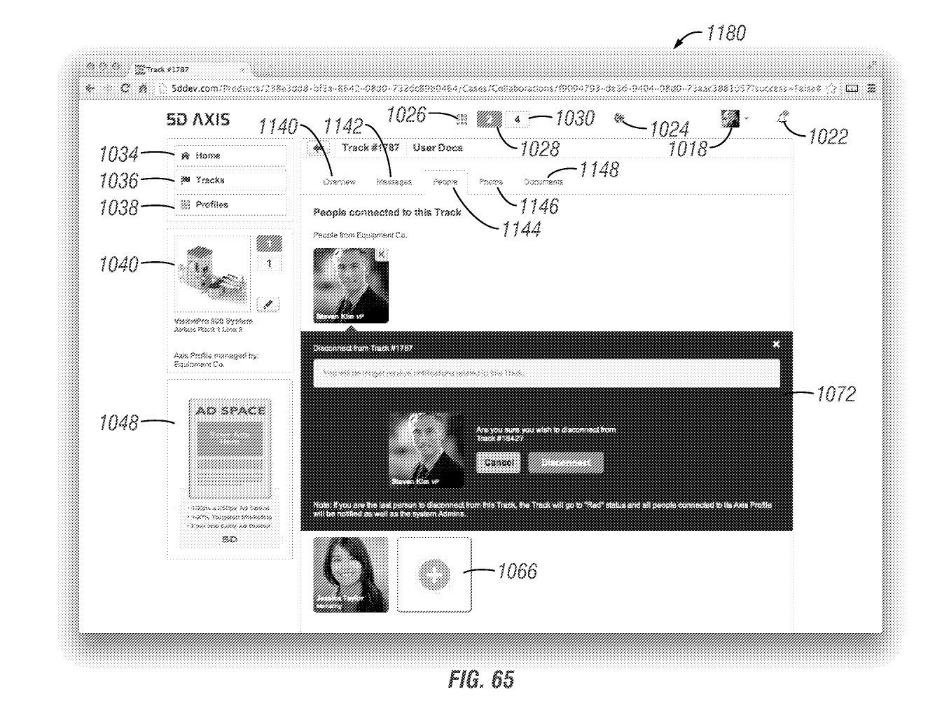

FIG. 65 illustrates a screen display 1180 with a window 1072 which may be used to disconnect a person from a particular track. A user will receive notifications for tracks which they are connected to. Thus, it should be understood that a user will receive notifications only for tracks which they are connected with and may disconnect from tracks they are not interested in in order to avoid notifications associated with those tracks.

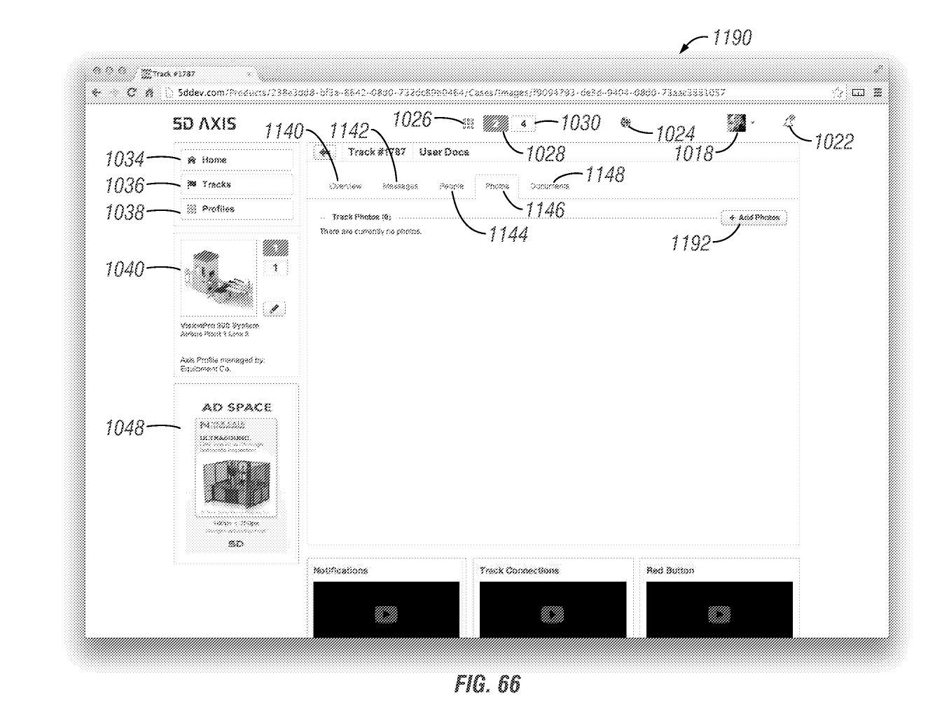

FIG. 66 illustrates a screen display 1190 with the photos tab 1146 selected. As shown, there are currently no photos, but photos can be added by selecting the add photos button 1192.

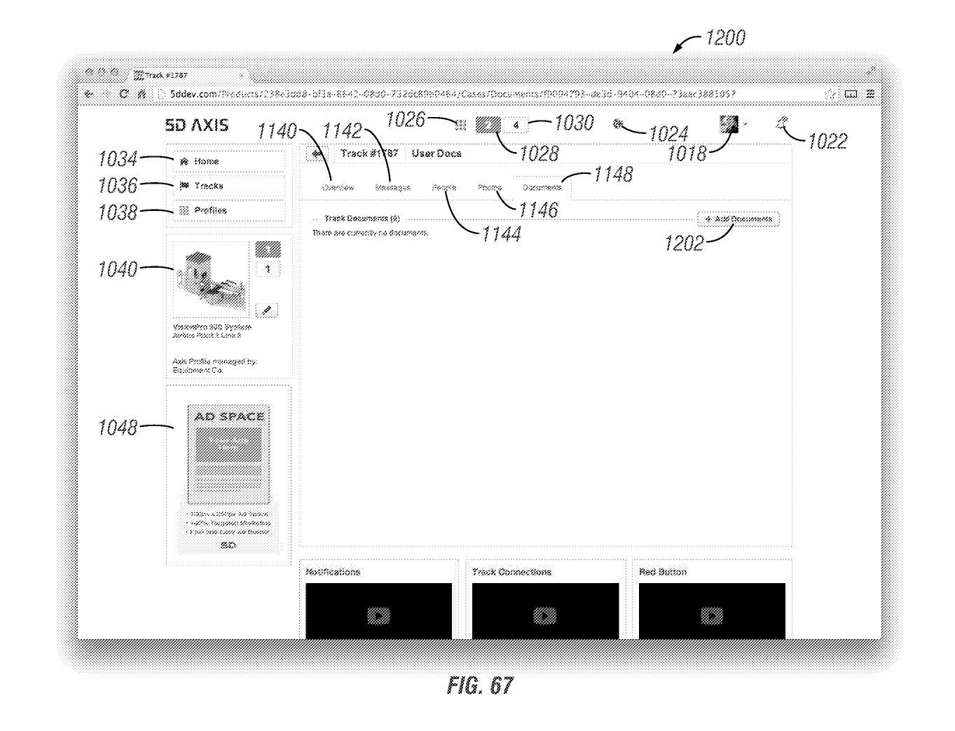

FIG. 67 illustrates a screen display 1200 with the documents tab 1148 selected. As shown, there are currently no documents, but documents can be added by selecting the add documents button 1202.

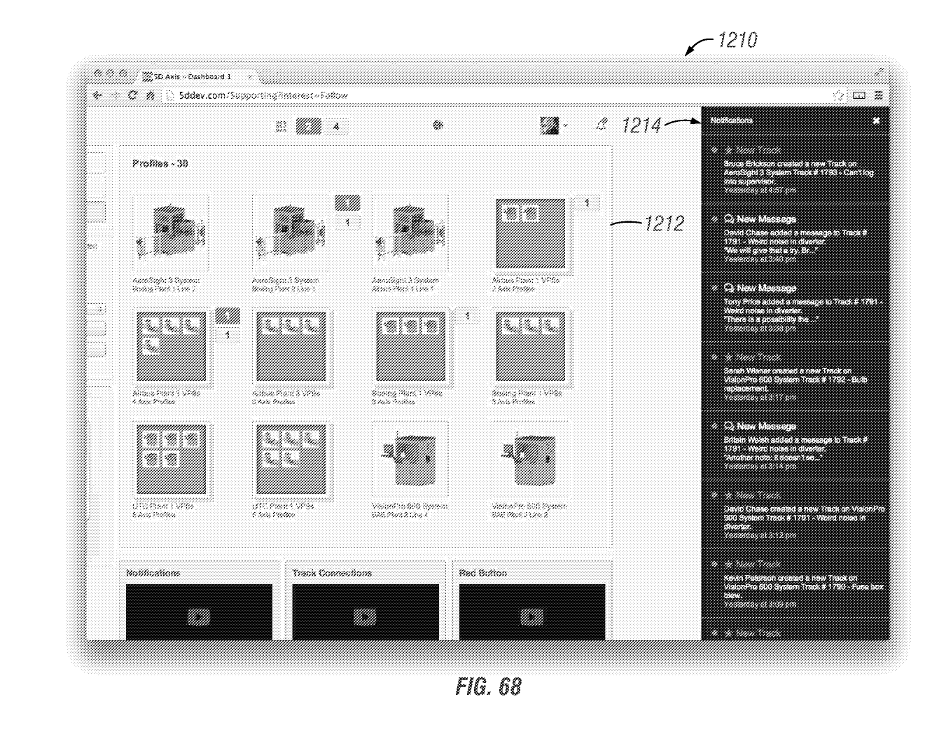

FIG. 68 illustrates a screen display 1210 which illustrates profiles 1212 that a user is following as well as notifications 14. Notifications can be associated with different events such as the opening of a new track, the availability of new messages, or other events. Users will receive notifications only for the tracks they are connected to.

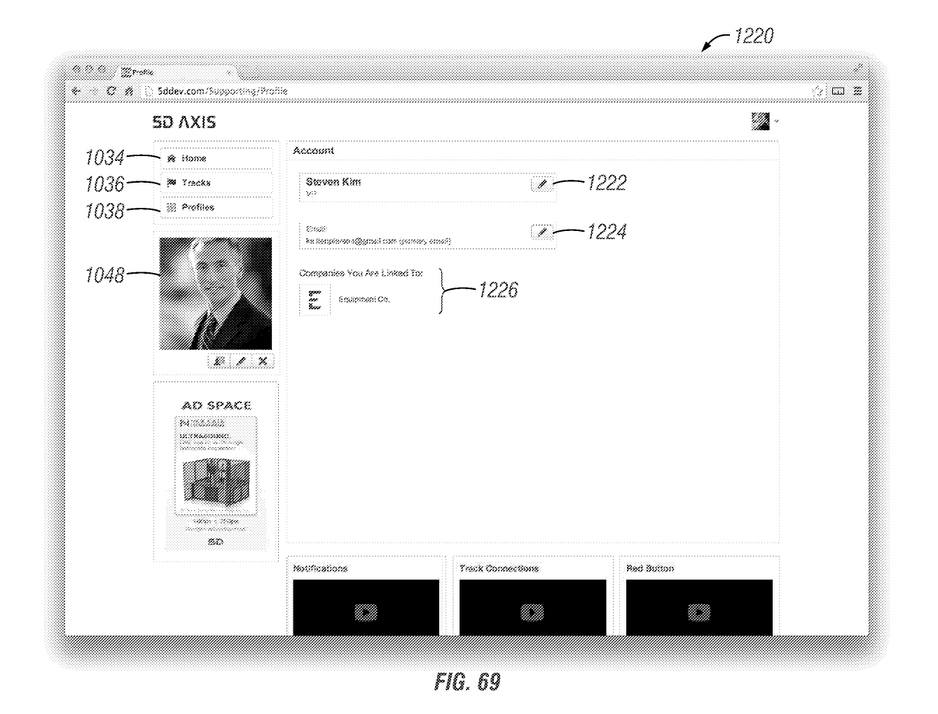

FIG. 69 illustrates a screen display 1220 for editing a profile or account of a user. This can include changing a name and/or title 1222, an email 1224, or companies the user is lined to 1226.

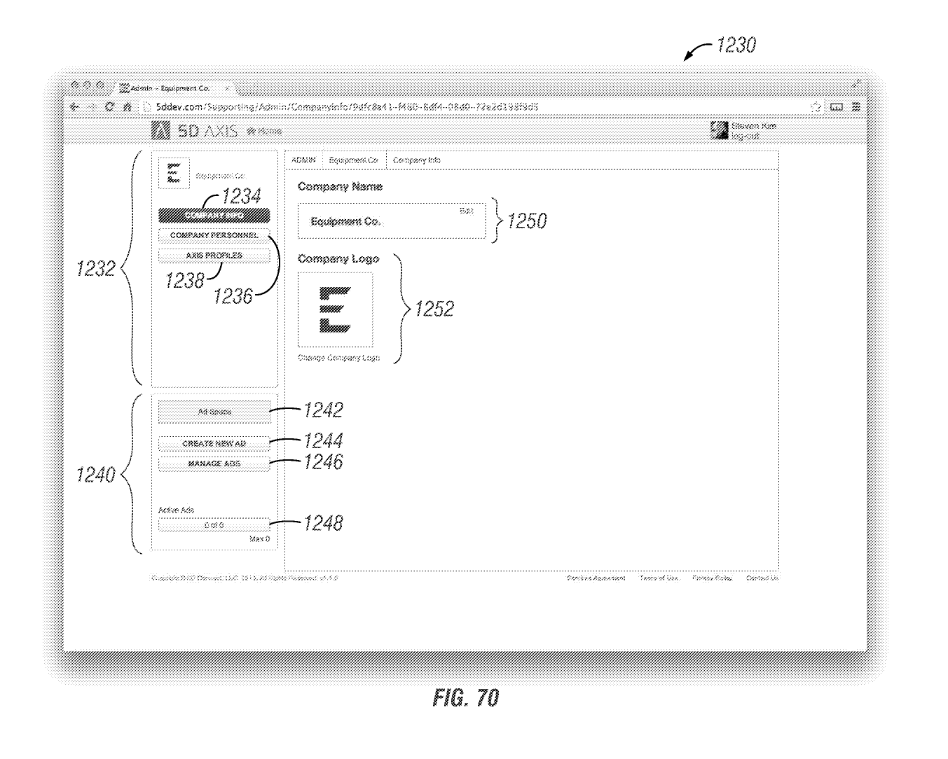

FIG. 70 illustrates a screen display 1230 for an administrator to use to add or edit information about a company. A panel 1232 includes a company info button 1234, a company personnel button 126, and an axis profiles button 1236. An advertising panel 1240 is also shown which includes ad space 1242, a create new ad button 1244, a manage ads button 1246, and a display of active ads 1248. The administrator can edit the company name 1250, or the company logo 1252.

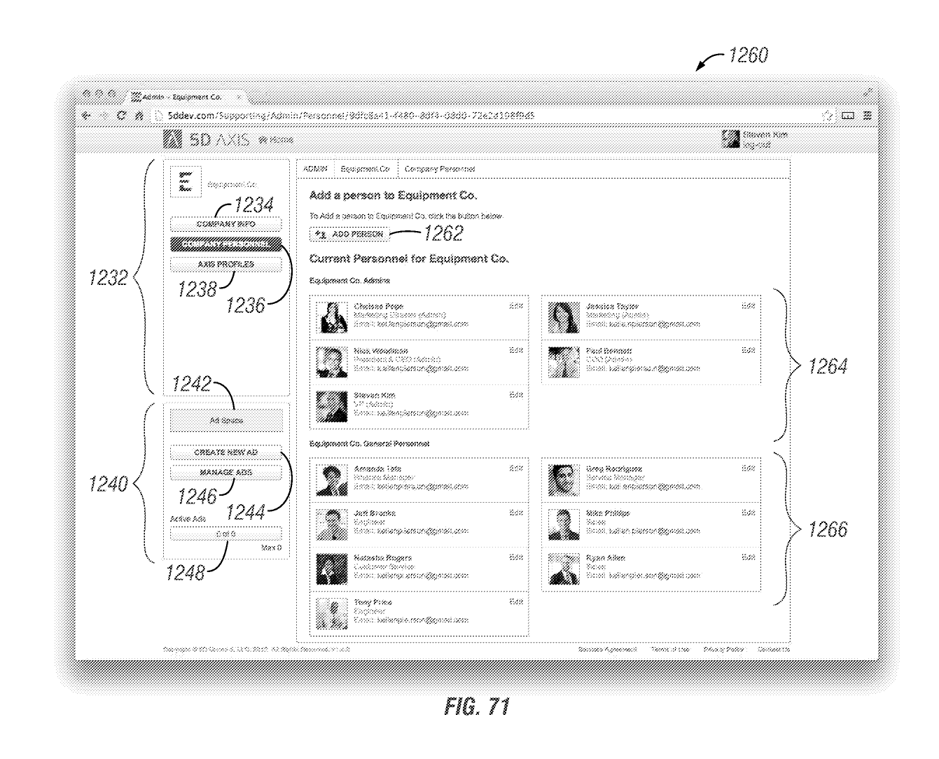

FIG. 71 illustrates a screen display 1260 for an administrator to use to maintain company personnel. An administrator can select the add person button 1262 to add individuals. Current administrative personal 1264 are shown as well as general personnel 1266.

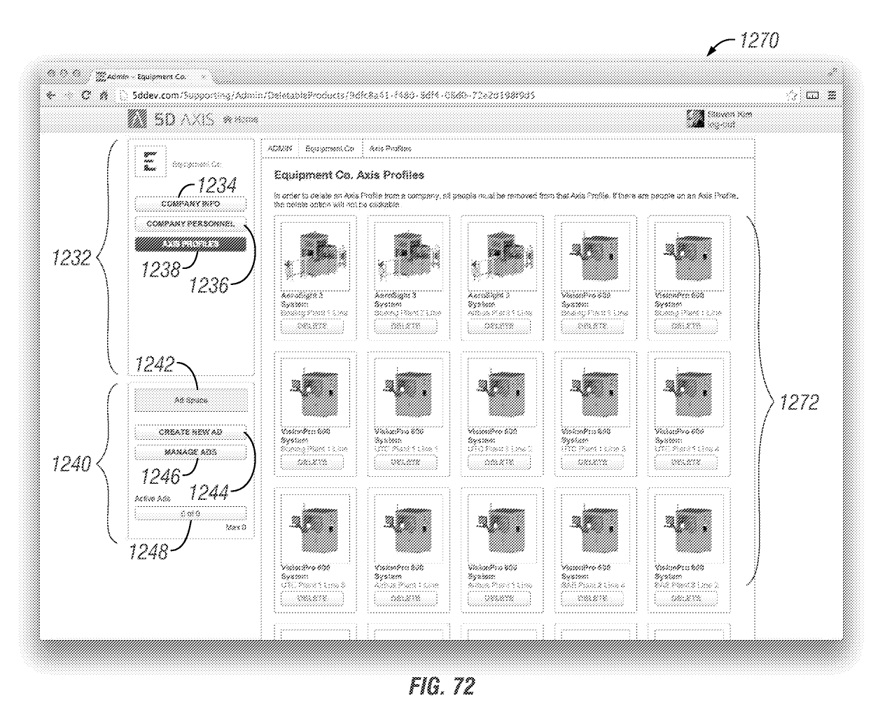

FIG. 72 illustrates a screen display for an administrator to delete profiles. Profiles 1272 are shown which can be deleted if there are no people on the profile.

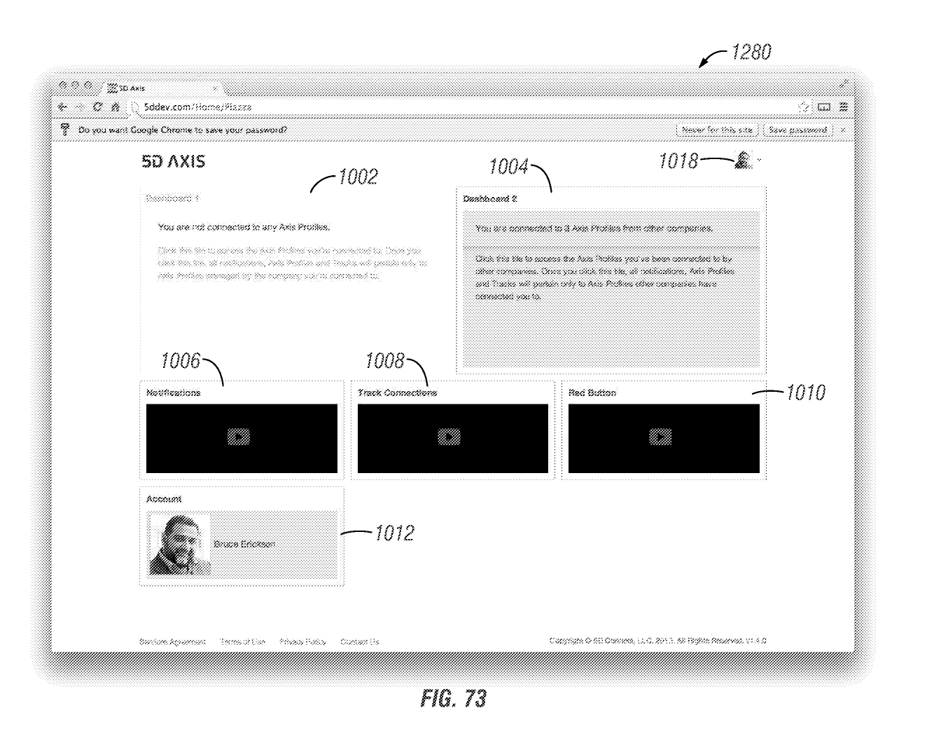

FIG. 73 illustrates a screen display 1280 where the second dashboard 1004 is selected.

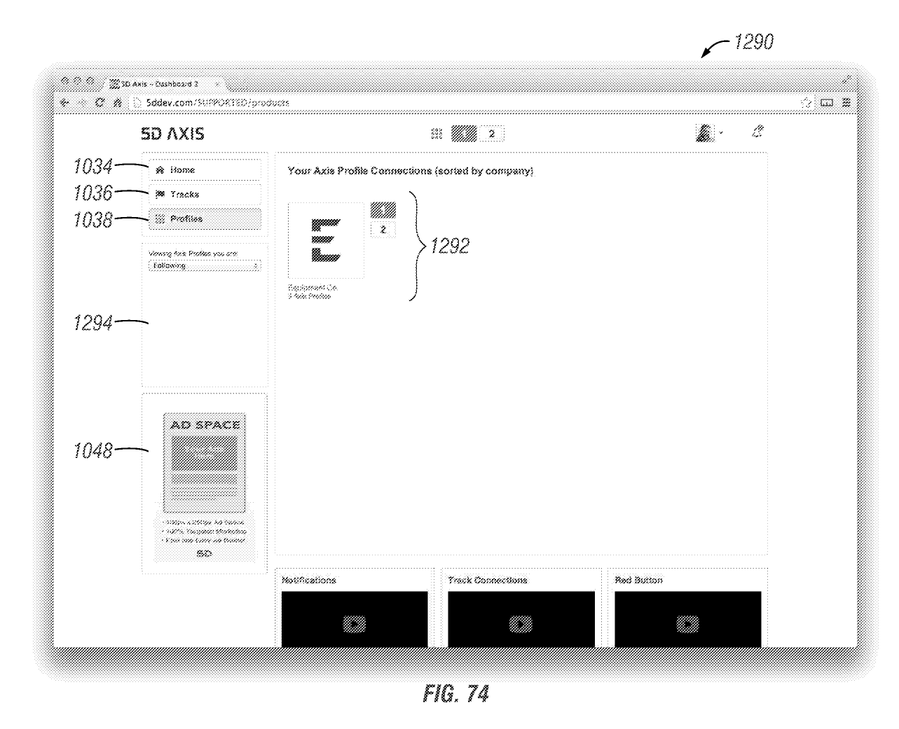

FIG. 74 illustrates a screen display 1290 showing profile connections sorted by company 1292. The company may be selected.

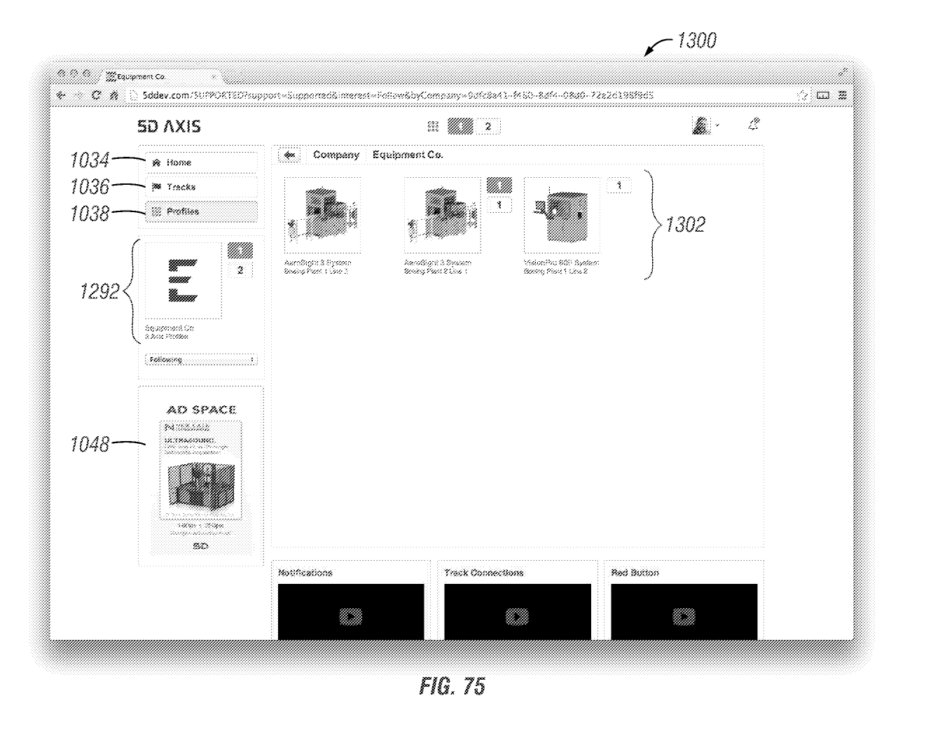

FIG. 75 illustrates a screen display 1300 showing profiles 1302 associated with a selected company.

Although various representative screen displays are shown, the present invention contemplates numerous variations in the user interface including the particular user interface design elements selected or used throughout. It is noted, however, that selection of particular arrangements of user interface design elements may assist in meeting various objects, features, or advantages of the present invention. For example, it is preferred that the user interface design assist in providing a product-centric approach to managing customer support services.

Therefore, methods, apparatus, and systems for providing customer support services have been disclosed. Although specific embodiments have been shown and described throughout, the present invention is not to be limited to the specific embodiments shown here as the present invention contemplates numerous, variations, options, and additions.

What is claimed is:

1. A method executed at least in part in a computing device for providing cloud based customer support services, the method comprising:
providing a cloud based service enabling data interchange between participants of a cloud based support service, the participants including customers seeking support on products or services and support personnel from companies providing the products or services, the cloud based service providing access to a database stored on a non-transitory computer readable storage medium and providing a user interface;
associating a subset of the participants with a selected product or service through the user interface associated with the cloud based service;
enabling the customers to initiate a support case for the selected product or service through the user interface associated with the cloud based service; and
enabling the subset of the participants associated with the product or service to communicate in order to resolve the support case through the user interface of the cloud based service.

2. The method of claim 1 further comprising enabling each of the participants to view all support cases for all products or services on a single page.

3. The method of claim 1 further comprising enabling each of the subset of the participants associated with the selected product or service to see a list of all other participants associated with the selected product or service.

4. The method of claim 1 further comprising providing activity stream notifications to the subset of the participants associated with the product or service through the cloud based service.

5. The method of claim 1 further comprising inviting one of the participants not within the subset of the participants to join the subset of the participants upon request of one of the subset of the participants.

6. The method of claim 1 further comprising enabling the customers to upload photos, videos, or other documents to the cloud based service and associating the photos, videos, or other documents with the support case.

7. The method of claim 1 further comprising enabling each of the participants to be associated with more than one of the products or services.

8. The method of claim 1 further comprising enabling the support personnel to be associated with more than one of the companies providing the products or services.

9. The method of claim 1 further comprising providing advertising through the cloud based service to target the customers.

10. The method of claim 1 wherein the step of enabling the customers to initiate a support case includes enabling the customers to select a type of case.

11. A method for providing customer support, the method comprising:
providing a cloud based service enabling data interchange between participants of a cloud based support service, the participants including customers seeking support on products or services and support personnel from companies providing the products or services, the cloud based service providing access to a database stored on a non-transitory computer readable storage medium and providing a user interface;
providing access to a plurality of companies providing support to their customers using the cloud-based service on the host device.

12. The method of claim 11 further comprising associating a subset of the participants with a selected product or service through the user interface associated with the cloud based service.

13. The method of claim 12 further comprising enabling the customers to initiate a track for the selected product or service through the user interface associated with the cloud based service.

14. The method of claim 13 further comprising enabling the subset of the participants connected with the track to communicate in order to resolve a support issue through the user interface of the cloud based service.

15. The method of claim 14 further comprising enabling each of the participants to view all tracks for all products or services they are connected to on a single page.

16. The method of claim 15 further comprising enabling each of the subset of the participants associated with the selected product or service to see a list of all other participants associated with the selected product or service.

17. The method of claim 16 further comprising providing activity stream notifications to the subset of the participants associated with the tracks for all the products or services they are connecting with through the cloud based service.

18. The method of claim 17 further comprising connecting one of the participants not within the subset of the participants upon request of one of the subset of the participants.

19. A system for providing cloud based customer support services, the system comprising a cloud based server providing a cloud based service enabling data interchange between participants of a cloud based support service, the participants including customers seeking support on products or services and support personnel from companies providing the products or services, the cloud based server programmed to perform steps of associating a subset of the participants with a selected product or service, enabling the customers to initiate a support case for the selected product or service, and enabling the subset of the participants associated with the product or service to communicate in order to resolve the support case.
